(19) United States
(12) Patent Application Publication
(10) Pub. No.: US 2025/0117242 A1
(43) Pub. Date: Apr. 10, 2025

(54) METHODS AND SYSTEMS THAT AUTOMATICALLY GENERATE PARAMETERIZED CLOUD-INFRASTRUCTURE TEMPLATES

(71) Applicant: VMware LLC, Palo Alto, CA (US)

(72) Inventors: Priyank Agarwal, Bangalore (IN); Praveen Kumar, Bangalore (IN); Kalyan Devarakonda, Bangalore (IN); Nitin Ramachandra, Bangalore (IN); Aakash Das, Bangalore (IN)

(21) Appl. No.: 18/649,909

(22) Filed: Apr. 29, 2024

(30) Foreign Application Priority Data
Oct. 4, 2023 (IN) 202341066494

(51) Int. Cl. G06F 9/455

(52) U.S. Cl. CPC G06F 9/45558; G06F 2009/4557; G06F 2009/45583; G06F 2009/45587; G06F 2009/45595

(57) ABSTRACT

The current document is directed to an infrastructure-as-code (“IaC”) cloud-infrastructure-management service or system that automatically generates parameterized cloud-infrastructure templates that represent cloud-based infrastructure, including virtual networks, virtual machines, load balancers, and connection topologies. The IaC cloud-infrastructure manager automatically transforms cloud-infrastructure-specification-and-configuration files into a set of parameterized cloud-infrastructure-specification-and-configuration files and a parameters file that together comprise a parameterized cloud-infrastructure template.

### RELATED APPLICATIONS

This application claims priority to Indian Application No. 202341066494 filed Oct. 4, 2023, by VMware LLC, entitled “METHODS AND SYSTEMS THAT AUTOMATICALLY GENERATE PARAMETERIZED CLOUD-INFRASTRUCTURE TEMPLATES,” which is hereby incorporated by reference in its entirety for all purposes.

### TECHNICAL FIELD

The current document is directed to distributed-computer-systems and, in particular, to an infrastructure-as-code (“IaC”) cloud-infrastructure-management service or system that automatically generates parameterized cloud-infrastructure templates that represent already deployed cloud-based infrastructure, including virtual networks, virtual machines, load balancers, and connection topologies.

### BACKGROUND

During the past seven decades, electronic computing has evolved from primitive, vacuum-tube-based computer systems, initially developed during the 1940s, to modern electronic computing systems, including distributed cloud-computing systems, in which large numbers of multiprocessor servers, work stations, and other individual computing systems are networked together with large-capacity data-storage devices and other electronic devices to produce geographically distributed computing systems with hundreds of thousands, millions, or more components that provide enormous computational bandwidths and data-storage capacities. These large, distributed computing systems are made possible by advances in computer networking, distributed operating systems and applications, data-storage appliances, computer hardware, and software technologies. The advent of distributed computer systems has provided a computational platform for increasingly complex distributed applications, including distributed service-oriented applications. Distributed applications, including distributed service-oriented applications and distributed microservices-based applications, provide many advantages, including efficient scaling to respond to changes in workload, efficient functionality compartmentalization that, in turn, provides development and management efficiencies, flexible response to system component failures, straightforward incorporation of existing functionalities, and straightforward expansion of functionalities and interfaces with minimal interdependencies between different types of distributed-application instances. As new distributed-computing technologies are developed, and as general hardware and software technologies continue to advance, the current trend towards ever-larger and more complex distributed computing systems appears likely to continue well into the future.

As the complexity of distributed computing systems has increased, the management and administration of distributed computing systems and applications have, in turn, become increasingly complex, involving greater computational overheads and significant inefficiencies and deficiencies. In fact, many desired management-and-administration functionalities are becoming sufficiently complex to render traditional approaches to the design and implementation of automated and semi-automated management and administration subsystems impractical, from a time and cost standpoint. Therefore, designers and developers of distributed computer systems and applications continue to seek new approaches to implementing automated and semi-automated management-and-administration facilities and functionalities.

### SUMMARY

The current document is directed to an infrastructure-as-code (“IaC”) cloud-infrastructure-management service or system that automatically generates parameterized cloud-infrastructure templates that represent cloud-based infrastructure, including virtual networks, virtual machines, load balancers, and connection topologies. The IaC cloud-infrastructure manager automatically transforms cloud-infrastructure-specification-and-configuration files into a set of parameterized cloud-infrastructure-specification-and-configuration files and a parameters file that together comprise a parameterized cloud-infrastructure template.

### BRIEF DESCRIPTION OF THE DRAWINGS

FIG. 1 provides a general architectural diagram for various types of computers.

FIG. 2 illustrates an Internet-connected distributed computing system.

FIG. 3 illustrates cloud computing.

FIG. 4 illustrates generalized hardware and software components of a general-purpose computer system, such as a general-purpose computer system having an architecture similar to that shown in FIG. 1.

FIGS. 5A-D illustrate two types of virtual machine and virtual-machine execution environments.

FIG. 6 illustrates an OVF package.

FIG. 7 illustrates virtual data centers provided as an abstraction of underlying physical-data-center hardware components.

FIG. 8 illustrates a number of different cloud-computing facilities that provide computational infrastructure to an organization for supporting the organization's distributed applications and services.

FIG. 9 illustrates a universal-management-interface provided by the currently disclosed IaC cloud-infrastructure-management service.

FIG. 10 illustrates a portion of the architecture of the IaC cloud-infrastructure-management service.

FIG. 11 illustrates the cloud-management interface provided by the IaC cloud-infrastructure-management service.

FIG. 12 illustrates components of a GraphQL API interface.

FIGS. 13A-14E illustrate an example schema, an extension to that example schema, and queries, a mutation, and a subscription to illustrate the GraphQL data query language.

FIG. 15 illustrates a stitching process.

FIGS. 16A-D illustrate the YAML Ain′t Markup Language (“YAML”) data serialization language.

FIG. 17 illustrates certain features provided by the Jinja template engine that are used, in addition to YAML, for representing infrastructure in SLS documents.

FIGS. 18A-C illustrate a structured labor state (“SLS”) data file and credential file as well as the output from an Idem describe command.

FIG. 19 illustrates a fundamental control loop involving the Idem service.

FIG. 20 illustrates one implementation of the Idem service.

FIG. 21 provides an abstract illustration of SLS data files.

FIGS. 22A-C illustrate aspects of the process of transforming an SLS data file that specifies cloud infrastructure into a parameterized cloud-infrastructure template.

FIG. 23 shows an example SLS data file that is used in the following discussion of the currently disclosed methods for identifying and parameterizing variable values.

FIG. 24 shows a JSON-like encoding of parameterization parameters that specify certain parameterization-parameter values used in identifying and parameterizing variables within the example SLS data file shown in FIG. 23.

FIG. 25 provides a control-flow diagram of the routine “parameterized” that represents the overall, currently disclosed process of identifying and parameterizing variables in an SLS data file.

FIG. 26 provides a control-flow diagram for the routine “compile and validate,” called in step 2504 of FIG. 25.

FIG. 27 provides a control-flow diagram for the routine “next element,” called in step 2606 of FIG. 26.

FIG. 28 shows the contents of the JSON-like representation J of the example SLS data files S provided in FIG. 23.

FIGS. 29A-B again shows the JSON-like representation J and the SLS data file S, for convenient comparison.

FIGS. 30A-B provide control-flow diagrams for the routine “build insights,” called in step 2506 of FIG. 25.

FIGS. 31A-M show the build-insights response contained in the build-insights-response file R produced from the JSON-like representation J output by the routine “compile and validate” for the example SLS data file S shown in FIG. 23.

FIGS. 32A-B provide control-flow diagrams that illustrate implementation of the routine “string frequency,” called in step 2508 of FIG. 25.

FIG. 33 illustrates a portion of the string-variable frequency map SFM generated by the routine “string frequency” for the build-insights response R generated for the SLS data files S.

FIG. 34 provides a control-flow diagram for the routine “list frequency,” called in step 2510 of FIG. 25.

FIG. 35 illustrates a portion of the LFM output by the routine “list frequencies” following processing of the JSON-like representation J.

FIGS. 36A-C provide control flow diagrams that illustrate an implementation of the routine “process string frequency,” called in step 2512 of FIG. 25.

FIGS. 37A-B provide control flow diagrams that illustrate an implementation of the routine “process list frequency” called in step 2514 of FIG. 25.

FIGS. 38A-D show examples of the contents of the pSFM and pLFM.

FIGS. 39A-B provide control-flow diagrams for the routine “generate parameterizations,” called in step 2516 of FIG. 24.

FIG. 40 provides a control-flow diagram that illustrates an implementation of the routine “parameterized input,” called in step 2518 of FIG. 25.

FIG. 41 shows the contents of file S′ output by the routine “generate parameterizations” for the example SLS data file S.

FIG. 42 shows an implementation of the params file.

### DETAILED DESCRIPTION

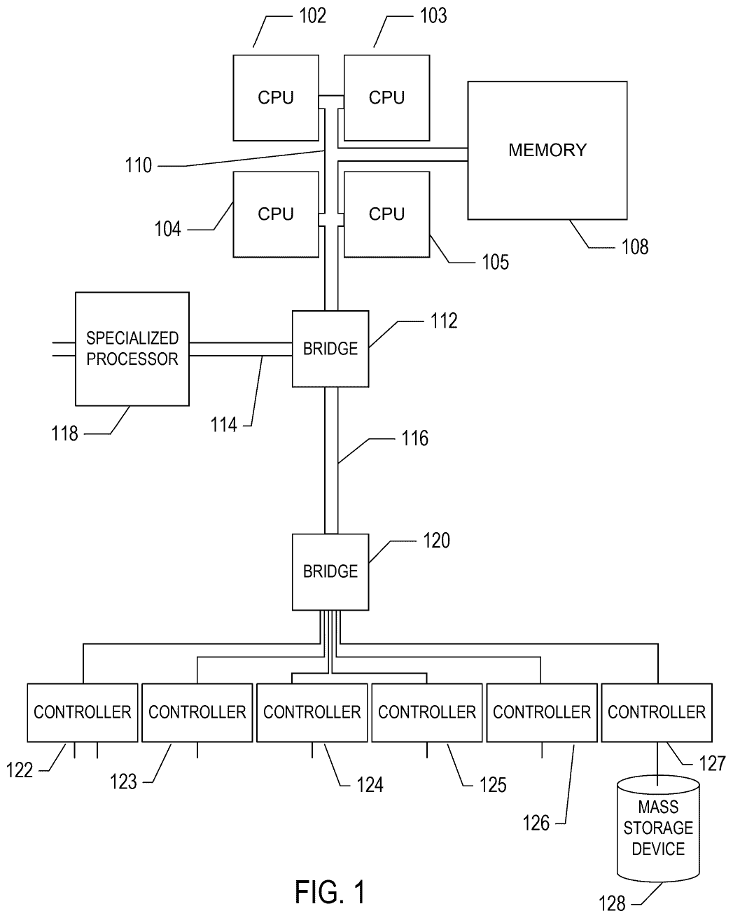

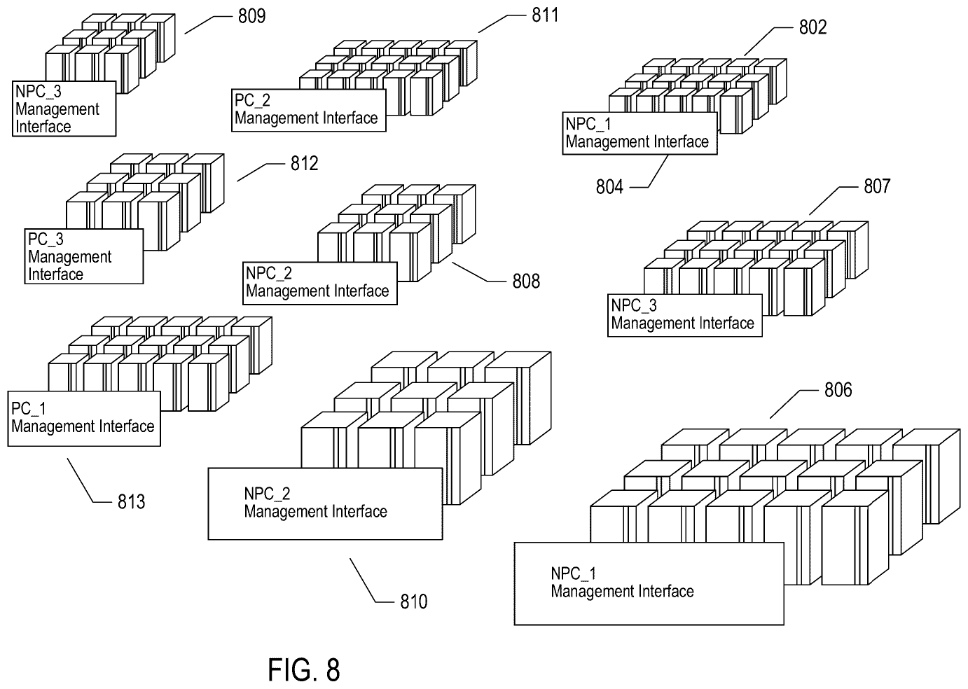

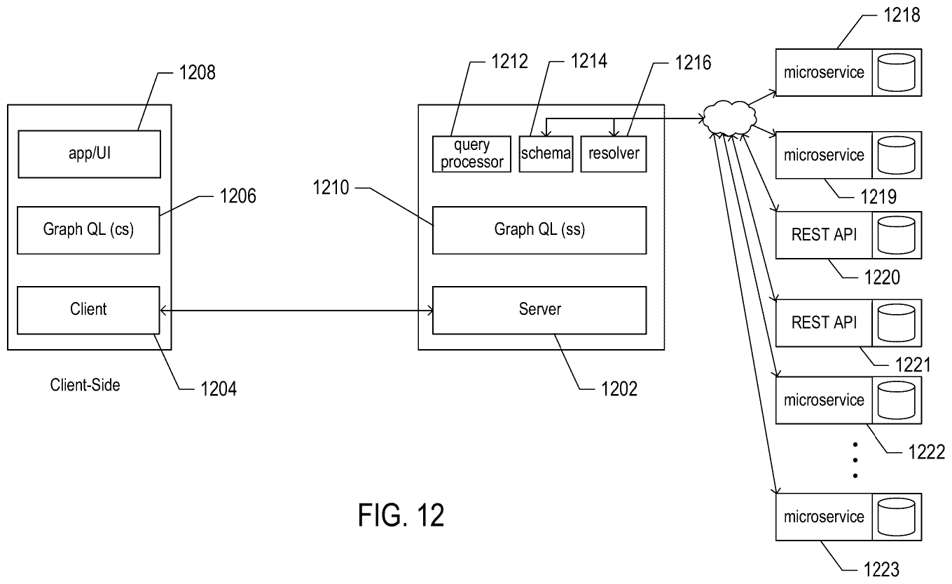

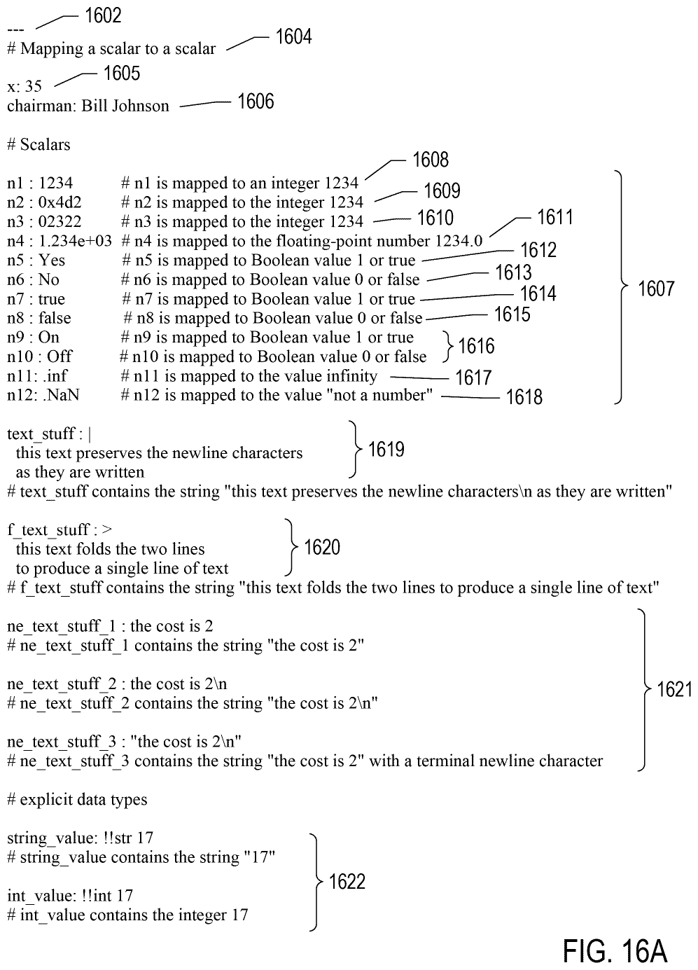

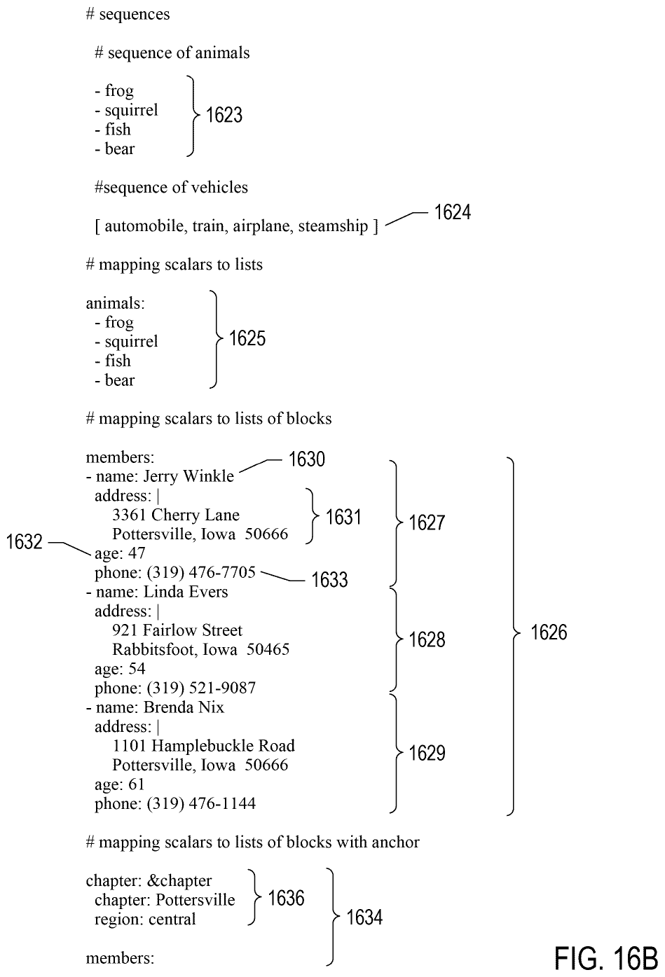

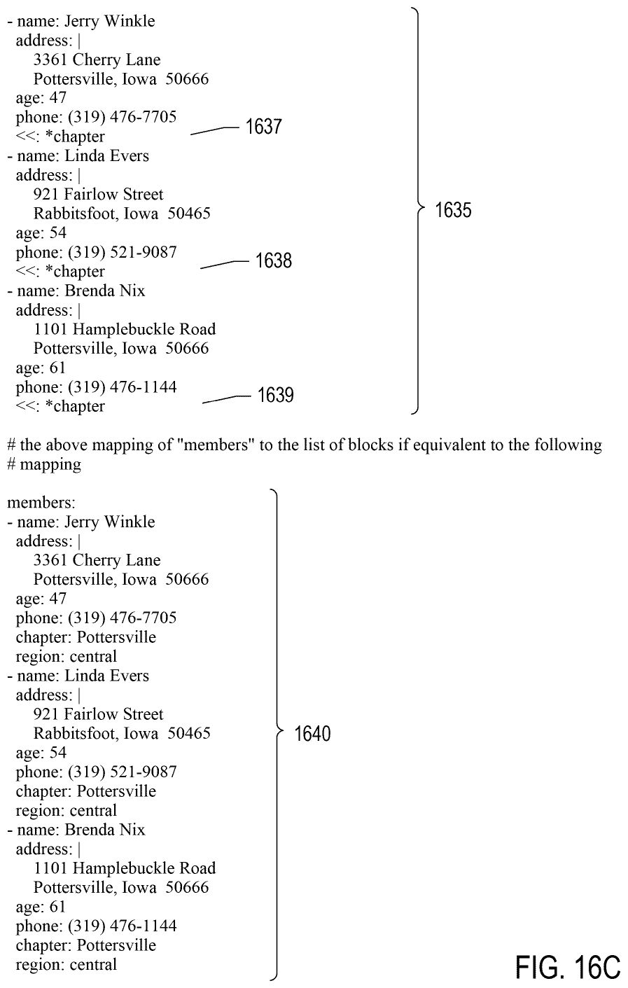

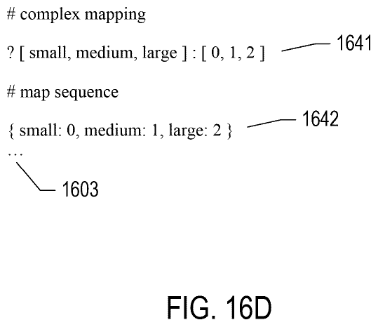

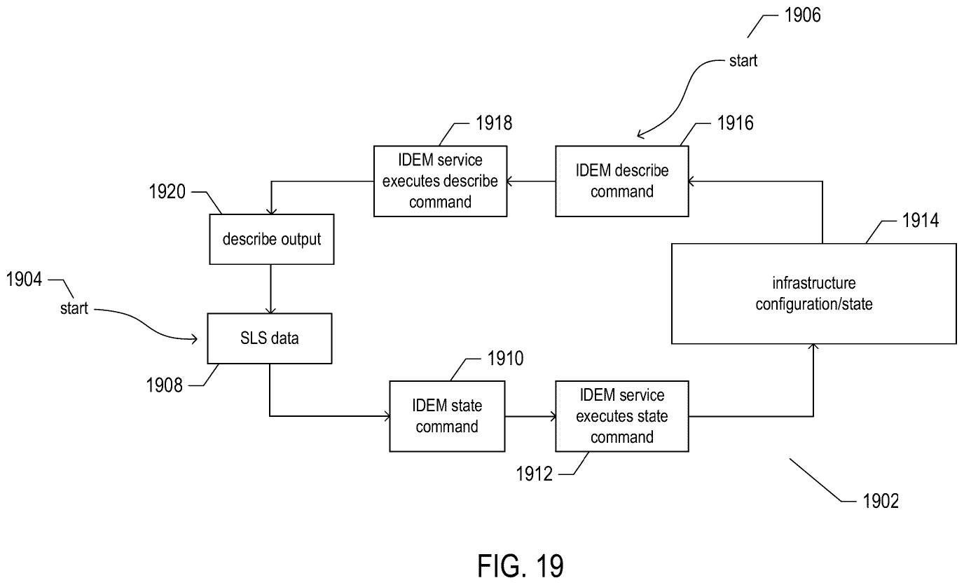

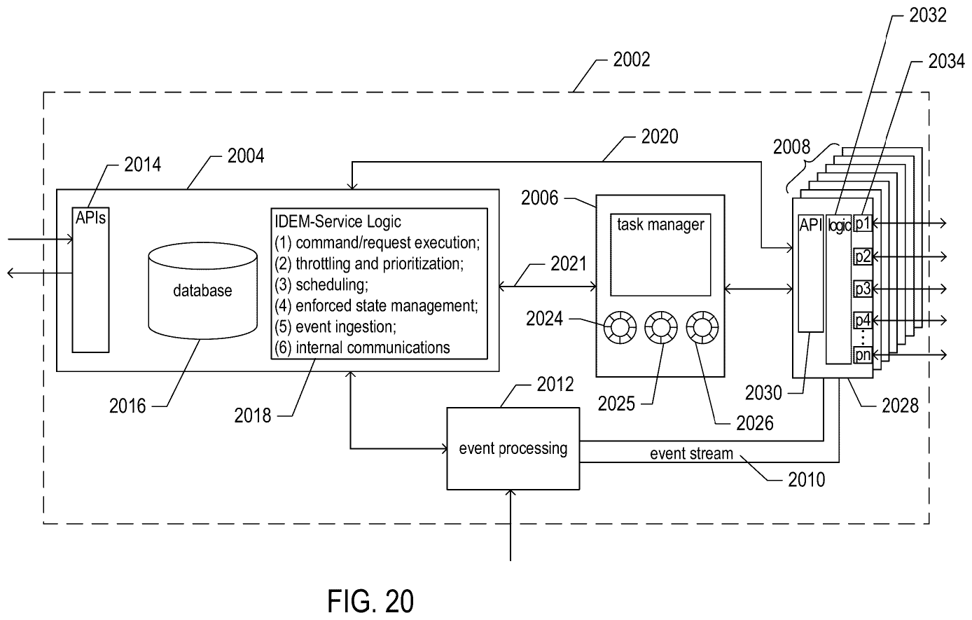

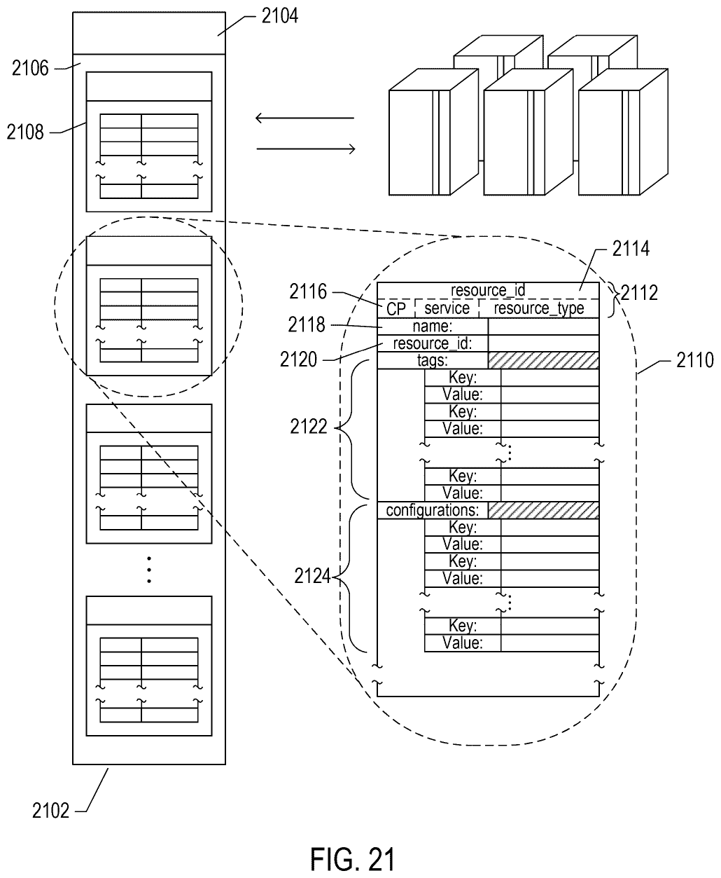

The current application is directed to an IaC cloud-infrastructure-management service or system that automatically generates parameterized cloud-infrastructure templates. In a first subsection, below, a detailed description of computer hardware, complex computational systems, and virtualization is provided with reference to FIGS. 1-7. In a second subsection, an overview of an IaC cloud-infrastructure-management service is provided, with reference to FIGS. 8-11. A third subsection provides an overview of the GraphQL API interface with reference to FIGS. 12-15. A fourth subsection provides an overview of YAML, JINJA, and SLS documents with reference to FIGS. 16-18C. A fifth subsection provides an overview of the Idem service reference to FIGS. 19-20. Finally, in a sixth subsection, the currently disclosed methods and systems are discussed with reference to FIGS. 21-42.

### Computer Hardware, Complex Computational Systems, and Virtualization

The term “abstraction” is not, in any way, intended to mean or suggest an abstract idea or concept. Computational abstractions are tangible, physical interfaces that are implemented, ultimately, using physical computer hardware, data-storage devices, and communications systems. Instead, the term “abstraction” refers, in the current discussion, to a logical level of functionality encapsulated within one or more concrete, tangible, physically-implemented computer systems with defined interfaces through which electronically-encoded data is exchanged, process execution launched, and electronic services are provided. Interfaces may include graphical and textual data displayed on physical display devices as well as computer programs and routines that control physical computer processors to carry out various tasks and operations and that are invoked through electronically implemented application programming interfaces (“APIs”) and other electronically implemented interfaces. There is a tendency among those unfamiliar with modern technology and science to misinterpret the terms “abstract” and “abstraction,” when used to describe certain aspects of modern computing. For example, one frequently encounters assertions that, because a computational system is described in terms of abstractions, functional layers, and interfaces, the computational system is somehow different from a physical machine or device. Such allegations are unfounded. One only needs to disconnect a computer system or group of computer systems from their respective power supplies to appreciate the physical, machine nature of complex computer technologies. One also frequently encounters statements that characterize a computational technology as being “only software,” and thus not a machine or device. Software is essentially a sequence of encoded symbols, such as a printout of a computer program or digitally encoded computer instructions sequentially stored in a file on an optical disk or within an electromechanical mass-storage device. Software alone can do nothing. It is only when encoded computer instructions are loaded into an electronic memory within a computer system and executed on a physical processor that so-called “software implemented” functionality is provided. The digitally encoded computer instructions are an essential and physical control component of processor-controlled machines and devices, no less essential and physical than a cam-shaft control system in an internal-combustion engine. Multi-cloud aggregations, cloud-computing services, virtual-machine containers and virtual machines, communications interfaces, and many of the other topics discussed below are tangible, physical components of physical, electro-optical-mechanical computer systems.

FIG. 1 provides a general architectural diagram for various types of computers. The computer system contains one or multiple central processing units (“CPUs”) 102-105, one or more electronic memories 108 interconnected with the CPUs by a CPU/memory-subsystem bus 110 or multiple busses, a first bridge 112 that interconnects the CPU/memory-subsystem bus 110 with additional busses 114 and 116, or other types of high-speed interconnection media, including multiple, high-speed serial interconnects. These busses or serial interconnections, in turn, connect the CPUs and memory with specialized processors, such as a graphics processor 118, and with one or more additional bridges 120, which are interconnected with high-speed serial links or with multiple controllers 122-127, such as controller 127, that provide access to various different types of mass-storage devices 128, electronic displays, input devices, and other such components, subcomponents, and computational resources. It should be noted that computer-readable data-storage devices include optical and electromagnetic disks, electronic memories, and other physical data-storage devices. Those familiar with modern science and technology appreciate that electromagnetic radiation and propagating signals do not store data for subsequent retrieval and can transiently “store” only a byte or less of information per mile, far less information than needed to encode even the simplest of routines.

Of course, there are many different types of computer-system architectures that differ from one another in the number of different memories, including different types of hierarchical cache memories, the number of processors and the connectivity of the processors with other system components, the number of internal communications busses and serial links, and in many other ways. However, computer systems generally execute stored programs by fetching instructions from memory and executing the instructions in one or more processors. Computer systems include general-purpose computer systems, such as personal computers (“PCs”), various types of servers and workstations, and higher-end mainframe computers, but may also include a plethora of various types of special-purpose computing devices, including data-storage systems, communications routers, network nodes, tablet computers, and mobile telephones.

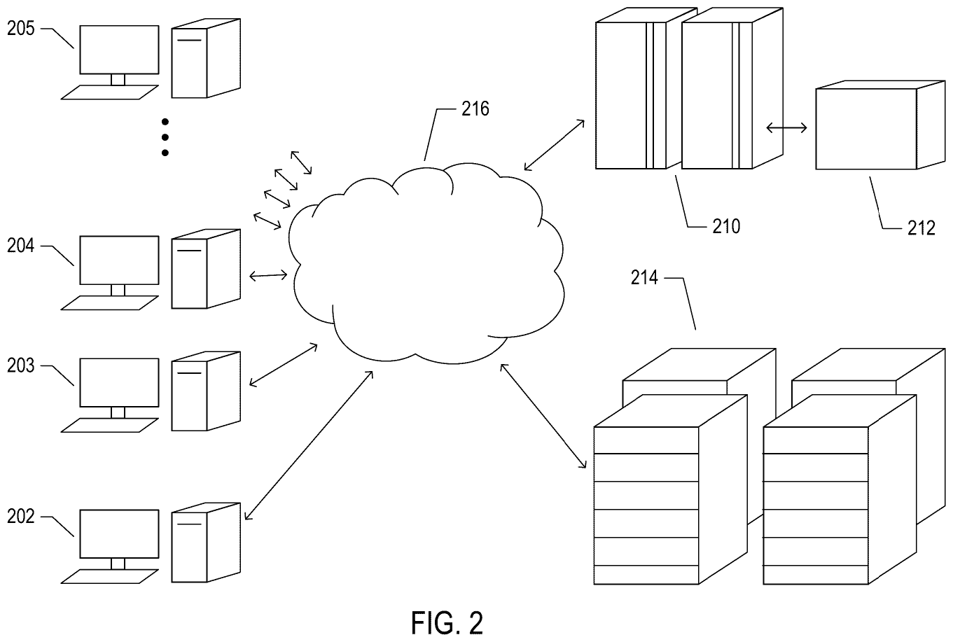

FIG. 2 illustrates an Internet-connected distributed computing system. As communications and networking technologies have evolved in capability and accessibility, and as the computational bandwidths, data-storage capacities, and other capabilities and capacities of various types of computer systems have steadily and rapidly increased, much of modern computing now generally involves large distributed systems and computers interconnected by local networks, wide-area networks, wireless communications, and the Internet. FIG. 2 shows a typical distributed system in which a large number of PCs 202-205, a high-end distributed mainframe system 210 with a large data-storage system 212, and a large computer center 214 with large numbers of rack-mounted servers or blade servers all interconnected through various communications and networking systems that together comprise the Internet 216. Such distributed computing systems provide diverse arrays of functionalities. For example, a PC user sitting in a home office may access hundreds of millions of different web sites provided by hundreds of thousands of different web servers throughout the world and may access high-computational-bandwidth computing services from remote computer facilities for running complex computational tasks.

Until recently, computational services were generally provided by computer systems and data centers purchased, configured, managed, and maintained by service-provider organizations. For example, an e-commerce retailer generally purchased, configured, managed, and maintained a data center including numerous web servers, back-end computer systems, and data-storage systems for serving web pages to remote customers, receiving orders through the web-page interface, processing the orders, tracking completed orders, and other myriad different tasks associated with an e-commerce enterprise.

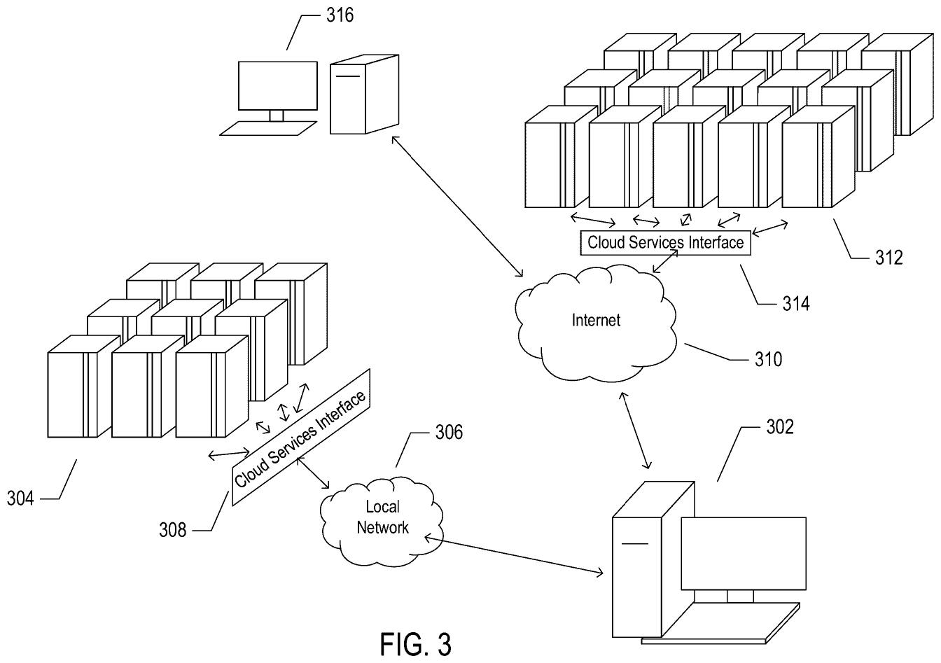

FIG. 3 illustrates cloud computing. In the recently developed cloud-computing paradigm, computing cycles and data-storage facilities are provided to organizations and individuals by cloud-computing providers. In addition, larger organizations may elect to establish private cloud-computing facilities in addition to, or instead of, subscribing to computing services provided by public cloud-computing service providers. In FIG. 3, a system administrator for an organization, using a PC 302, accesses the organization's private cloud 304 through a local network 306 and private-cloud interface 308 and also accesses, through the Internet 310, a public cloud 312 through a public-cloud services interface 314. The administrator can, in either the case of the private cloud 304 or public cloud 312, configure virtual computer systems and even entire virtual data centers and launch execution of application programs on the virtual computer systems and virtual data centers in order to carry out any of many different types of computational tasks. As one example, a small organization may configure and run a virtual data center within a public cloud that executes web servers to provide an e-commerce interface through the public cloud to remote customers of the organization, such as a user viewing the organization's e-commerce web pages on a remote user system 316.

Cloud-computing facilities are intended to provide computational bandwidth and data-storage services much as utility companies provide electrical power and water to consumers. Cloud computing provides enormous advantages to small organizations without the resources to purchase, manage, and maintain in-house data centers. Such organizations can dynamically add and delete virtual computer systems from their virtual data centers within public clouds in order to track computational-bandwidth and data-storage needs, rather than purchasing sufficient computer systems within a physical data center to handle peak computational-bandwidth and data-storage demands. Moreover, small organizations can completely avoid the overhead of maintaining and managing physical computer systems, including hiring and periodically retraining information-technology specialists and continuously paying for operating-system and database-management-system upgrades. Furthermore, cloud-computing interfaces allow for easy and straightforward configuration of virtual computing facilities, flexibility in the types of applications and operating systems that can be configured, and other functionalities that are useful even for owners and administrators of private cloud-computing facilities used by a single organization.

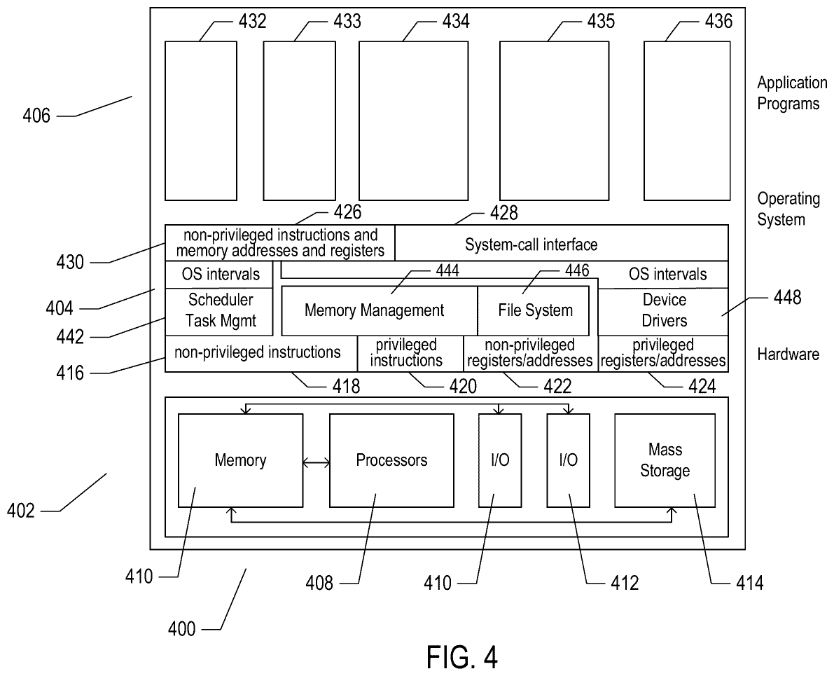

FIG. 4 illustrates generalized hardware and software components of a general-purpose computer system, such as a general-purpose computer system having an architecture similar to that shown in FIG. 1. The computer system 400 is often considered to include three fundamental layers: (1) a hardware layer or level 402; (2) an operating-system layer or level 404; and (3) an application-program layer or level 406. The hardware layer 402 includes one or more processors 408, system memory 410, various different types of input-output (“I/O”) devices 410 and 412, and mass-storage devices 414. Of course, the hardware level also includes many other components, including power supplies, internal communications links and busses, specialized integrated circuits, many different types of processor-controlled or microprocessor-controlled peripheral devices and controllers, and many other components. The operating system 404 interfaces to the hardware level 402 through a low-level operating system and hardware interface 416 generally comprising a set of non-privileged computer instructions 418, a set of privileged computer instructions 420, a set of non-privileged registers and memory addresses 422, and a set of privileged registers and memory addresses 424. In general, the operating system exposes non-privileged instructions, non-privileged registers, and non-privileged memory addresses 426 and a system-call interface 428 as an operating-system interface 430 to application programs 432-436 that execute within an execution environment provided to the application programs by the operating system. The operating system, alone, accesses the privileged instructions, privileged registers, and privileged memory addresses. By reserving access to privileged instructions, privileged registers, and privileged memory addresses, the operating system can ensure that application programs and other higher-level computational entities cannot interfere with one another's execution and cannot change the overall state of the computer system in ways that could deleteriously impact system operation. The operating system includes many internal components and modules, including a scheduler 442, memory management 444, a file system 446, device drivers 448, and many other components and modules. To a certain degree, modern operating systems provide numerous levels of abstraction above the hardware level, including virtual memory, which provides to each application program and other computational entities a separate, large, linear memory-address space that is mapped by the operating system to various electronic memories and mass-storage devices. The scheduler orchestrates interleaved execution of various different application programs and higher-level computational entities, providing to each application program a virtual, stand-alone system devoted entirely to the application program. From the application program's standpoint, the application program executes continuously without concern for the need to share processor resources and other system resources with other application programs and higher-level computational entities. The device drivers abstract details of hardware-component operation, allowing application programs to employ the system-call interface for transmitting and receiving data to and from communications networks, mass-storage devices, and other I/O devices and subsystems. The file system 436 facilitates abstraction of mass-storage-device and memory resources as a high-level, easy-to-access, file-system interface. Thus, the development and evolution of the operating system has resulted in the generation of a type of multi-faceted virtual execution environment for application programs and other higher-level computational entities.

While the execution environments provided by operating systems have proved to be an enormously successful level of abstraction within computer systems, the operating-system-provided level of abstraction is nonetheless associated with difficulties and challenges for developers and users of application programs and other higher-level computational entities. One difficulty arises from the fact that there are many different operating systems that run within various different types of computer hardware. In many cases, popular application programs and computational systems are developed to run on only a subset of the available operating systems and can therefore be executed within only a subset of the various different types of computer systems on which the operating systems are designed to run. Often, even when an application program or other computational system is ported to additional operating systems, the application program or other computational system can nonetheless run more efficiently on the operating systems for which the application program or other computational system was originally targeted. Another difficulty arises from the increasingly distributed nature of computer systems. Although distributed operating systems are the subject of considerable research and development efforts, many of the popular operating systems are designed primarily for execution on a single computer system. In many cases, it is difficult to move application programs, in real time, between the different computer systems of a distributed computing system for high-availability, fault-tolerance, and load-balancing purposes. The problems are even greater in heterogeneous distributed computing systems which include different types of hardware and devices running different types of operating systems. Operating systems continue to evolve, as a result of which certain older application programs and other computational entities may be incompatible with more recent versions of operating systems for which they are targeted, creating compatibility issues that are particularly difficult to manage in large distributed systems.

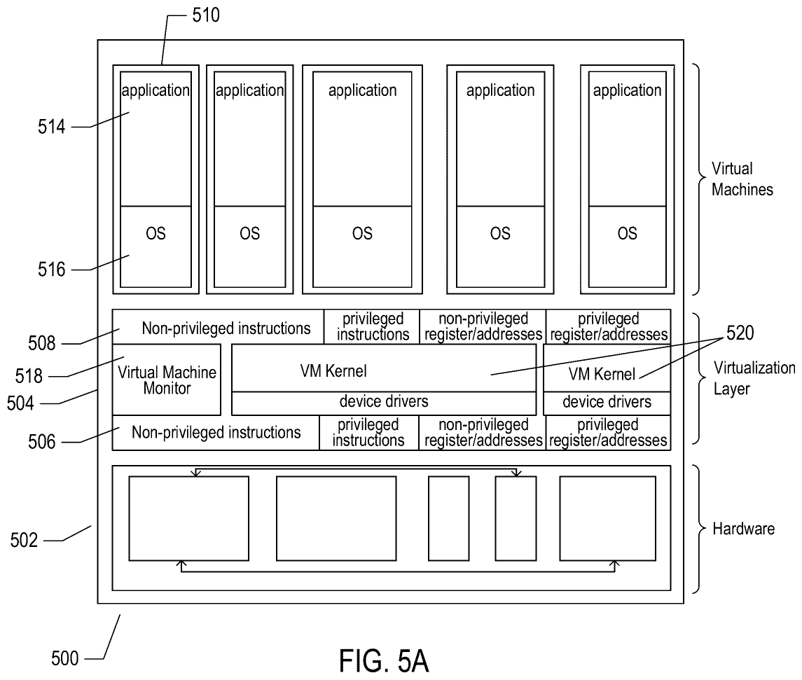

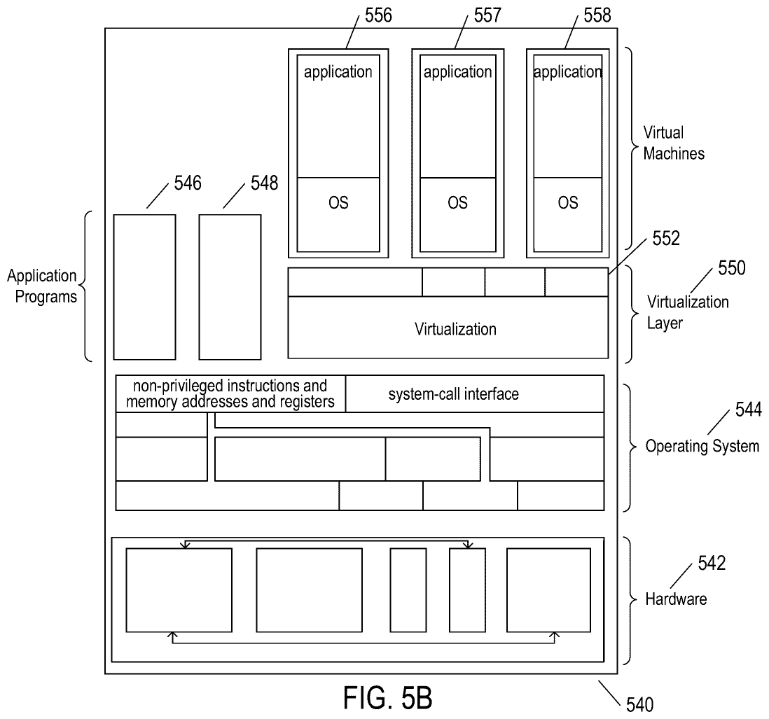

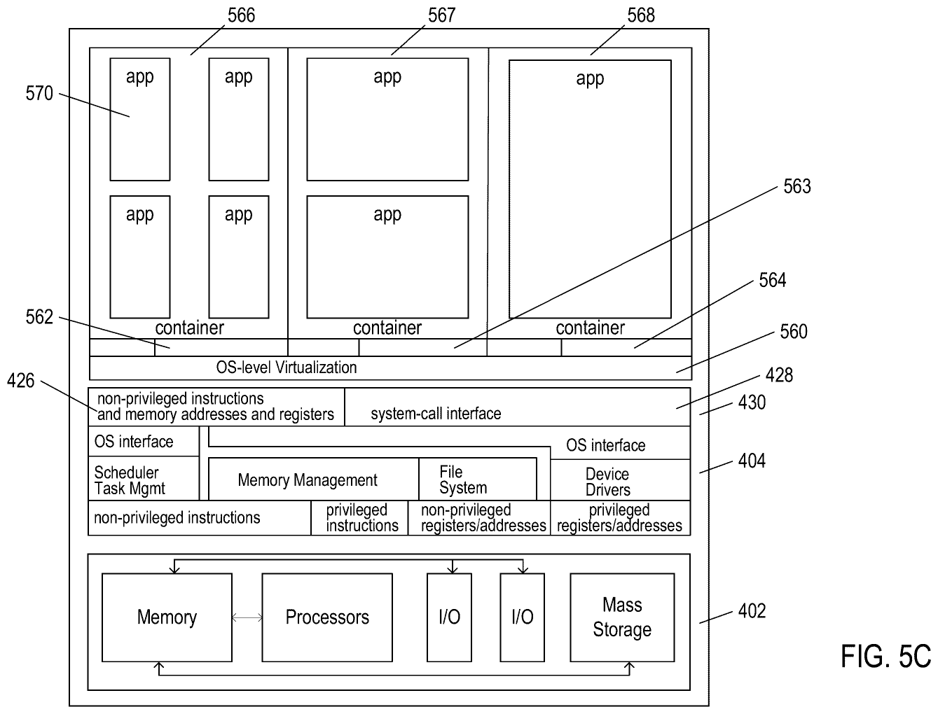

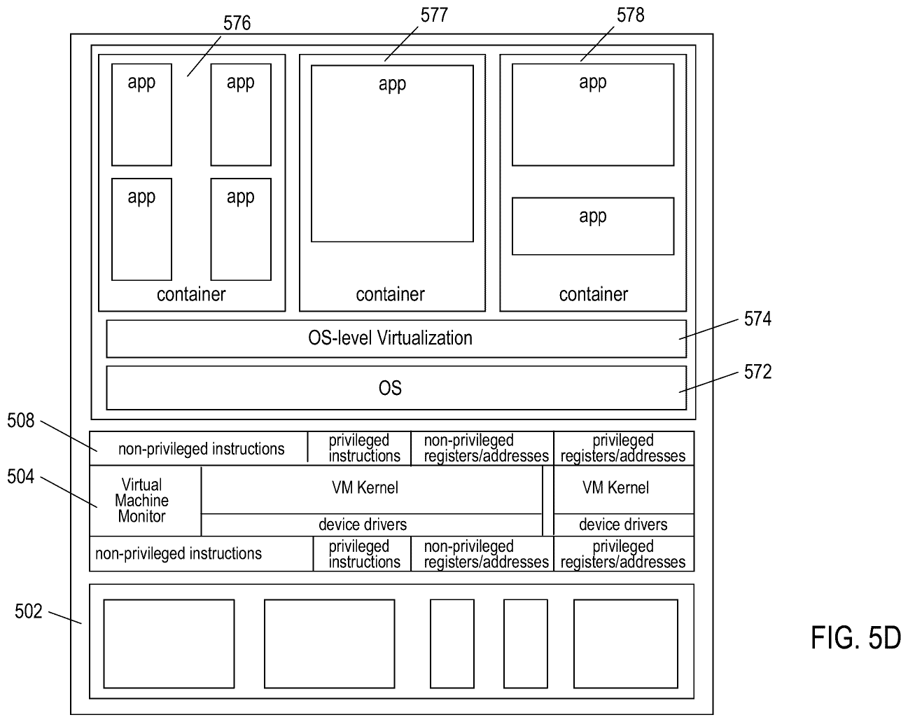

For all of these reasons, a higher level of abstraction, referred to as the “virtual machine,” has been developed and evolved to further abstract computer hardware in order to address many difficulties and challenges associated with traditional computing systems, including the compatibility issues discussed above. FIGS. 5A-D illustrate several types of virtual machine and virtual-machine execution environments. FIGS. 5A-B use the same illustration conventions as used in FIG. 4. FIG. 5A shows a first type of virtualization. The computer system 500 in FIG. 5A includes the same hardware layer 502 as the hardware layer 402 shown in FIG. 4. However, rather than providing an operating system layer directly above the hardware layer, as in FIG. 4, the virtualized computing environment illustrated in FIG. 5A features a virtualization layer 504 that interfaces through a virtualization-layer/hardware-layer interface 506, equivalent to interface 416 in FIG. 4, to the hardware. The virtualization layer provides a hardware-like interface 508 to a number of virtual machines, such as virtual machine 510, executing above the virtualization layer in a virtual-machine layer 512. Each virtual machine includes one or more application programs or other higher-level computational entities packaged together with an operating system, referred to as a “guest operating system,” such as application 514 and guest operating system 516 packaged together within virtual machine 510. Each virtual machine is thus equivalent to the operating-system layer 404 and application-program layer 406 in the general-purpose computer system shown in FIG. 4. Each guest operating system within a virtual machine interfaces to the virtualization-layer interface 508 rather than to the actual hardware interface 506. The virtualization layer partitions hardware resources into abstract virtual-hardware layers to which each guest operating system within a virtual machine interfaces. The guest operating systems within the virtual machines, in general, are unaware of the virtualization layer and operate as if they were directly accessing a true hardware interface. The virtualization layer ensures that each of the virtual machines currently executing within the virtual environment receive a fair allocation of underlying hardware resources and that all virtual machines receive sufficient resources to progress in execution. The virtualization-layer interface 508 may differ for different guest operating systems. For example, the virtualization layer is generally able to provide virtual hardware interfaces for a variety of different types of computer hardware. This allows, as one example, a virtual machine that includes a guest operating system designed for a particular computer architecture to run on hardware of a different architecture. The number of virtual machines need not be equal to the number of physical processors or even a multiple of the number of processors.

The virtualization layer includes a virtual-machine-monitor module 518 (“VMM”) that virtualizes physical processors in the hardware layer to create virtual processors on which each of the virtual machines executes. For execution efficiency, the virtualization layer attempts to allow virtual machines to directly execute non-privileged instructions and to directly access non-privileged registers and memory. However, when the guest operating system within a virtual machine accesses virtual privileged instructions, virtual privileged registers, and virtual privileged memory through the virtualization-layer interface 508, the accesses result in execution of virtualization-layer code to simulate or emulate the privileged resources. The virtualization layer additionally includes a kernel module 520 that manages memory, communications, and data-storage machine resources on behalf of executing virtual machines (“VM kernel”). The VM kernel, for example, maintains shadow page tables on each virtual machine so that hardware-level virtual-memory facilities can be used to process memory accesses. The VM kernel additionally includes routines that implement virtual communications and data-storage devices as well as device drivers that directly control the operation of underlying hardware communications and data-storage devices. Similarly, the VM kernel virtualizes various other types of I/O devices, including keyboards, optical-disk drives, and other such devices. The virtualization layer essentially schedules execution of virtual machines much like an operating system schedules execution of application programs, so that the virtual machines each execute within a complete and fully functional virtual hardware layer.

FIG. 5B illustrates a second type of virtualization. In FIG. 5B, the computer system 540 includes the same hardware layer 542 and software layer 544 as the hardware layer 402 shown in FIG. 4. Several application programs 546 and 548 are shown running in the execution environment provided by the operating system. In addition, a virtualization layer 550 is also provided, in computer 540, but, unlike the virtualization layer 504 discussed with reference to FIG. 5A, virtualization layer 550 is layered above the operating system 544, referred to as the “host OS,” and uses the operating system interface to access operating-system-provided functionality as well as the hardware. The virtualization layer 550 comprises primarily a VMM and a hardware-like interface 552, similar to hardware-like interface 508 in FIG. 5A. The virtualization-layer/hardware-layer interface 552, equivalent to interface 416 in FIG. 4, provides an execution environment for a number of virtual machines 556-558, each including one or more application programs or other higher-level computational entities packaged together with a guest operating system.

While the traditional virtual-machine-based virtualization layers, described with reference to FIGS. 5A-B, have enjoyed widespread adoption and use in a variety of different environments, from personal computers to enormous, distributed computing systems, traditional virtualization technologies are associated with computational overheads. While these computational overheads have been steadily decreased, over the years, and often represent ten percent or less of the total computational bandwidth consumed by an application running in a virtualized environment, traditional virtualization technologies nonetheless involve computational costs in return for the power and flexibility that they provide. Another approach to virtualization is referred to as operating-system-level virtualization (“OSL virtualization”). FIG. 5C illustrates the OSL-virtualization approach. In FIG. 5C, as in previously discussed FIG. 4, an operating system 404 runs above the hardware 402 of a host computer. The operating system provides an interface for higher-level computational entities, the interface including a system-call interface 428 and exposure to the non-privileged instructions and memory addresses and registers 426 of the hardware layer 402. However, unlike in FIG. 5A, rather than applications running directly above the operating system, OSL virtualization involves an OS-level virtualization layer 560 that provides an operating-system interface 562-564 to each of one or more containers 566-568. The containers, in turn, provide an execution environment for one or more applications, such as application 570 running within the execution environment provided by container 566. The container can be thought of as a partition of the resources generally available to higher-level computational entities through the operating system interface 430. While a traditional virtualization layer can simulate the hardware interface expected by any of many different operating systems, OSL virtualization essentially provides a secure partition of the execution environment provided by a particular operating system. As one example, OSL virtualization provides a file system to each container, but the file system provided to the container is essentially a view of a partition of the general file system provided by the underlying operating system. In essence, OSL virtualization uses operating-system features, such as namespace support, to isolate each container from the remaining containers so that the applications executing within the execution environment provided by a container are isolated from applications executing within the execution environments provided by all other containers. As a result, a container can be booted up much faster than a virtual machine, since the container uses operating-system-kernel features that are already available within the host computer. Furthermore, the containers share computational bandwidth, memory, network bandwidth, and other computational resources provided by the operating system, without resource overhead allocated to virtual machines and virtualization layers. Again, however, OSL virtualization does not provide many desirable features of traditional virtualization. As mentioned above, OSL virtualization does not provide a way to run different types of operating systems for different groups of containers within the same host system, nor does OSL-virtualization provide for live migration of containers between host computers, as does traditional virtualization technologies.

FIG. 5D illustrates an approach to combining the power and flexibility of traditional virtualization with the advantages of OSL virtualization. FIG. 5D shows a host computer similar to that shown in FIG. 5A, discussed above. The host computer includes a hardware layer 502 and a virtualization layer 504 that provides a simulated hardware interface 508 to an operating system 572. Unlike in FIG. 5A, the operating system interfaces to an OSL-virtualization layer 574 that provides container execution environments 576-578 to multiple application programs. Running containers above a guest operating system within a virtualized host computer provides many of the advantages of traditional virtualization and OSL virtualization. Containers can be quickly booted in order to provide additional execution environments and associated resources to new applications. The resources available to the guest operating system are efficiently partitioned among the containers provided by the OSL-virtualization layer 574. Many of the powerful and flexible features of the traditional virtualization technology can be applied to containers running above guest operating systems including live migration from one host computer to another, various types of high-availability and distributed resource sharing, and other such features. Containers provide share-based allocation of computational resources to groups of applications with guaranteed isolation of applications in one container from applications in the remaining containers executing above a guest operating system. Moreover, resource allocation can be modified at run time between containers. The traditional virtualization layer provides flexible and easy scaling and a simple approach to operating-system upgrades and patches. Thus, the use of OSL virtualization above traditional virtualization, as illustrated in FIG. 5D, provides much of the advantages of both a traditional virtualization layer and the advantages of OSL virtualization. Note that, although only a single guest operating system and OSL virtualization layer as shown in FIG. 5D, a single virtualized host system can run multiple different guest operating systems within multiple virtual machines, each of which supports one or more containers.

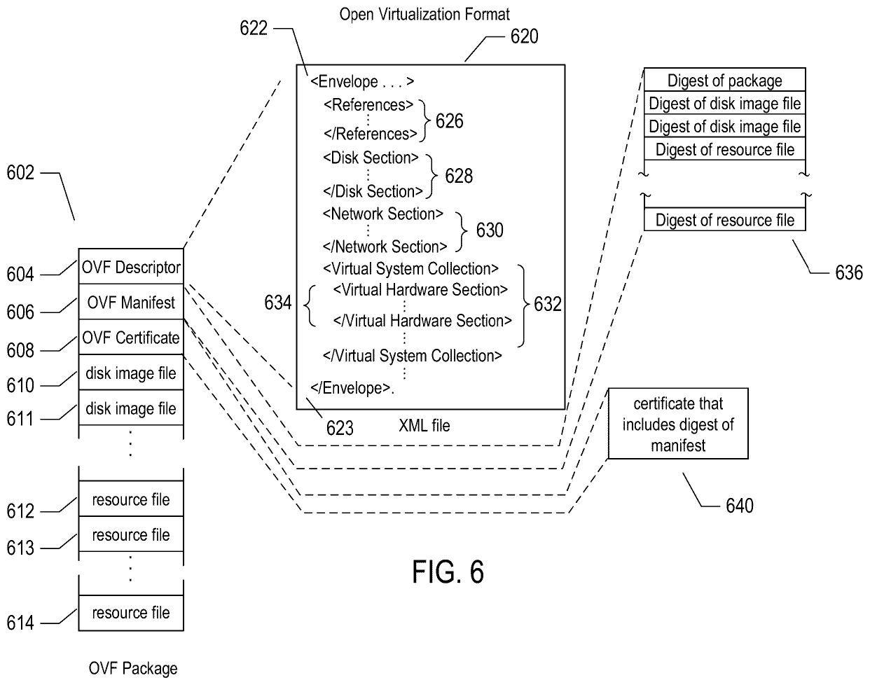

A virtual machine or virtual application, described below, is encapsulated within a data package for transmission, distribution, and loading into a virtual-execution environment. One public standard for virtual-machine encapsulation is referred to as the “open virtualization format” (“OVF”). The OVF standard specifies a format for digitally encoding a virtual machine within one or more data files. FIG. 6 illustrates an OVF package. An OVF package 602 includes an OVF descriptor 604, an OVF manifest 606, an OVF certificate 608, one or more disk-image files 610-611, and one or more resource files 612-614. The OVF package can be encoded and stored as a single file or as a set of files. The OVF descriptor 604 is an XML document 620 that includes a hierarchical set of elements, each demarcated by a beginning tag and an ending tag. The outermost, or highest-level, element is the envelope element, demarcated by tags 622 and 623. The next-level element includes a reference element 626 that includes references to all files that are part of the OVF package, a disk section 628 that contains meta information about all of the virtual disks included in the OVF package, a networks section 630 that includes meta information about all of the logical networks included in the OVF package, and a collection of virtual-machine configurations 632 which further includes hardware descriptions of each virtual machine 634. There are many additional hierarchical levels and elements within a typical OVF descriptor. The OVF descriptor is thus a self-describing XML file that describes the contents of an OVF package. The OVF manifest 606 is a list of cryptographic-hash-function-generated digests 636 of the entire OVF package and of the various components of the OVF package. The OVF certificate 608 is an authentication certificate 640 that includes a digest of the manifest and that is cryptographically signed. Disk image files, such as disk image file 610, are digital encodings of the contents of virtual disks and resource files 612 are digitally encoded content, such as operating-system images. A virtual machine or a collection of virtual machines encapsulated together within a virtual application can thus be digitally encoded as one or more files within an OVF package that can be transmitted, distributed, and loaded using well-known tools for transmitting, distributing, and loading files. A virtual appliance is a software service that is delivered as a complete software stack installed within one or more virtual machines that is encoded within an OVF package.

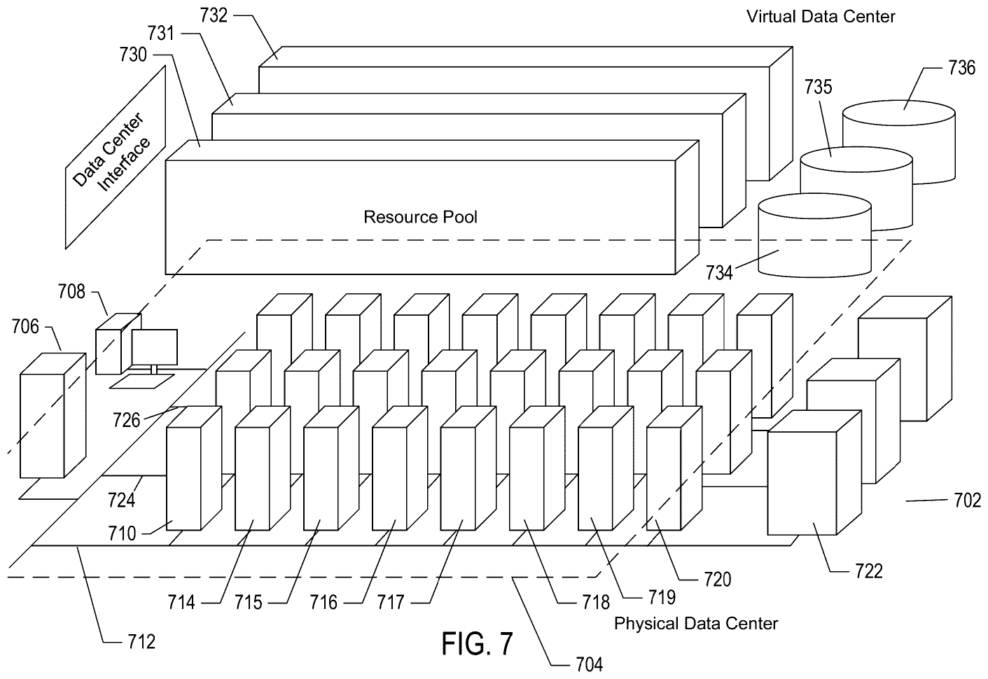

The advent of virtual machines and virtual environments has alleviated many of the difficulties and challenges associated with traditional general-purpose computing. Machine and operating-system dependencies can be significantly reduced or entirely eliminated by packaging applications and operating systems together as virtual machines and virtual appliances that execute within virtual environments provided by virtualization layers running on many different types of computer hardware. A next level of abstraction, referred to as virtual data centers which are one example of a broader virtual-infrastructure category, provide a data-center interface to virtual data centers computationally constructed within physical data centers. FIG. 7 illustrates virtual data centers provided as an abstraction of underlying physical-data-center hardware components. In FIG. 7, a physical data center 702 is shown below a virtual-interface plane 704. The physical data center consists of a virtual-infrastructure management server (“VI-management-server”) 706 and any of various different computers, such as PCs 708, on which a virtual-data-center management interface may be displayed to system administrators and other users. The physical data center additionally includes generally large numbers of server computers, such as server computer 710, that are coupled together by local area networks, such as local area network 712 that directly interconnects server computer 710 and 714-720 and a mass-storage array 722. The physical data center shown in FIG. 7 includes three local area networks 712, 724, and 726 that each directly interconnects a bank of eight servers and a mass-storage array. The individual server computers, such as server computer 710, each includes a virtualization layer and runs multiple virtual machines. Different physical data centers may include many different types of computers, networks, data-storage systems and devices connected according to many different types of connection topologies. The virtual-data-center abstraction layer 704, a logical abstraction layer shown by a plane in FIG. 7, abstracts the physical data center to a virtual data center comprising one or more resource pools, such as resource pools 730-732, one or more virtual data stores, such as virtual data stores 734-736, and one or more virtual networks. In certain implementations, the resource pools abstract banks of physical servers directly interconnected by a local area network.

### Overview of an IaC Cloud-Infrastructure-Management Service

FIG. 8 illustrates a number of different cloud-computing facilities that provide computational infrastructure to an organization for supporting the organization's distributed applications and services. The cloud-computing facilities are each represented by an array of cabinets containing servers, data-storage appliances, communications hardware, and other computational resources, such as the array of cabinets 802. Each cloud-computing facility provides a management interface, such as management interface 804 associated with cloud-computing facility 802. The organization leases computational resources from a number of native-public-cloud cloud-computing facilities 802 and 806-810 and also obtains computational resources from multiple private-cloud cloud-computing facilities 811-813. The organization may wish to move distributed-application and distributed-service instances among the cloud-computing facilities to take advantage of favorable leasing rates, lower communications latencies, and desirable features and policies provided by particular cloud-computing facilities. In addition, the organization may wish to scale-up or scale-down the computational resources leased from different cloud-computing facilities in order to efficiently handle dynamic workloads. All of these types of operations involve issuing commands and requests through the management interfaces associated with the cloud-computing facilities. In the example shown in FIG. 8, cloud-computing facilities 802 and 806 are accessed through a first type of management interface, cloud-computing facilities 808 in 810 are accessed through a second type of management interface, and cloud-computing facilities 807 and 809 are accessed through a third type of management interface. The management interfaces associated with private-cloud cloud-computing facilities 811-813 are different from one another and from the native-public-cloud management interfaces.

The many different management interfaces represent a challenge to management and administration personnel within the organization. The management personnel need to be familiar with a variety of different management interfaces that may involve different command sets, different command-set syntaxes, and different features, In addition, the different management interfaces may accept different types of blueprints or cloud templates that specify the infrastructure and infrastructure configuration desired by the organization. It may be difficult for management personnel to determine whether certain desired features and functionalities easily accessed and obtained through certain types of management interfaces are even provided by cloud-computing facilities associated with other types of management interfaces. Different management interfaces may require different types of authentication and authorization credentials which further complicates management operations performed by management and administration personnel. These problems may even be of greater significance when computational resources are leased from cloud-computing facilities and configured and managed by automated management systems.

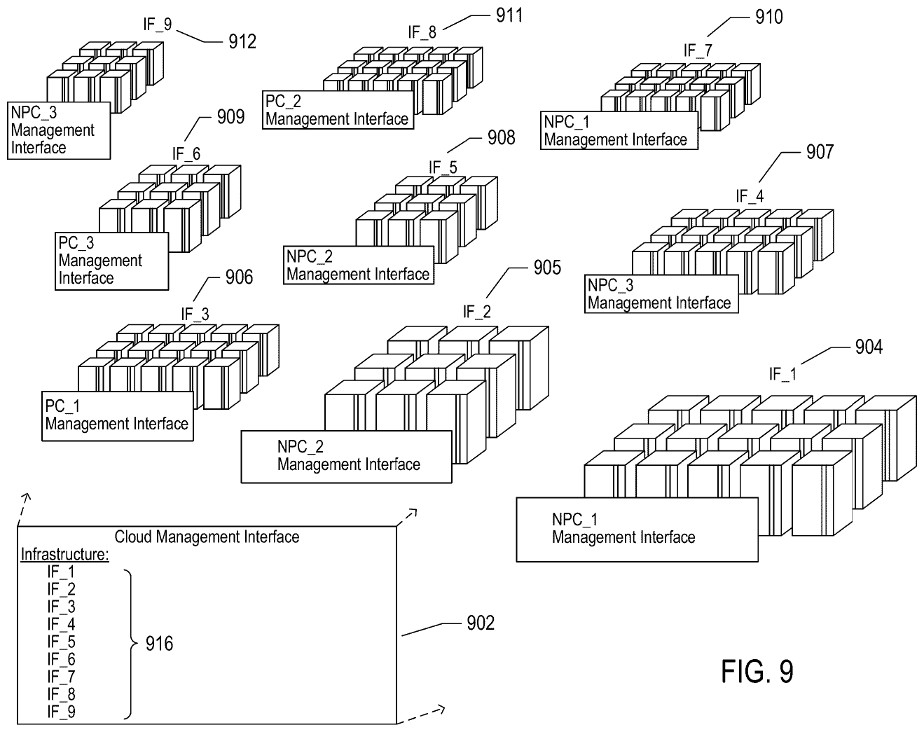

To address the problems associated with multiple different management interfaces to multiple different cloud-computing facilities, discussed in the preceding paragraph, an IaC cloud-infrastructure-management service provides a single, universal management interface through which management and administration personnel as well as automated management systems define and deploy cloud-based infrastructure within many different types of cloud-computing facilities. FIG. 9 illustrates a universal-management-interface provided by the IaC cloud-infrastructure-management service. The IaC cloud-infrastructure-management service provides a cloud-management interface 902 through which both human management personnel and automated management systems can manage computational infrastructure provided by many different types of underlying cloud-computing facilities associated with various different types of management interfaces. The infrastructure deployed and configured within the various cloud-computing facilities is represented in FIG. 9 by the labels “IF_1” 904, “IF_2” 905, “IF_3” 906, “IF_4” 907, “IF_5” 908, “IF_6” 909, “IF_7” 910, “IF_8” 9011, and “IF_9” 912. The IaC cloud-infrastructure-management service maintains the required authentication and authorization credentials for the different underlying cloud-computing facilities on behalf of human management personnel and automated management systems and automatically provides the required authentication and authorization credentials when accessing management interfaces provided by the different underlying cloud-computing facilities. One or more common types of cloud templates or blueprints are used to specify desired infrastructure and desired infrastructure configuration within the underlying cloud-computing facilities. Each different set of computational resources that together constitute an infrastructure within each of the cloud-computing facilities is visible, and can be managed, through the cloud-management interface 902, as indicated by the infrastructure labels 916 shown within the cloud-management interface.

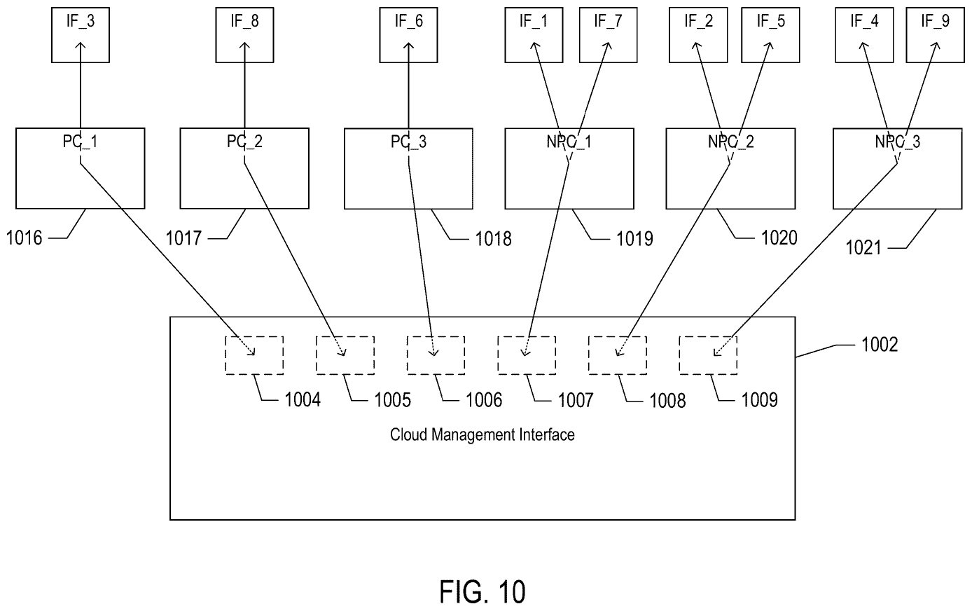

FIG. 10 illustrates a portion of the architecture of the IaC cloud-infrastructure-management service. The IaC cloud-infrastructure-management service provides a cloud-management interface 1002 that includes a common or universal set of commands that can be used to deploy and configure infrastructure in many different types of private-cloud and native-public-cloud cloud-computing facilities that provide various types of cloud-management interfaces, allowing management and administration personnel and upstream automated infrastructure-management systems to deploy and configure infrastructure across the many different types of cloud-computing facilities through a common cloud-management interface 1002. The cloud-management interface 1002 is implemented by the IaC cloud-infrastructure-management service, discussed below. The IaC cloud-infrastructure-management service includes cloud-computing-facility-specific plug-ins, represented by dashed-line rectangles 1004-1009, that implement, together with control logic within the IaC cloud-infrastructure-management service, translation of the commands and features of the cloud-management interface 1002 to the commands and features of the underlying cloud-facility-specific management interfaces 1016-1021.

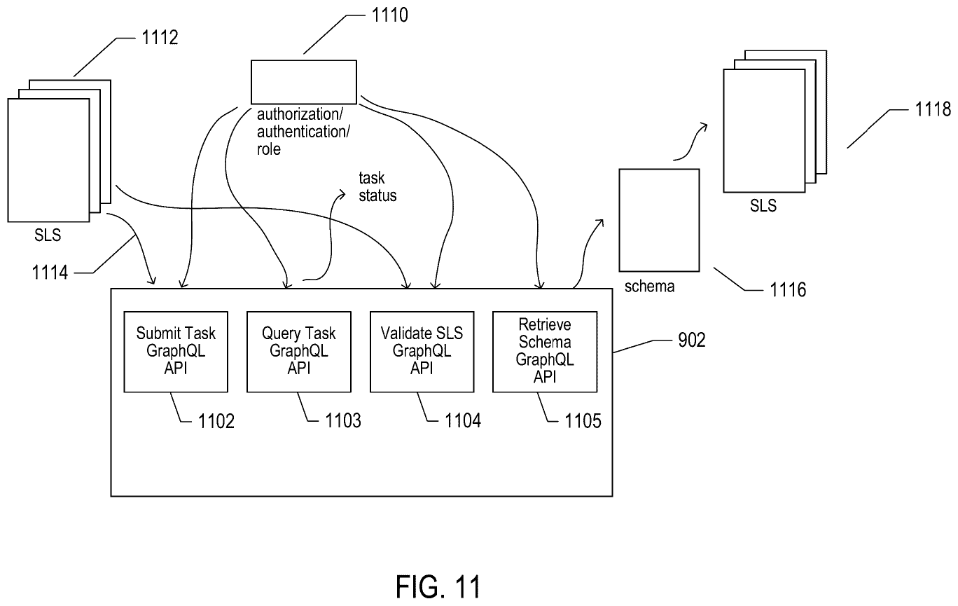

FIG. 11 illustrates the cloud-management interface provided by the IaC cloud-infrastructure-management service. The cloud-management interface 902 includes four different GraphQL application programming interfaces (“APIs”): (1) Submit Task 1102, through which deployment-and-configuration commands are input to the IaC cloud-infrastructure-management service; (2) Query Task 1103, through which status queries for previously submitted deployment-and-configuration commands and requests are input to the IaC cloud-infrastructure-management service; (3) Validate SLS 1104, through which requests to validate SLS data are input to the IaC cloud-infrastructure-management service; and (4) Retrieved Schema 1105, through which the schemas for infrastructures within underlying computing-facilities can be requested from the IaC cloud-infrastructure-management service. Requests and commands input to the IaC cloud-infrastructure-management service are generally accompanied with an authorization/authentication/role certificate or token 1110, deployment-and-configuration tasks submitted to the Submit Task API are generally accompanied with SLS data 1112 (described below), and requests for validation of SLS data are accompanied with the SLS data to be validated, as indicated by curved arrows, such as curved arrow 1114, in FIG. 11. The schema 1116 returned when a command input to the Retrieve Schema API is executed is convertible into an SLS-data specification 1118 which can be input to the Submit Task API and/or modified and input to the Submit Task API.

There are, however, many different types of IaC cloud-infrastructure-management service or system implementations. For example, an IaC cloud-infrastructure-management service or system may be alternatively implemented as a collection of plug-ins that together comprise a cloud-infrastructure-management engine and a command-line interface (“CLI”). It is, for this reason, that the current document uses the phrase “service or system” to indicate that the IaC cloud-infrastructure-management service is but one implementation approach to implementing cloud-infrastructure-management. To avoid repeating this phrase, the phrase “cloud-infrastructure manager” is used to refer to the various possible implementations of IaC cloud-infrastructure-management services or systems.

### GraphQL Interface

FIG. 12 illustrates components of a GraphQL interface. The GraphQL interface is used as an API interface by various types of services and distributed applications. For example, as shown in FIG. 12, a server 1202 provides a service that communicates with a service client 1204 through a GraphQL API provided by the server. The service client 1204 can be viewed as a computational process that uses client-side GraphQL functionality 1206 to allow an application or user interface 1208 to access services and information provided by the server 1202. The server uses server-side GraphQL functionality 1210, components of which include a query processor 1212, a storage schema 1214, and a resolver component 1216 that accesses various different microservices 1218-1223 to execute the GraphQL-encoded service requests made by the client to the server. Of course, a GraphQL API may be provided by multiple server processes in a distributed application and may be accessed by many different clients of the services provided by the distributed application. GraphQL provides numerous advantages with respect to the Representational State Transfer (“REST”) interface technology, including increased specificity and precision with which clients can request information from servers and a potential for increased data-transfer efficiencies.

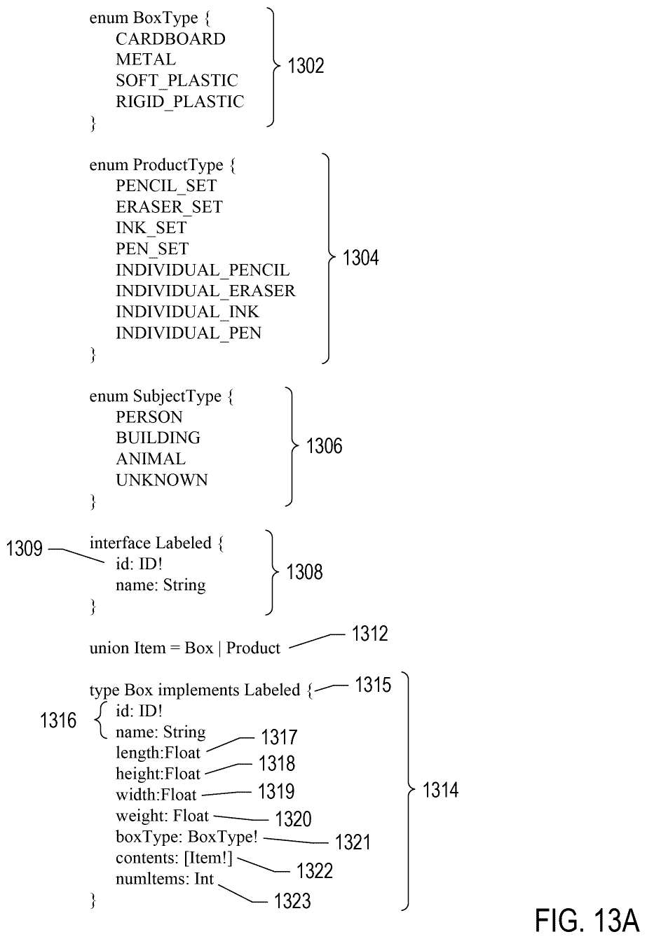

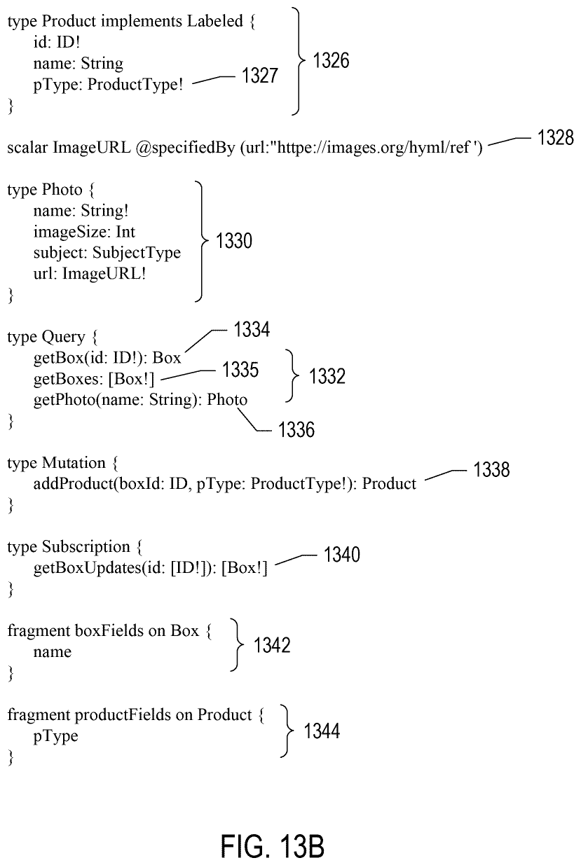

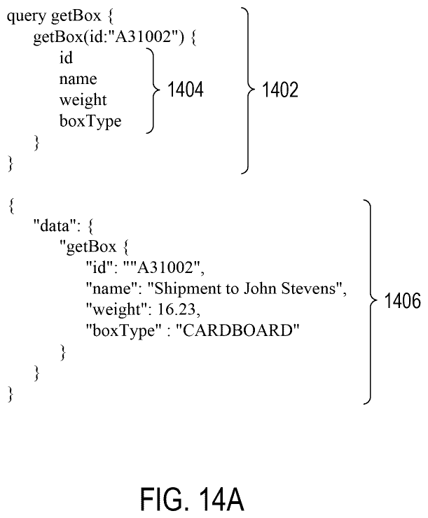

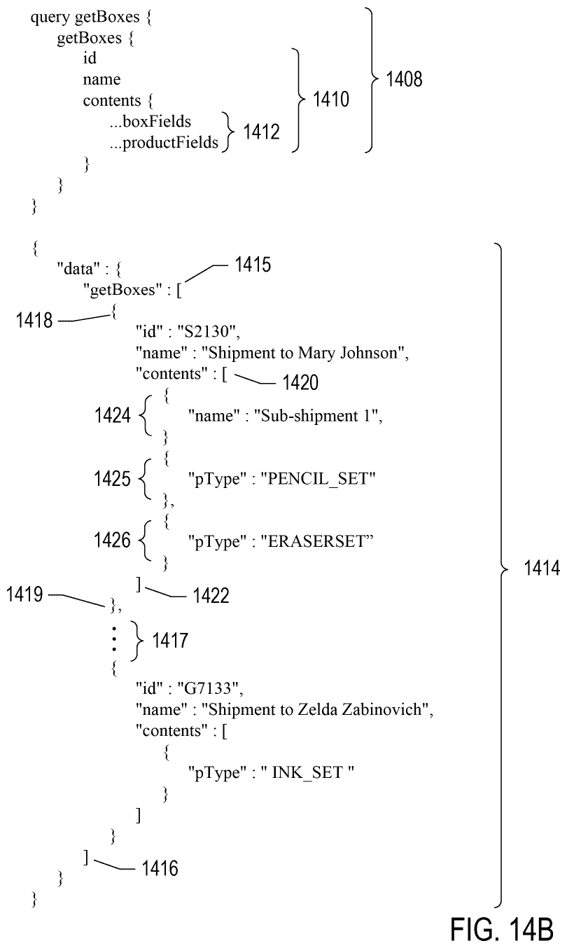

FIGS. 13A-B illustrate an example schema, an extension to that example schema, and queries, a mutation, and a subscription to illustrate the GraphQL query language. The example shown in FIGS. 13A-B does not illustrate all of the different GraphQL features and constructs, but a comprehensive specification for the GraphQL query language is provided by the GraphQL Foundation. A GraphQL schema can be thought of as the specification for an API for a service, distributed application, or other server-side entity. The example schema provided in FIGS. 13A-B is a portion of a very simple interface to a service that provides information about shipments of drafting products from a drafting-product retailer.

Three initial enumeration datatypes are specified in a first portion of FIG. 13A. The enumeration BoxType 1302 specifies an enumeration datatype with four possible values: “CARDBOARD,” “METAL,” “SOFT_PLASTIC,” and “RIGID_PLASTIC.” In the example schema, a box represents a shipment and the box type indicates the type of container in which the shipment is packaged. The enumeration ProductType 1304 specifies an enumeration datatype with eight possible values: “PENCIL_SET,” “ERASER_SET,” “INK_SET,” “PEN_SET,” “INDIVIDUAL_PENCIL,” “INDIVIDUAL_ERASER,” and “INDIVIDUAL_INK,” “INDIVIDUAL_PEN.” In the example schema, a shipment, or box, can contain products including sets of pencils, erasers, ink, and pens as well as individual pencils, erasers, ink, and pens. In addition, as discussed later, a shipment, or box, can also contain one or more boxes, or sub-shipments. The enumeration SubjectType 1306 specifies an enumeration datatype with four possible values: “PERSON,” “BUILDING,” “ANIMAL,” and “UNKNOWN.” In the example schema, the subject of a photograph is represented by one of the values of the enumeration SubjectType.

The interface datatype Labeled 1308 is next specified in the example schema. An interface datatype specifies a number of fields that are necessarily included in any object datatype that implements the interface. An example of such an object datatype is discussed below. The two fields required to be included in any object datatype that implements the interface Labeled include: (1) the field id 1309, of fundamental datatype ID; and (2) the field name 1310, of fundamental datatype String. The symbol “!” following the type specifier “ID” is a wrapping type that requires the field id to have a non-null value. The fundamental scalar datatypes in GraphQL include: (1) integers, Int; (2) floating-point values, Float; (3) Boolean values, Boolean; (4) string values, String; and (5) identifiers, ID. All of the more complex datatypes in GraphQL must ultimately comprise scalar datatypes, which can be thought of as the leaf nodes of a parse tree generated from parsing GraphQL queries, mutations, and subscriptions, discussed below. Wrapping datatypes include the non-null wrapping datatype discussed above and the list wrapping datatype indicated by bracketing a datatype, such as “[Int],” which specifies a list, or single-dimensional array, of integers or “[[Int]],” which specifies a list of lists or a two-dimensional matrix of integers.

The union Item 1312 is next specified in the example schema. A union datatype indicates that a field in an output data object can have one of the multiple datatypes indicated by the union specification. In this case, the datatype Item can be either a Box data object or a Product data object.

The Box object datatype 1314 is next specified in the example schema. An object datatype is a collection of fields that can have scalar-data-type values, wrapping-data-type values, or object data-type values. Because an object datatype may include one or more fields with object data-type values, object datatypes can describe hierarchical aggregations of data. The language “implements Labeled” 1315 indicates that the Box object datatype necessarily includes the interface Labeled fields id and name, discussed above, and those fields occur as the first two fields 1316 of the Box object datatype. The fields id and name represent a unique identifier and a name for the shipment represented by an instance of the Box object datatype. The additional fields in the Box object datatype include: (1) length 1317, of type Float, representing the length of the shipment container; (2) height 1318, of type Float, representing the height of the shipment container; (3) width 1319, of type Float, representing the width of the shipment container; (4) weight 1320, of type Float, representing the weight of the shipment container; (5) boxType 1321, of non-null enumeration type boxType, representing the type of shipment container; (6) contents 1322, an array of non-null Item data objects, representing the contents of the shipment; and (7) numItems 1323, of type Int, representing the number of items in the array contents. Since the field contents is an array of Item data objects, a box, or shipment, can contain one or more additional boxes, or sub-shipments. This illustrates how the GraphQL query language supports arbitrarily hierarchically nested data aggregations.

Turning to FIG. 13B, the example schema next specifies a Product 1326 object datatype that, like the Box object datatype, implements the interface Labeled and that additionally includes a field pType 1327 of enumeration type ProductType. An instance of the Product object datatype represents one of the different types of products that can be included in the shipment.

The example schema next specifies a custom scalar datatype ImageURL 1328 to store a Uniform Resource Locator (“URL”) for an image. The language “@specifiedBy( ) is a directive that takes a URL argument that references a description of how a String serialization of the custom scalar datatype ImageURL needs to be composed and formatted in order to represent a URL for an image. GraphQL supports a number of built-in directives and allows for specification of custom directives. Directives are essentially specifications of run-time execution details that are carried out by a server-side query processor that processes GraphQL queries, mutations, and subscriptions, discussed below. As another example, built-in directives can control query-execution to omit or include certain fields in returned data objects based on variables evaluated at the query-execution time. It should also be noted that fields in object datatypes may also take arguments, since fields are actually functions that return the specified datatypes. Arguments supplied to fields, like arguments supplied to directives, are evaluated and used at query-execution time by query processors.

The example schema next specifies the Photo object datatype 1330, which represents a photograph or image that can be accessed through the service API specified by the schema. The Photo object datatype includes fields that represent the name of the photo, and image size, the type of subject of the photo or image, and in image URL.

The example schema next specifies three queries, a mutation, and a subscription for the root Query, Mutation, and Subscription operations. A query, like a database query, requests the server-side GraphQL entity to return information specified by the query. Thus, a query is essentially an information request, similar to a GET operation on a REST API. A mutation is a request to alter stored information and is thus similar to a PUT or PATCH operation on a REST API. In addition, a mutation returns requested information. A subscription is a request to open a connection or channel through which a GraphQL client receives specified information as the information becomes available to the GraphQL server that processes the subscription request. Thus, the various data objects specified in the schema provide the basis for constructing queries, mutations, and subscriptions that allow a client to request and receive information from a server. The example schema specifies three different types of queries 1332 that can be directed, by a client, to the server via the GraphQL interface: (1) getBox 1334, which receives an identifier for a Box data object as an argument and returns a Box data object in response; (2) getBoxes 1335, which returns a list or array of Box data objects in response; and (3) getPhoto 1336, which receives the name of a photo or image as an input argument and returns a Photo data object in response. These are three examples of the many different types of queries that might be implemented in the GraphQL interface. A single mutation addProduct 1338 is specified, which receives the identifier for a Box data object and a product type as arguments and, when executed by the server, adds a product of the specified product type to the box identified by the Box data-object identifier and returns a Product data object representing the product added to the box. A single subscription getBoxUpdates receives a list of Box data-object identifiers, as an argument, and returns a list of Box data objects in each response returned through the communications channel opened between the client and server for transmission of the requested information, over time, to the client. In this case, the client receives Box data objects corresponding to any of the boxes specified in the argument to the subscription getBoxUpdates when those Box data objects are updated, such as in response to addProduct mutations submitted to the server.

Finally, the example schema specifies two fragments: (1) boxFields 1342; and (2) productFields 1344. A fragment specifies one or more fields of an object datatype. Fragments can be used to simplify query construction by expanding a fragment, using the operator “ . . . ” in a selection set of a query, mutation, or subscription, as discussed below, rather than listing each field in the fragments separately in the selection set. A slightly different use of fragments is illustrated in example queries, below. In the current case, the fragment boxFields includes only the single field name of the Box data-object type and the fragment productFields includes only the single field name pType of the Product datatype.

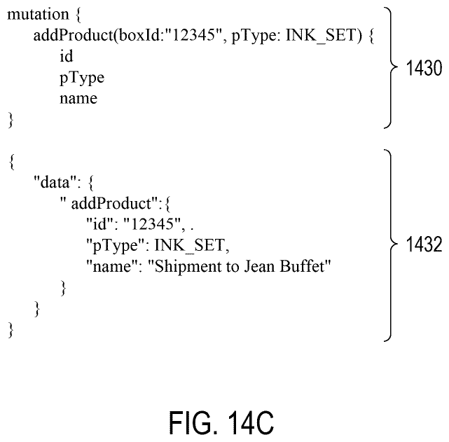

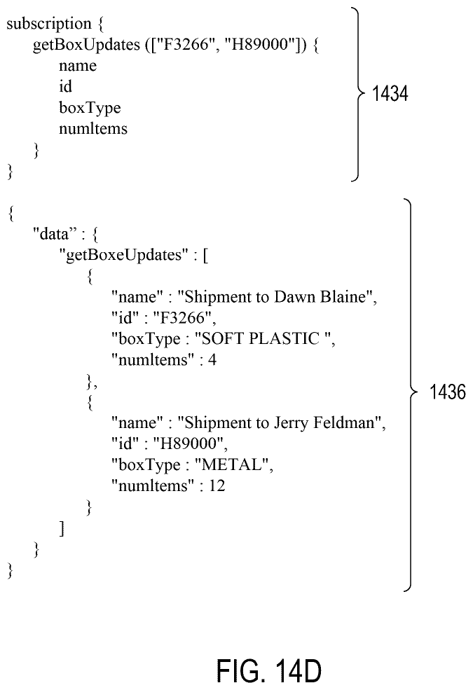

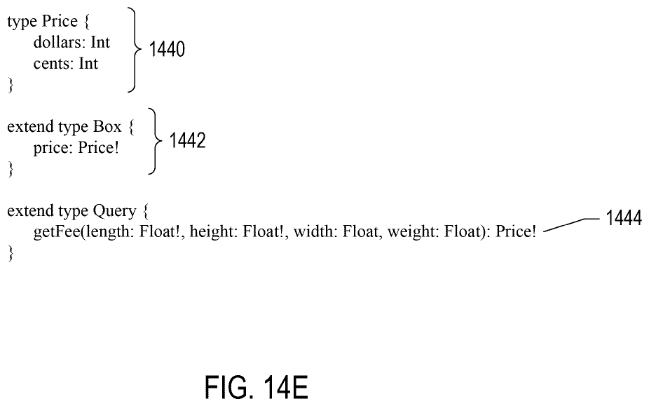

FIGS. 14A-D illustrates two example queries, an example mutation, and an example subscription based on the example schema discussed with reference to FIGS. 13A-B. FIG. 14A shows an example query 1402 submitted by a client to a server and the JavaScript Object Notation (“JSON”) data object returned by the server to the client. Various different types of data representations and formats can be returned by servers implementing GraphQL interfaces, but JSON is a commonly used data representation and formatting convention. The query 1402 is of the query type 1334 specified in FIG. 13B. The argument specified for the query is “A31002,” the String serialization of a Box identifier. A selection set 1404 for the query specifies that the client issuing the query wishes to receive only values for the id, name, weight, and boxType fields of the Box data object with identifier “A31002.” The JSON response to the query 1406 contains the requested information. This points to one of the large advantages provided by the GraphQL query language. A client can specify exactly the information the client wishes to receive from the server, rather than receiving predefined information for predefined queries provided by a REST interface. In this case, the client is not interested in receiving values for many of the fields in the Box data object and is able to use a selection set in the query to request only those fields that the client is interested in receiving.

FIG. 14B illustrates a second example query based on the example schema discussed with reference to FIGS. 13A-B. The second example query 1408 is of the query type 1335 specified in FIG. 13B. A selection set 1410 within the query requests that, for each Box data object currently maintained by the server, values for the id, name, and contents fields of the Box data object should be returned. The contents field has a list type and specifies a list of Item data objects, where an Item may be either a Box data object or a Product data object. A selection set 1412 for the contents field uses expansion of the boxFields and productFields fragments to specify that, for each Item in the list of Item data objects represented by the contents field, if the Item is a Box data object, then the value of the name field for that Box data object should be returned while, if the Item is a Product data object, then the value of the pType field of the Product data object should be returned. The JSON response 1414 to query 1408 is shown in the lower portion of FIG. 14B. The returned data is a list of the requested fields of the Box data object currently maintained by the server. That list begins with bracket 1415 and ends with bracket 1416. Ellipsis 1417 indicates that there may be additional information in the response for additional Box data objects. The requested data for the first Box data object occurs between curly brackets 1418 and 1419. The list of items for the contents of this Box data object begin with bracket 1420 and end with bracket 1422. The first Item 1424 in the list is a Box data object and the second two Item data objects 1425 and 1426 are Product data objects. The second example query illustrates that a client can receive a large amount of arbitrarily related information in one request-response interaction with a server, rather than needing to use multiple request-response interactions. In this case, a list of portions of multiple Box data objects can be obtained in one request-response interaction. As another example, in a typical REST interface, a client may need to submit a request to separately retrieve information for each Box data object contained within an outer-level Box data object, but, using a hierarchical object datatype, that information can be requested in a single GraphQL query.

FIG. 14C illustrates an example mutation based on the example schema discussed with reference to FIGS. 13A-B. The example mutation 1430 is of the mutation type 1338 specified in FIG. 13B. The mutation requests that the server add a product of type INK_SET to the Box data object identified by Box data-object identifier “12345” and return values for the id, pType, and name fields of the updated Box data object. The JSON response 1432 to query 1430 is shown in the lower portion of FIG. 14C. FIG. 14D illustrates an example subscription based on the example schema discussed with reference to FIGS. 13A-B. The example subscription 1434 is of the subscription type 1340 specified in FIG. 13B. The subscription requests that the server return, for updated Box data objects identified by Box data-object identifiers “F3266” and “H89000,” current values for the name, id, boxType, and numItems fields. One of the JSON responses 1436 to subscription 1434 returned at one point in time is shown in the lower portion of FIG. 14D.

FIG. 14E illustrates a second schema, based on the first example schema of FIGS. 13A-B and generated by extending the first example schema. The second schema may be used as an interface to a different service that returns shipment fees associated with Box data objects that represent shipments. The schema extension includes specification of a new Price data object 1440, extension of the object datatype Box to include an additional field price with a Price data-object value 1442, and extending the root Query operation type to include a getFee query 1444 that receives the length, height, width, and weight of a shipment and returns the corresponding shipment price or cost. Thus, GraphQL provides for extension of schemas to generate new extended schemas to serve as interfaces for new services, distributed applications, and other such entities.

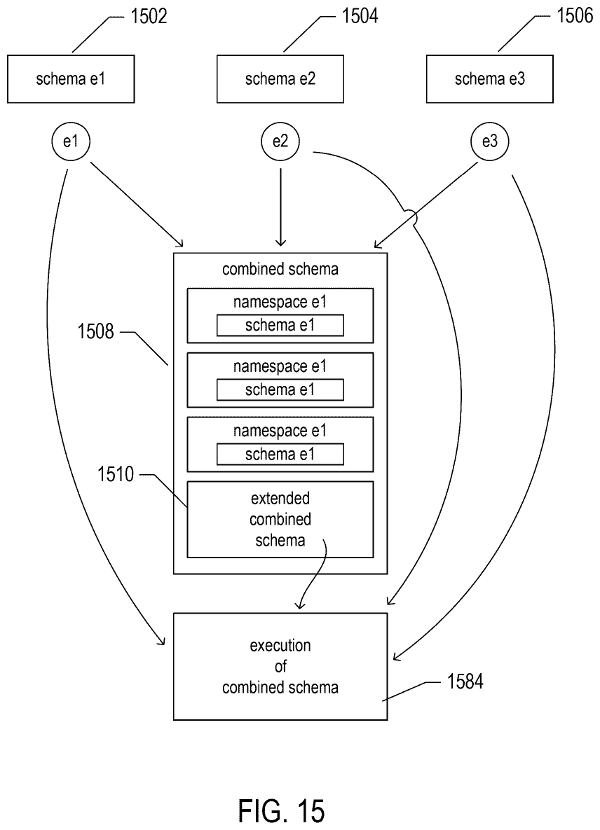

FIG. 15 illustrates a stitching process. Schema stitching is not formally defined by the GraphQL query-language specification. The GraphQL query-language specification specifies that a GraphQL interface is represented by a single schema. However, in many cases, it may be desirable to combine two or more schemas in order to produce a combined schema that is a superset of the two or more constituent schemas, allowing queries, mutations, and subscriptions based on the combined schema to employ object datatypes and other defined types and directives specified in two or more of the constituent schemas. There are multiple different types of implementations of schema stitching. In an example shown in FIG. 15, there are three underlying schemas 1502-1504. The stitching process combines these three schemas into a combined schema 1508. The combined schema includes the underlying schemas. In the illustrated approach to stitching, each underlying schema is embedded in a different namespace in the combined schema, which may include additional extensions 1510. The namespaces are employed in order to differentiate between identical identifiers used in two or more of the underlying schemas. Other approaches to stitching may simply add extensions to all or a portion of the type names defined in all of the underlying schemas in order to generate unique names across all of the underlying schemas. In the combined schema, queries, mutations, and subscriptions may use types from all of the underlying schemas and, in combined-schema extensions of underlying-schema types, a type defined in one underlying schema can be extended to reference a type defined in a different underlying schema. When a query, mutation, or subscription defined in the combined schema is executed, the execution 1514 may involve execution of multiple queries by multiple different services associated with the underlying schemas.

### YAML/JINJA and SLS Data

FIGS. 16A-D illustrate the YAML Ain′t Markup Language (“YAML”) data serialization language. YAML provides for representing data in text files. Certain features of YAML are illustrated by the YAML document shown in FIGS. 16A-D. A YAML document begins with three hyphens (1602 in FIG. 16A) and ends with three periods (1603 in FIG. 16D.) Multiple YAML documents can be included in a single text file. Comments begin with a “#” symbol followed by a space, such as the comment 1604. One of the fundamental constructs in YAML is a mapping of a scalar value to a scalar string, or name, such as the mapping 1605 of the integer value 35 to the name “x” and the mapping 1606 of the string value “Bill Johnson” to the name “Chairman.” YAML supports a variety of different types of scalars, as shown in the set of mappings 1607, including: integers encoded as decimal integers 1608, integers encoded as hexadecimal integers 1609, and integers encoded as octal integers 1610; floating-point numbers 1611; Boolean values “Yes” 1612 and “No” 1613, “true” 1614 and “false” 1615, and “On” and “Off” 1616; a value representing infinity 1617; and a value representing “not a number” 1618. On lines 1619, two text lines are mapped to the name “text_stuff,” with the symbol “|” used to indicate that newline characters in the text should be preserved. On lines 1620, two text lines are mapped to the name “f_text_stuff,” with the symbol “>” indicating that newlines should be removed in order to fold the text into a single text block. Text can be unquoted or quoted, as indicated by the examples on lines 1621. The “!!” operator can be used to explicitly assign types to values, as indicated on lines 1622.

Turning to FIG. 16B, another fundamental data structure supported by YAML is the sequence or list. Several different representations of lists are supported. In a first representation of a list 1623, the elements of the list are indicated by a preceding “-” and a space. In a second representation 1624, the elements of the list are contained within brackets and separated by commas and spaces. As indicated on lines 1625, a list can be mapped to a name. In the example of lines 1625, a list of animals is mapped to the character string, or name, “animals.” Note that indentation is used, as in the Python programming language, to indicate hierarchical structure.

Lines 1626 show a mapping of a more complex type of list to the name, or character string, “members.” In this example, the list is a list of blocks 1627-1629. Each block is preceded by a hyphen and a space. Each block contains a mapping of a character string to the character string “name” 1630, a mapping of two text lines to the character string “address” 1631, a mapping of an integer to the character string “age” 1632, and a mapping of an alphanumerically encoded phone number to the character string “phone” 1633. In the example of lines 1634 at the bottom of FIG. 16B and lines 1635 at the top of FIG. 16C, the mapping of the list of blocks to the character string “members” on lines 1626 of FIG. 16B is modified to include two additional lines in each block of the list. The two additional lines are specified using the anchor symbol “&” on lines 1636 at the bottom of FIG. 16B. The lines are included at the end of each block in the list using the reference prefix “<<: *” at the beginning of each of three lines referencing the anchor “chapter” 1637-1639. The modified list is equivalent to the list shown on lines 1640 of FIG. 16C. Finally, on line 1641 at the top of FIG. 16D, a more complex mapping that maps the list “[0, 1, 2]” to the list “[small, medium, large]” is shown. This mapping can alternatively be represented by the map sequence, or dictionary, shown on line 1642. The example YAML document shown in FIG. 16A-D does not, of course, provide a comprehensive description of the YAML data-representation language, but is instead intended to show some of the main features and constructs of YAML that are used in SLS documents, discussed below.

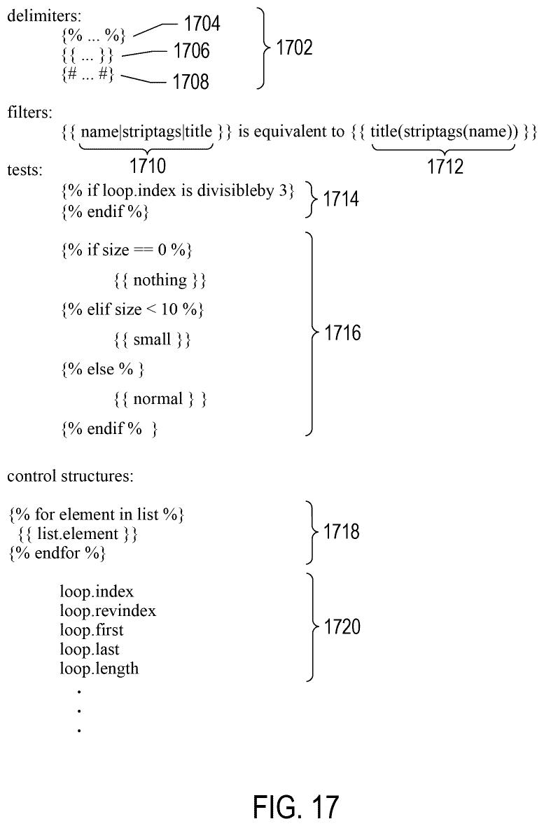

FIG. 17 illustrates certain features provided by the Jinja template engine that are used, in addition to YAML, for representing infrastructure in SLS documents. Jinja employs several types of delimiters to encode Jinja constructs. These are shown on lines 1702 of FIG. 17, with ellipses indicating that additional text is enclosed by the delimiters. A first type of delimiter 1704 is used to encapsulate tests, control structures, and other programming-language-like constructs. A second type of delimiter 1706 is used to encapsulate variables for output. A third type of delimiter 1708 is used to enclose comments. Pipe symbols “|” can be used to indicate sequences of function calls. For example, the delimited string “name|striptags|title” 1710 is equivalent to the character string 1712, which represents calling a function “title” with an argument that represents a value returned by calling the function “striptags” with the argument “name.” Jinja supports if statements, as shown by the example on lines 1714, and if-elseif-else statements, as shown by the example on lines 1716. Jinja provides a set of comparison operators used in if and if-elseif-else statements. Finally, Jinja provides various types of control structures, such as for-loops, as indicated on lines 1718. The for-loop control structure is accompanied with a number of Jinja loop variables 1720 that can be used in conditional expressions within loops. FIG. 17 does not provide a comprehensive list of examples of Jinja features and constructs, but is instead intended simply to show some of the main types of Jinja constructs that, in combination with YAML constructs and features, are used in SLS documents, described below.

The currently disclosed cloud-infrastructure-management service is referred to as the “Idem service” in the remainder of this document, for reasons discussed in a following section. The Idem service, as discussed above, receives SLS data files that describe deployment and configuration of cloud-based infrastructure. SLS data files can be represented in various different data-serialization languages, including JSON, but a combination of YAML-like and Jinja-like formatting conventions, features, and constructs are most frequently used. An Idem state file is an SLS data file that represents configuration of a cloud-based infrastructure, and Idem SLS data files serve as blueprints or cloud templates input to the Submitted Task and Validate SLS APIs of the Idem-service management interface. There are, however, many different types of Idem implementations. Idem may be considered to be a data flow programming language, for example, and an Idem system may be implemented as a collection of plug-ins that together comprise a cloud-infrastructure-management engine and a command-line interface (“CLI”). In the current document, the Idem service introduced, above with reference to FIGS. 9-11, is used as an example cloud-infrastructure-management system in which the currently disclosed automated methods for generating parameterized cloud-infrastructure templates can be incorporated, but the currently disclosed automated methods can alternatively be incorporated in other types of cloud-infrastructure-management-system implementations.

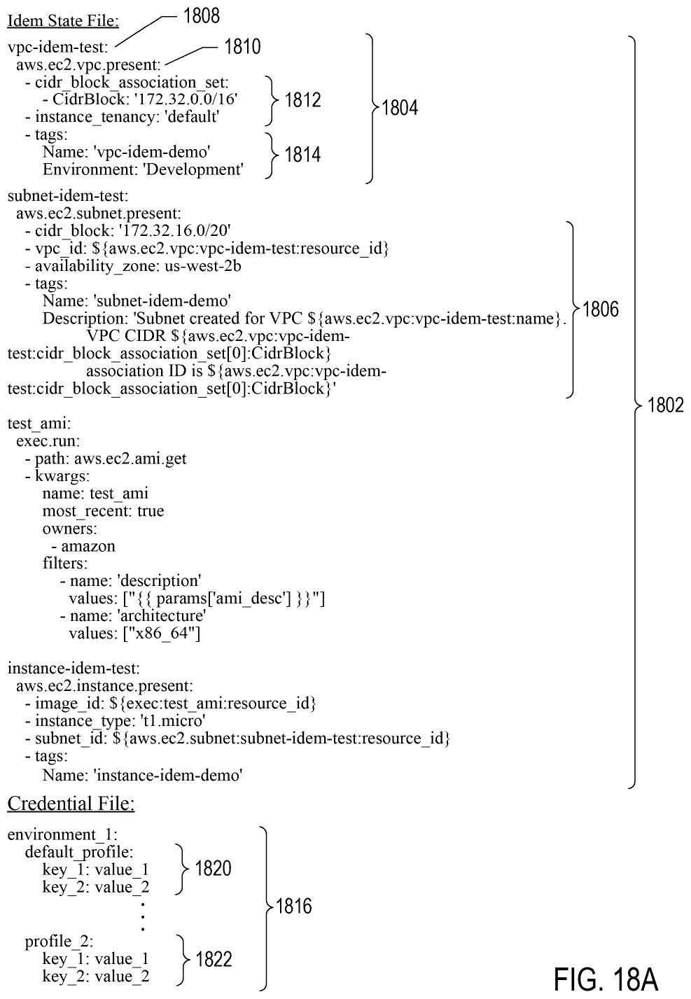

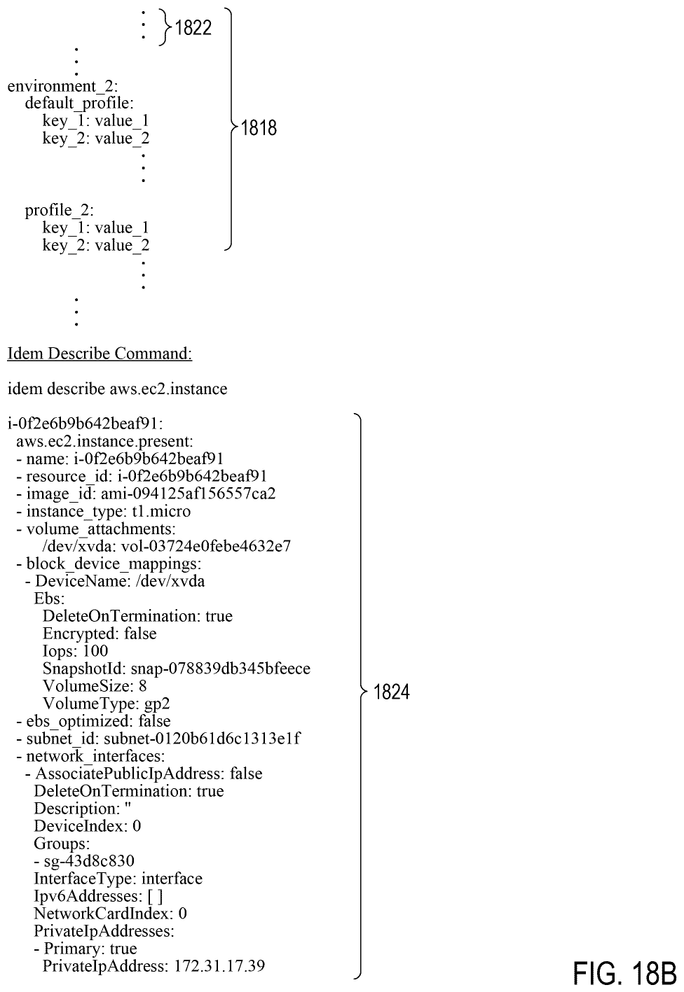

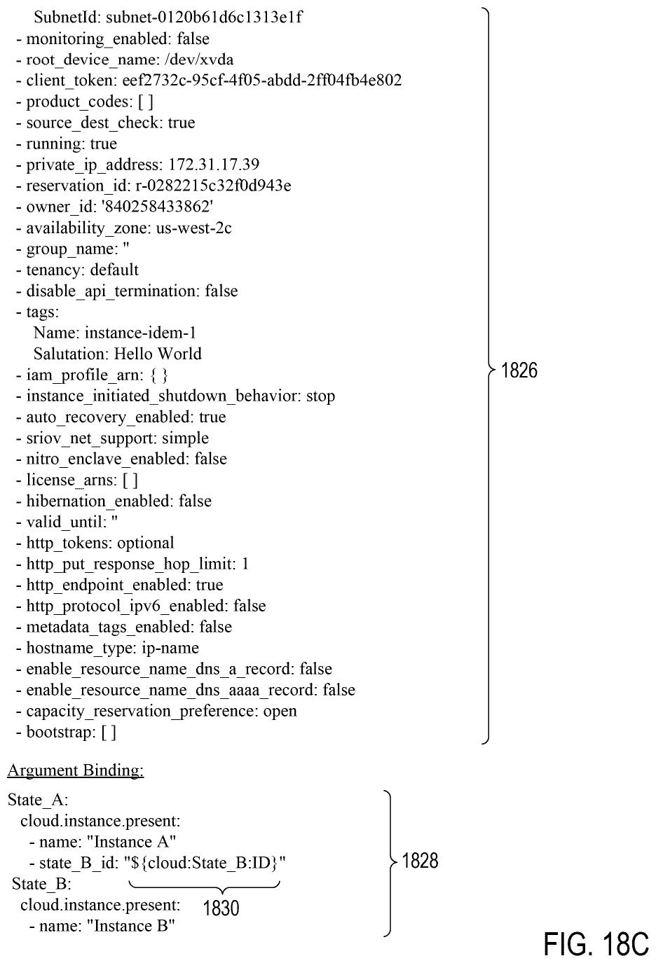

FIGS. 18A-C illustrate a structured layered state (“SLS”) data file and an SLS credential file as well as the output from an Idem describe command. A simple, example Idem state file is shown in the initial portion 1802 of FIG. 18A. The example SLS state file creates a virtual private cloud (“VPC”) for a virtual machine within an AWS cloud-computing facility and connects the VPC to an AWS subnet. A first portion of the example SLS state file 1804 specifies the VPC and a second portion of the example SLS state file 1806 specifies the subnet. Each resource includes a state name, such as “vpc-item-test” 1808 for the VPC, and a directive, or function, such as “aws.ec2.vpc.present” 1810. Directives include: (1) present, which indicates that, when the resource is not currently present in the infrastructure, the resource should be allocated, deployed, and configured according to the resource specification and that, when the resource is currently present in the infrastructure, the Idem service resource should ensure that the current deployment and configuration of the resource corresponds to the resource specification; (2) absent, which indicates that, when the resource is currently allocated and deployed, the resource should be removed; and (3) describe, which requests that the Idem service return information about the resource. Resources are specified using a plug-in/resource-group/resource-type tuple, such as “aws.ec2.vpc” in directive 1810. The plug-in portion of the plug-in/resource-group/resource-type tuple refers to a plug-in associated with a particular cloud-computing facility or cloud provider which provides the executables for accessing the particular cloud-computing facility and/or a set of cloud-computing facilities managed by the cloud provider. A resource specification includes a list of attribute/value pairs, generally including property/value pairs 1812 tag/value pairs 1814. Of course, real-world Idem state files may contain descriptions of hundreds or thousands of resources and, in addition, a blueprint or cloud templates may include multiple hierarchically organized SLS state files. The resource-group portion of the plug-in/resource-group/resource-type tuple refers to a group or class containing multiple types of resources and the resource-type portion of the plug-in/resource-group/resource-type tuple refers to a particular type of resource, such as a virtual machine or a subnet, which is a partition of the host-address space of a virtual-private-network-address space.

The form of an SLS credential file is shown in a lower portion 1816 of FIG. 18A and an upper portion 1818 of FIG. 18B. The SLS credential file contains a block of authentication/authorization information for one or more environments, each of which corresponds to plug-ins for different types of cloud-computing-facility management interfaces. The first portion 1816 of the example SLS credential file shown in FIG. 18A contains a block of authentication/authorization information for a first environment. Each block contains authentication/authorization information for one or more profiles, such as profiles 1820 and 1822 in the block for the first environment, including a default profile 1820. The authentication/authorization information is encoded as a set of attribute/value pairs, such as the name of a particular type of authentication/authorization information, such as an access key, and the alphanumerically encoded access key. SLS credential files are used to input authentication/authorization information to the Idem-service management interface so that the authentication/authorization information can be maintained by the Idem-service management interface and used by the Idem service to access functionality provided by the management interfaces of cloud-computing facilities via the various plug-ins.

The lower portion 1824 of FIG. 18B and the upper portion 1826 of FIG. 18C show the output of an Idem-service describe command executed with respect to the infrastructure described in the Idem state file 1802 shown in FIG. 18A. The output of the Idem-service describe command has a YAML-like format and can be used to generate a corresponding Idem state file that can be subsequently used to modify and enforce the configuration of the represented infrastructure, as discussed below. A final portion 1828 of FIG. 18C illustrates argument binding in SLS data files. The character string “$ {cloud: State_B: ID}” represents a reference to an attribute value of an attribute in an SLS data file generated by prior execution of a portion of an SLS data file. In the example shown in the final portion of FIG. 18C, the string “$ {cloud: State_B: ID}” references the name of the resource State_B once that name is obtained via an Idem-service state command. Moreover, execution of the Idem-service state command orders execution of operations related to specified resources to ensure that argument bindings refer to valid attribute values.

### The Idem Service

As discussed above, the current application discloses a cloud-infrastructure-management service referred to as the “Idem service.” This name is derived from the term “idempotent.” An idempotent operation is an operation that can be first applied to an object or entity and, when the object or entity is not subsequently altered by other operations, can be again applied to the object or entity without changing the object or entity. One example of an idempotent operation is the computational operation x=x mod 5, where the initial value of x is 16. The first application of the operation x=x mod 5 sets the value of x to 1. Provided that the value of x is not altered by some other operation, a second application of the operation x=x mod 5 results in the value of x remaining 1, and this is true for any number of repeated applications of the operation x=x mod 5 provided that the value of x is not altered by application of some other operation.

FIG. 19 illustrates a fundamental control loop involving the Idem service. This control loop involves the Idem-service state command, mentioned above, which applies an SLS-data blueprint or cloud template to a cloud-computing facility. In the case that no infrastructure has yet been deployed and configured within the cloud-computing facility on behalf of the individual or organization submitting the Idem-service state command to the management interface of the Idem service, the Idem service creates, deploys, and configures infrastructure on the cloud-computing facility according to the SLS-data blueprint or cloud template. When the resulting infrastructure is not subsequently altered by other commands or events, then, when the individual or organization again submits the same SLS-data blueprint or cloud template in a subsequent Idem-service state command to the management interface of the Idem service, the infrastructure is not changed by the subsequent Idem-service state command. However, in the case that the infrastructure has been altered by various events following the initial creation, deployment, and configuration of the infrastructure, submission of the same SLS-data blueprint or cloud template in a subsequent Idem-service state command to the management interface of the Idem service returns the infrastructure to the state that the infrastructure had upon initial creation, deployment, and configuration. Thus, the Idem-service state command associated with a particular SLS-data blueprint or cloud template is idempotent, and resubmission of an Idem-service state command associated with a particular SLS-data blueprint or cloud template can be used to control unintended departures of the state of cloud-based infrastructure, referred to as “enforcement,” without the risk of causing unintended changes to the state of the infrastructure defined by the SLS-data blueprint or cloud template.

The idempotency of the Idem-service state command is reflected in the fundamental control loop 1902 illustrated in FIG. 19. There are two possible starting points 1904 and 1906 for the control loop 1902. Assuming that the loop begins at the starting point 1904, the loop begins with an SLS-data blueprint or cloud template 1908 that describes desired infrastructure to be created, deployed, and configured within a cloud-computing facility. The SLS-data blueprint or cloud template is referenced by an Idem-service state command 1910 which is submitted to the Idem service for execution 1912. Execution of the Idem-service state command 1910 produces deployed and configured infrastructure 1914 with a state corresponding to a desired state represented by the SLS-data blueprint or cloud template. Subsequent submission of an Idem-service describe command 1916 result in execution of the describe command by the Idem service 1918 which, in turn, produces Idem-service-describe-command output 1920 that represents the current state of the infrastructure. At this point, if the output from the Idem describe command does not reflect the desired state of the infrastructure, the original SLS data can be referenced by a resubmitted Idem-service state command to enforce the originally desired infrastructure state. This enforcement operation is used to correct infrastructure drift, where “infrastructure drift” means an unintended departure of the state of the infrastructure from the desired state due to intervening events or operations. By contrast, if the loop started at starting point 1906, then the output from the Idem-service describe command can be translated into SLS data that can be subsequently used to enforce the infrastructure state represented by the SLS data. Yet another possibility is that the infrastructure state represented by the describe-command output may be used to generate corresponding SLS data which can then be modified in order to generate a new infrastructure state. Thus, the fundamental control loop may continue to iterate in order to maintain the state of the infrastructure in a desired state, with modifications to the SLS-data blueprint or cloud template made to alter the infrastructure state in response to changing goals or conditions.

FIG. 20 illustrates one implementation of the Idem service. The Idem service 2002 includes an Idem-service frontend 2004, a task manager 2006, multiple Idem-service workers 2008, with the number of Idem-service workers scalable to handle dynamic workloads, an event stream 2010, and an event-processing component 2012. The Idem-service frontend 2004 includes the previously discussed set of GraphQL APIs 2014 and a database 2016 for storing information related to managed infrastructure and received Idem requests and commands. The frontend additionally includes Idem-service logic 2018 that implements command/request execution, throttling and prioritization, scheduling, enforced-state management, event ingestion, and internal communications between the various components of the Idem service. Throttling involves managing the workload accepted by the Idem service to ensure that sufficient computational resources are available to execute received commands and requests. Prioritization involves prioritizing execution of received Idem commands and requests. Scheduling involves preemption of long-running Idem-command-and-request executions. Enforced state management involves maintaining a representation of the last enforced state of a particular infrastructure managed by the Idem service in order to facilitate subsequent command/request execution. Event ingestion involves receiving, storing, and acting on events input to the Idem-service frontend by the event-processing component 2012. The various components of the Idem service communicate by message passing, as indicated by double-headed arrows 2020-2022. The task manager 2006 coordinates various stages of execution of Idem commands and requests using numerous task queues 2024-2026. Each Idem-service worker, such as Idem-service worker 2028, presents an Idem-service worker API 2030 and includes logic 2032 that implements Idem-command-and-request execution. Each Idem-service worker includes a set of one or more plug-ins, such as plug-in 2034, allowing the Idem-service worker to access the management interfaces of cloud-computing facilities on which infrastructure managed by the Idem service is deployed and configured. As they execute commands and requests, Idem-service workers publish events to the event stream 2010. These events are monitored and processed by the event-processing component 2012, which filters the events and forwards processed events to the Idem-service frontend.

### Currently Disclosed Methods and Systems

FIG. 21 provides an abstract illustration of SLS data files. The contents of one or more SLS data files are abstractly represented by the column of resource descriptors 2102. This may represent a collection of one or more SLS data files or may alternatively represent an in-memory data structure into which the contents of one or more SLS data files have been stored for processing. In order to avoid repeating the language “one or more SLS data files,” the following discussion used the phrase “SLS data file” to mean “one or more SLS data files.” It is, of course, straightforward to combine multiple SLS data files into a single aggregate SLS data file. Furthermore, as mentioned above, an SLS data file is but an example of a cloud-infrastructure-specification-and-configuration file.

The initial portion 2104 of the SLS data file or in-memory representation of the contents of the SLS data file represents a header containing metadata descriptive of the SLS data file. The main portion 2106 of the SLS data file or in-memory representation of the contents of SLS data file contains a series of resource descriptors, such as resource descriptor 2108, that each represents a different state/resource specified in the SLS data file. Inset 2110 illustrates the contents of a resource descriptor. The resource descriptor includes, in an initial portion 2112, a user-friendly representation of a resource identifier that identifies the resource 2114 and a cloud-provider/service/resource-type tuple 2116, which is an alternative description of the above-discussed plug-in/resource-group/resource-type tuple. Following the initial portion 2112, the resource descriptor contains a series of key/value pairs that constitute specification and configure information for the resource. These include a key/value pair with a key “name” 2118, a key/value pair with a key “resource_id” 2120, a key/value pair 2122 with a key “tags” and a value comprising multiple key/value pairs, and a key/value pair 2124 with a key “configurations” and a value comprising multiple key/value pairs. Of course, different types of resources may be represented, in the SLS data file, with different key/value pairs that include different types of values, including string values, numeric values, list of values, and data-structure values.

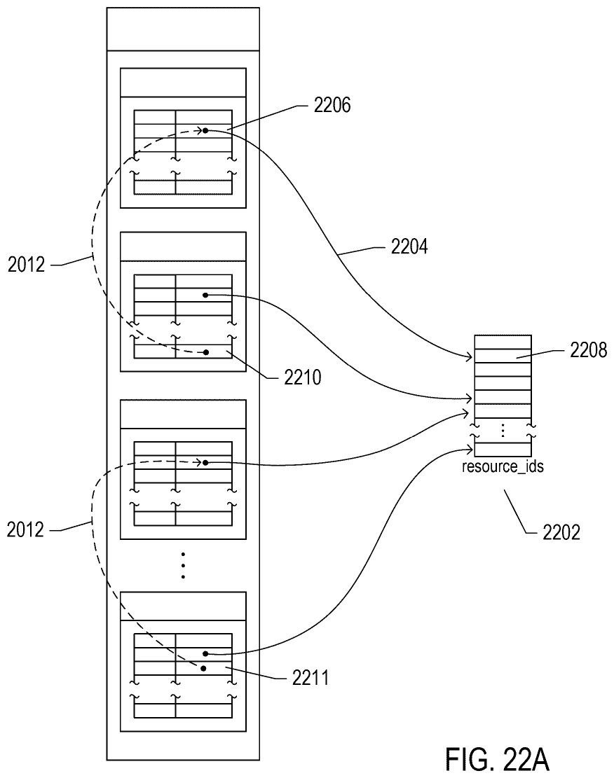

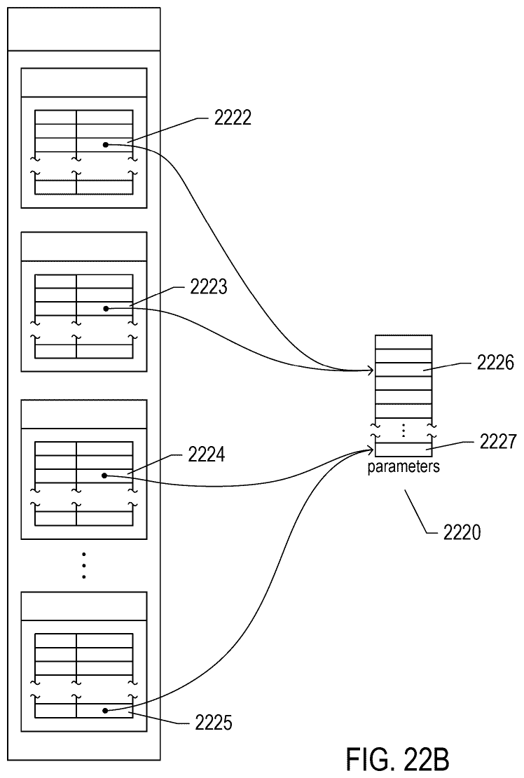

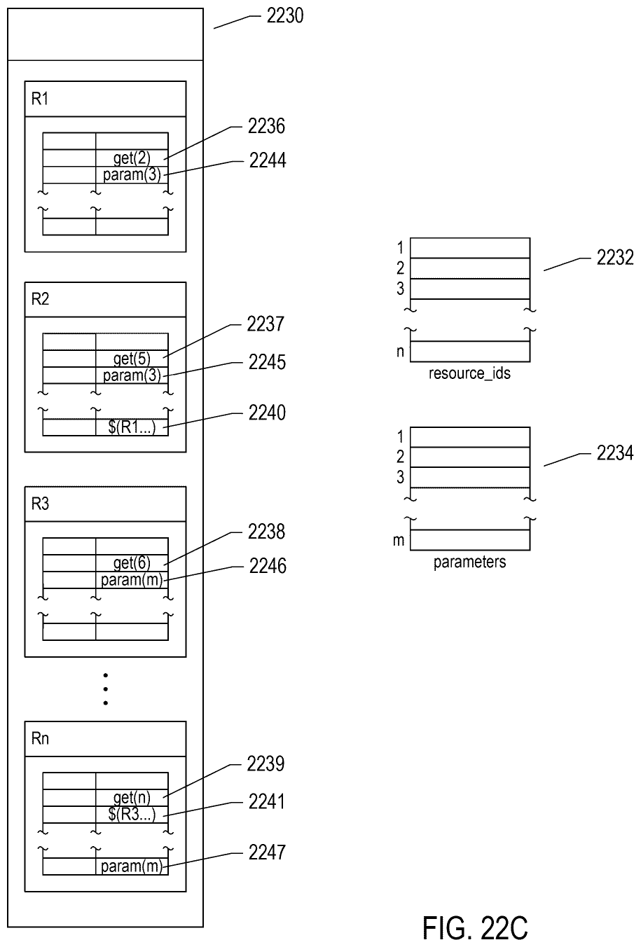

FIGS. 22A-C illustrate aspects of the process of transforming an SLS data file that specifies cloud infrastructure into a parameterized cloud-infrastructure template. Each resource, or state, represented by a resource descriptor is, as mentioned above, associated with a resource identifier. In general, resource identifiers are lengthy alphanumeric symbol strings generated by cloud providers and underlying cloud-management and distributed-computer-system-management systems. These alphanumeric symbol strings are difficult for human users to remember and process. Therefore, in initial steps of processing an SLS data file, the Idem service generally replaces the alphanumeric-symbol-string resource identifiers with user-friendly unique identifiers for each resource, as will be shown below in a particular example of an SLS data file used to describe the variable-parameterization process to which the current application is directed.

FIG. 22A illustrates the parameterization of resource identifiers. A resource-identifier file 2202 logically comprises a map of user-friendly resource-identifiers to cloud-provider-generated alphanumeric-symbol-string resource identifiers. The user-friendly resource identifiers contained in value fields of key/value pairs within the SLS data file are replaced with function calls to a get function that automatically substitutes the cloud-provider-generated alphanumeric-symbol-string resource identifiers for the get function calls in the SLS data file, as represented by solid arrows, such as solid arrow 2204 in FIG. 22A, which each connects a value field 2206 of a key/value pair in a resource descriptor to the corresponding cloud-provider-generated alphanumeric-symbol-string resource identifier 2208 in the resource-identifier file. When the SLS data file is processed and used by the Idem service for cloud-infrastructure management, the get function calls are automatically replaced by cloud-provider-generated alphanumeric-symbol-string resource identifiers. In addition, other value fields of key/value pairs, such as fields 2210-2211, may contain user-friendly resource identifiers identical to user-friendly resource identifiers in the value fields of key/value pairs with key “resource_id” in resource descriptors, as represented by dashed arrows 2012-2013 in FIG. 22A. These user-friendly resource identifiers in the other value fields act as internal pointers or references to the resource identifiers in resource_id key/value pairs. Parameterization of resource identifiers further includes replacing these internal-reference user-friendly resource identifiers with argument bindings, discussed above with reference to FIG. 18B.

Another significant step in parameterization of an SLS data file is to identify certain value fields of key/value pairs as candidates for parameterization as variables. In this sense, variables in an SLS data file are similar to variables in programs and routines. Multiple value fields of key/value pairs may contain the same string, numeric, or list value. For example, multiple resources within specified cloud infrastructure may all have certain identical configuration parameters represented by the same value in the value fields of a common key/value pair in the resource descriptors for the multiple resources. For a human user, it may be difficult or impossible to identify such repeated occurrences of a particular value within multiple value fields of an SLS data file, as a result of which a user attempting to reuse an SLS data file for specifying and configuring new cloud infrastructure may be faced with an almost impossible task of consistently changing the contents of a large number of value fields to alter the specification for the new cloud infrastructure. By recognizing variables within an SLS data file and replacing the values of the variables with references to the variable values stored in the parameters file 2220, using an SLS-data-file cloud-infrastructure specification to specify and configure new cloud infrastructure becomes much easier, requiring only updating the value stored in the parameters file rather than repeatedly searching through the SLS data file for recurring values for a number of different key/value pairs. Thus, as shown in FIG. 22B, replacing recurring values, such as values 2222-2223 and 2224-2225 in an SLS data file with references to stored values in the parameters file, 2226 and 2227, or, in other words, replacing the values of variables in an SLS file with references to values stored in the parameters file, represents another significant step in generating a parameterized cloud-infrastructure template from SLS data file.

FIG. 22C illustrates a parameterized cloud-infrastructure template corresponding to an SLS data file. The original SLS data file (2102 in FIG. 21) is replaced by a parameterized cloud-infrastructure template comprising a modified SLS data file 2230, a resource identifiers file 2232, and a parameters file 2234. In the implementation discussed below, the resource identifiers file and parameters file are combined into a single parameters file. Note that resource identifiers have been replaced by get function calls 2236-2239, internal resource-identifier references have been replaced by argument bindings 2240-2241, and variable values have been replaced by references to parameter values stored in the parameters file 2244-2247.

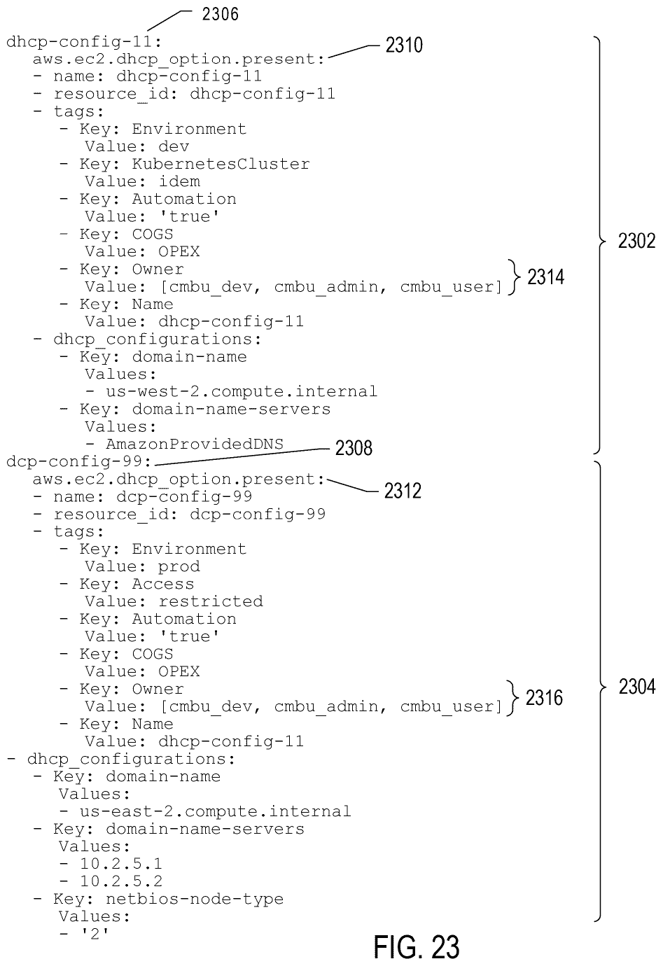

FIG. 23 shows an example SLS data file that is used in the following discussion of the currently disclosed methods for identifying and parameterizing variables. The example SLS data file includes two resource descriptors 2302 and 2304. The first resource is identified by the user-friendly resource identifier “dcp-config-11” 2306 and the second resource is identified by the user-friendly resource identifier “dcp-config-99” 2308. Both resource descriptors include a cloud-provider/service/resource-type tuple combined with the state function present 2310 and 2312. The format of the two resource descriptors 2302 and 2304 is consistent with the format discussed above with reference to FIG. 21.

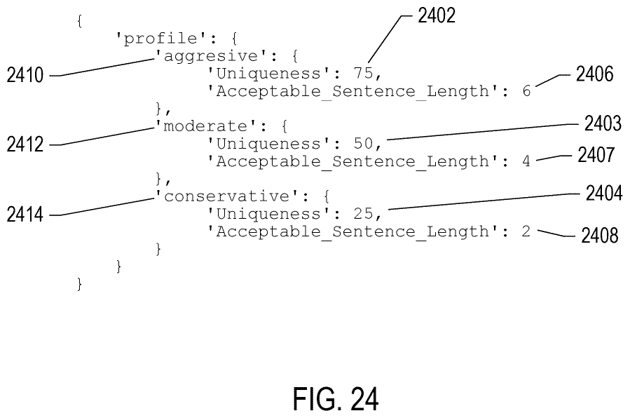

FIG. 24 shows a JSON-like encoding of parameterization parameters that specify certain parameterization-parameter values used in identifying and parameterizing variables within the example SLS data file shown in FIG. 23. A uniqueness parameter value 2302-2304 and an acceptable-sentence-length parameter value 2406-2408 is shown for each of three different levels “aggressive” 2410, “moderate” 2412, and “conservative” 2414. The uniqueness and acceptable-sentence-length parameters are discussed further, below.

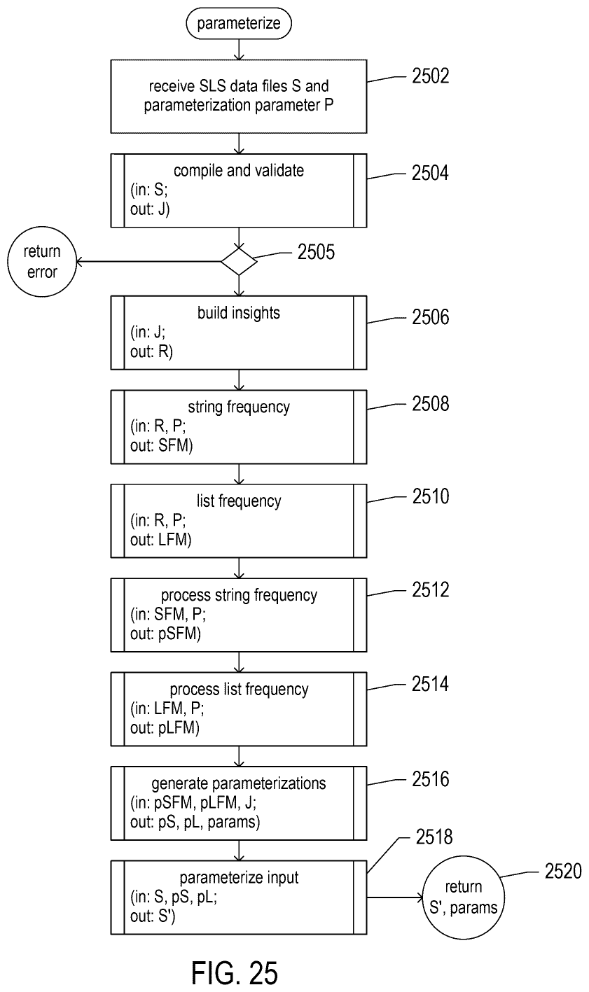

FIG. 25 provides a control-flow diagram of the routine “parameterized” that represents the overall, currently disclosed process of identifying and parameterizing variables in an SLS data file. In step 2502, the routine “parameterized” receives an SLS data file S and parameterization parameters in a JSON-like parameterization file P, such as those shown in FIG. 24. In step 2504, a routine “compile and validate” is called to compile the SLS data file S into a JSON-like representation J. In step 2506, a routine “build insights” processes the JSON-like representation J to produce a build-insights response file R that contains a large amount of information gleaned from the JSON-like representation J. If an error occurs, as represented by step 2505, the routine “parameterized” returns an error result. Otherwise, in step 2508, a routine “string frequency” is called to generate a string-frequency map SFM from the JSON-like representation J and the build-insights response file R. In step 2510, a routine “list frequency” is called to generate a list-frequency map LFM from the JSON-like representation J and the build-insights response file R. In step 2512, a routine “process string frequency” is called to generate a processed string-frequency map pSFM from the string-frequency map SFM. In step 2514, a routine “process list frequency” is called to generate a processed list-frequency map pLFM from the string-frequency map SFM. In step 2516, a routine “generate parameterizations” is called to generate string and list parameterization files pS and pL along with a parameters file params. Finally, in step 2518, a routine “parameterized input” is called to generate a parameterized version S′ of the input SLS data file S. The parameterized version S′ of the input SLS data file S and the parameters file params are returned as the parameterized cloud-infrastructure template in step 2520. All of the routines called in FIG. 25 are discussed in detail, below.

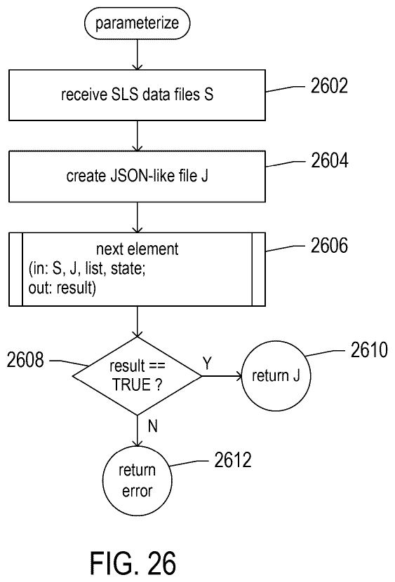

FIG. 26 provides a control-flow diagram for the routine “compile and validate,” called in step 2504 of FIG. 25. In step 2602, the routine “compile and validate” receives an SLS data file S. In step 2604, the routine “compile and validate” creates a new file J. In step 2606, the routine “compile and validate” calls a recursive routine “next element” to recursively process the SLS data file S. When the routine “next element” returns the result TRUE, as determined in step 2608, the routine “compute and validate” returns the file J as a JSON-like representation of the set of SLS data file S, in step 2610. Otherwise, an error is returned, in step 2612.

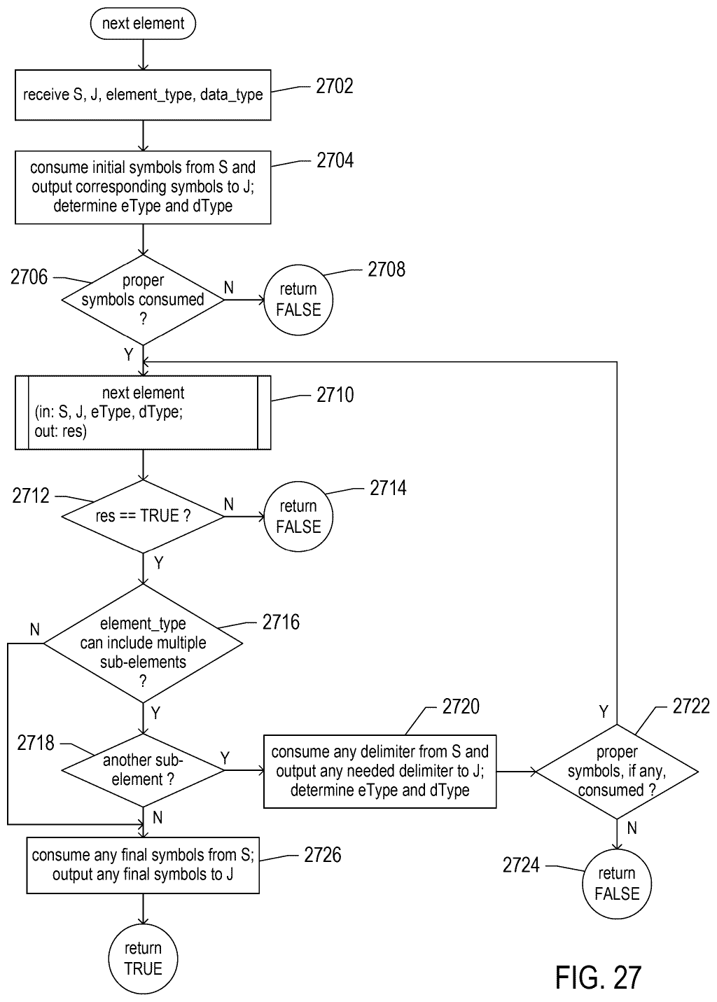

FIG. 27 provides a control-flow diagram for the routine “next element,” called in step 2606 of FIG. 26. In step 2702, the routine “next element” receives the SLS data file S, the file J that will contain a JSON-like representation of the SLS data file, an indication of a next expected element type, and an indication of the datatype of the next expected element. For example, in the call to the routine “next element” in step 2606 of FIG. 26, the next expected element type is a list and the expected data type for elements of the list is a resource descriptor or state. The arguments S and J are received by reference, so that advancement of associated file pointers are preserved across routine calls. In step 2704, the routine “next element” consumes any expected initial symbols from S and outputs corresponding symbols to J. For example, when the next expected element type is a list, a “[” symbol is output to J. When the expected initial symbols for the element type are not consumed from S, in step 2704, as determined in step 2706, the routine “next element” returns the value FALSE, in step 2708. Otherwise, the routine “next element” recursively calls itself, in step 2710, to process the next expected element in the SLS data file S. Note that the next expected element type and datatype need to be determined prior to that call. When the recursive call to the routine “next element” returns the value FALSE, as determined in step 2712, the value FALSE is returned in step 2714. When the currently considered element type can include multiple sub-elements, as determined in step 2716, and when there is another sub-element to consume, as determined in step 2718, the routine “next element” consumes any delimiter symbol or symbols from S and outputs any corresponding needed delimiter symbol or symbols to J, in step 2720 and, if a delimiter was expected and the proper symbol or symbols were consumed, as determined in step 2722, the routine “next element” is a again called in step 2710. Otherwise, FALSE is returned in step 2724. In step 2726, any final expected symbols are consumed from S and any corresponding final symbols are output to J. Of course, this is a rather abstract representation of the routine “next element.” When processing a complex document, such as an SLS data file, there is considerable logic involved in determining the expected next element types and datatypes and much additional logic may need to be included depending on the syntax and semantics of the SLS data file being processed.

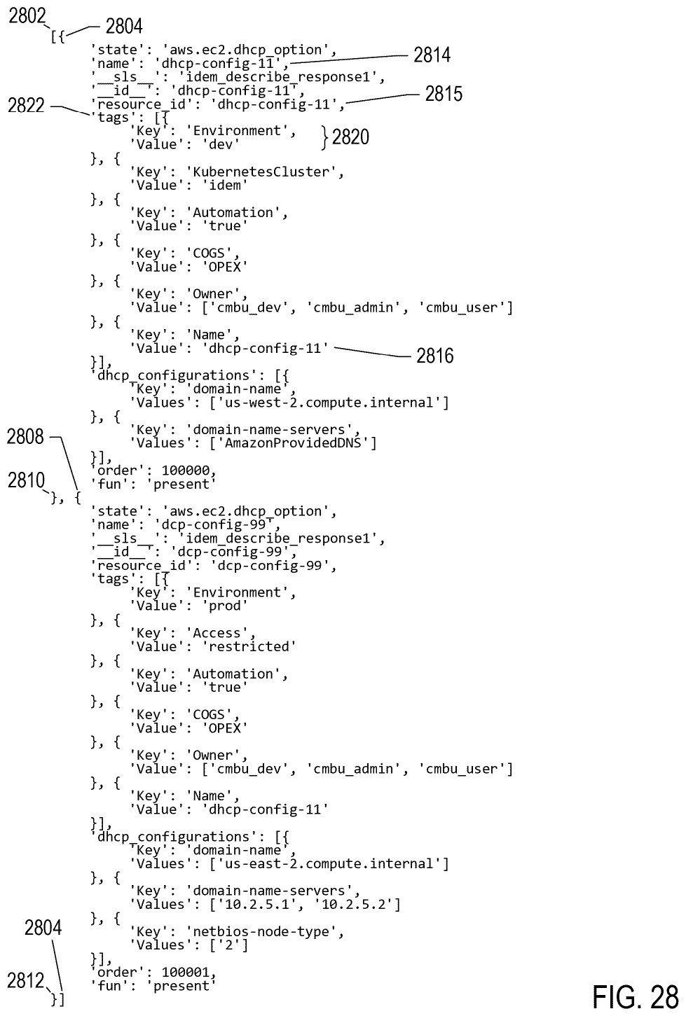

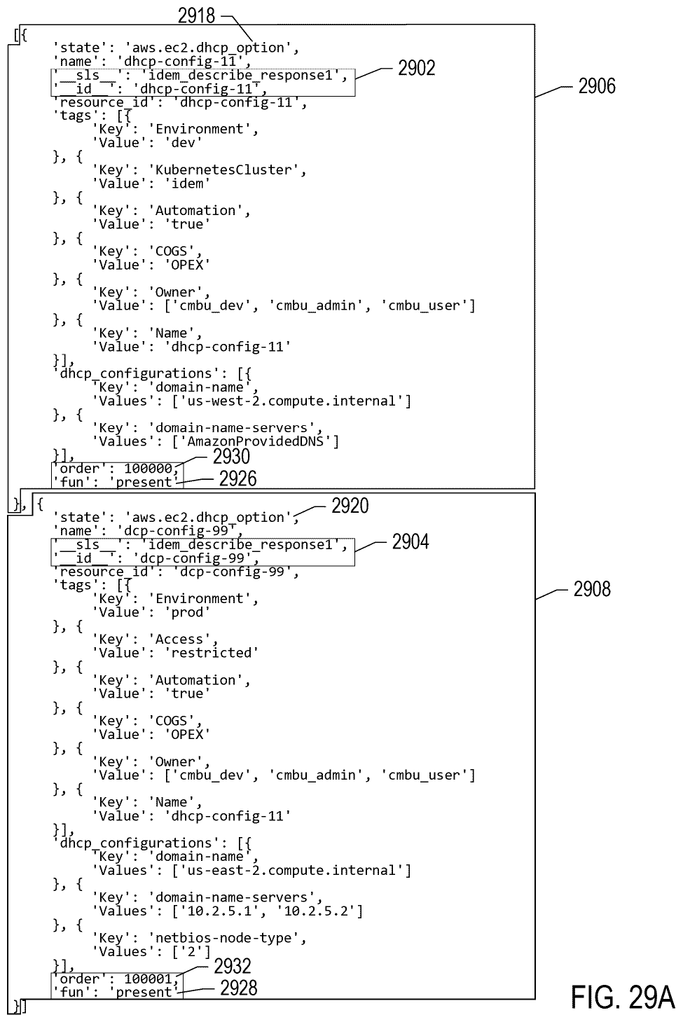

FIG. 28 shows the contents of the JSON-like representation J of the example SLS data file S provided in FIG. 23. The JSON-like representation represents the two resource descriptors as elements of a list that begins with a first “[” symbol 2802 and that ends with a final “]” symbol 2804. Each resource descriptor is a data structure that begins with a “{” symbol 2806 and 2808 and ends with a “}” symbol 2810 and 2812. In general, the content of the JSON-like representation J is identical to the content of the SLS the data files S, with a few exceptions.

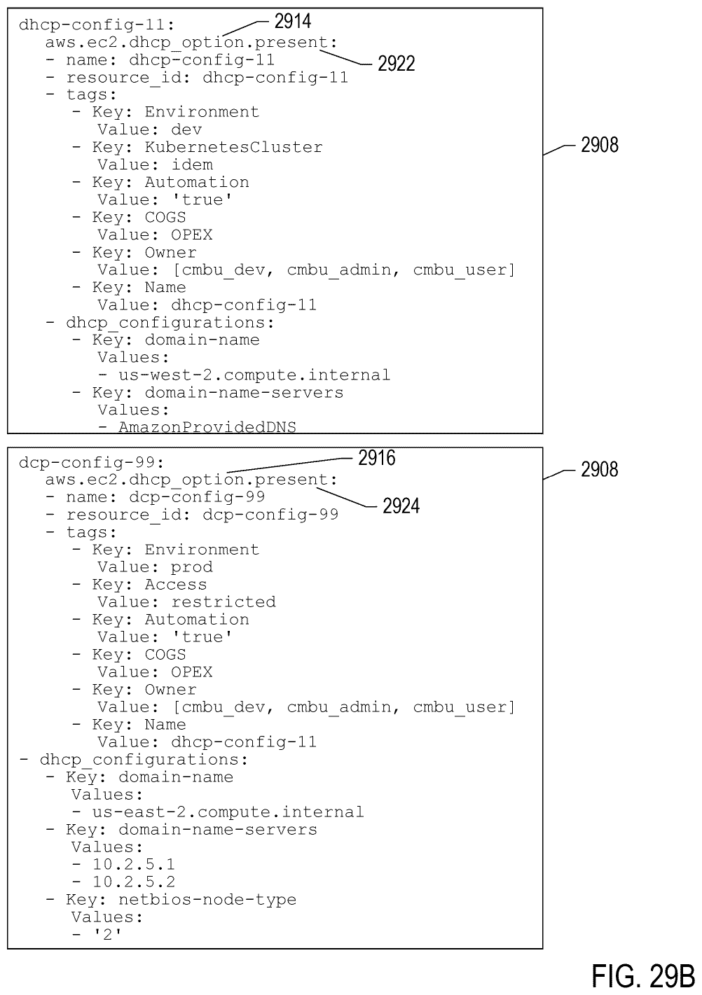

FIGS. 29A-B again show the JSON-like representation J and the SLS data file S, for convenient comparison. The JSON-like representation J, shown in FIG. 29A, includes additional metadata 2902 and 2904 in each of the two resource descriptors 2906 and 2908 that are not present in the two resource descriptors 2910 and 2912 in the SLS data file S shown in FIG. 29B. The cloud-provider/service/resource-type tuples 2914 and 2916 in the SLS data file S are now included in the value fields 2918 and 2920 of a key/value pair with key “state.” The function “present” 2922 and 2924 in the SLS data file S is moved to additional key/value pairs 2926 and 2928 in the JSON-like representation J, along with additional key/value pairs 2930 and 2932. Otherwise, the contents of the JSON-like representation J are equivalent to contents of the SLS data file S, having been translated/formatted into JSON.

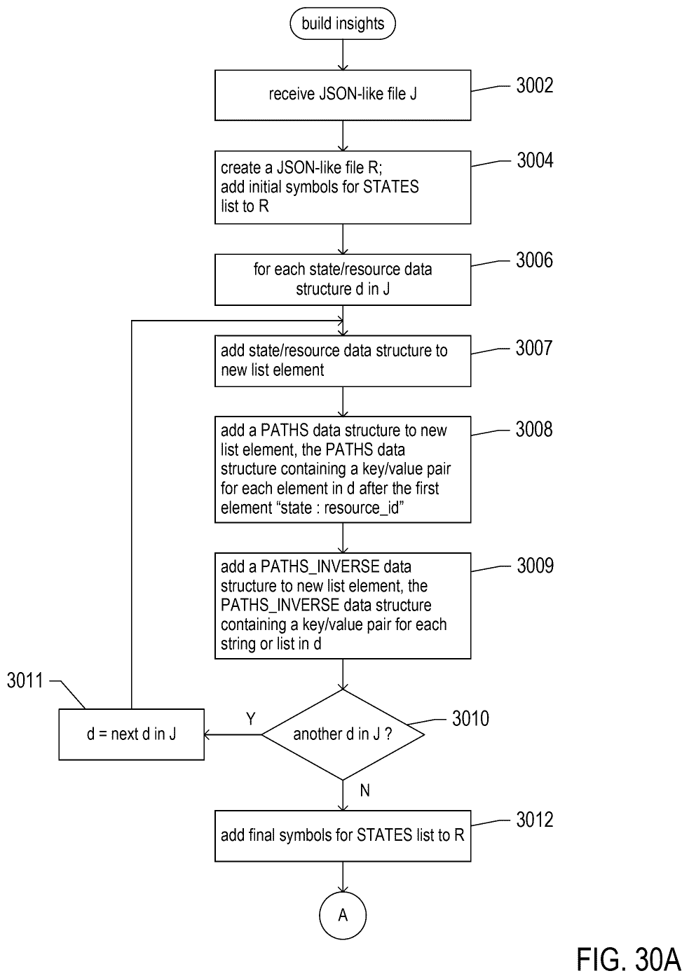

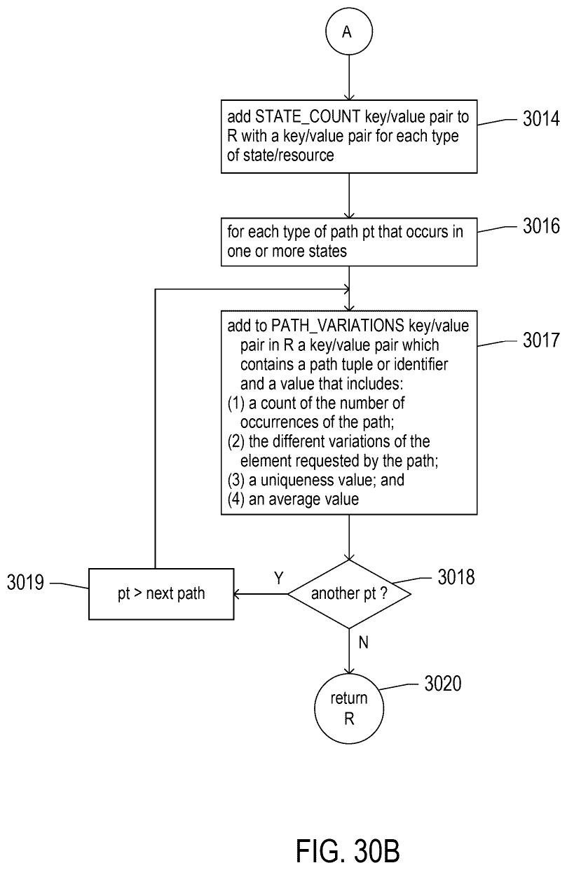

FIGS. 30A-B provide control-flow diagrams for the routine “build insights,” called in step 2506 of FIG. 25. In step 3002, the JSON-like representation J is received. In step 3004, the routine “build insights” creates a new file R to contain the build-insights response in JSON-like format and adds initial symbols to R for the key of a key/value pair “STATES,” the value of which is a list that includes a data structure for each resource descriptor in J. In the for-loop of steps 3006-3011, the routine “build insights” adds a data-structure element to the list for each resource descriptor in J. In step 3007, the data descriptor for the currently considered resource, or state, is added as a portion of the currently considered list element for the list that is the value of the key/value pair “STATES.” Another portion of the currently considered list element, a PATHS key/value pair, is added in step 3008. The PATHS key/value pair includes a value containing a key/value pair for each element in the resource descriptor, other than the first element, the key comprising a tuple that represents a path-like address, or path, for the element and the value containing a JSON encoding of the value of the element. Thus, the value of the PATHS key/value pair is equivalent to an index or map of tuples representing paths or addresses for elements in the resource descriptor to the values of the elements in the resource descriptor. In step 3009, a final portion of the currently considered list element is added to the currently considered list element. This is a PATHS_INVERSE key/value pair, the value of which is an inverse mapping of resource-descriptor-element values to internal references or element addresses for elements in the resource descriptor. Following completion of the for-loop of steps 3006-3011, the routine “build insights” adds final symbols for the STATES list to the file R, in step 3012. Continuing to FIG. 30B, the routine “build insights,” in step 3014, next adds a STATE_COUNT key/value pair to R which contains a key/value pair for each type of state or resource, the key including the name of the resource type and the value containing a count of the number of occurrences of the resource of the resource type in the SLS data file S. Finally, in the for-loop of steps 3016-3019, the routine “build insights” adds a PATH_VARIATIONS key/value pair, the value of which includes a key/value pair for each path that occurs in one or more resources or states. The key of the key/value pair for a path includes a path and the value includes a count of the number of occurrences of the path, different variations of the element represented by the path, a uniqueness value, and an average value. The file R is returned, in step 3020, at the completion of execution of the for-loop of steps 3016-3019.

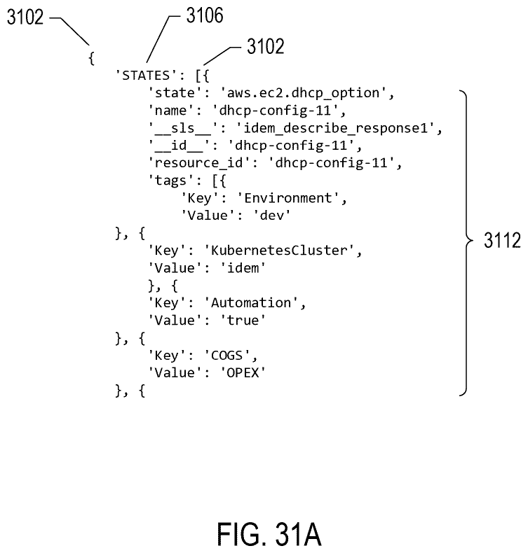

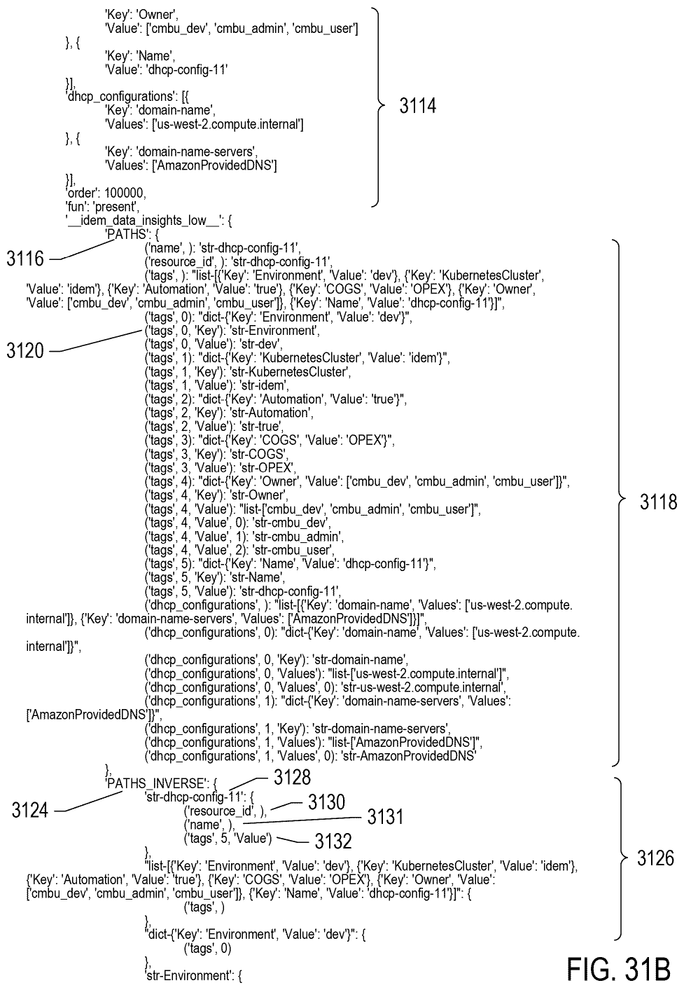

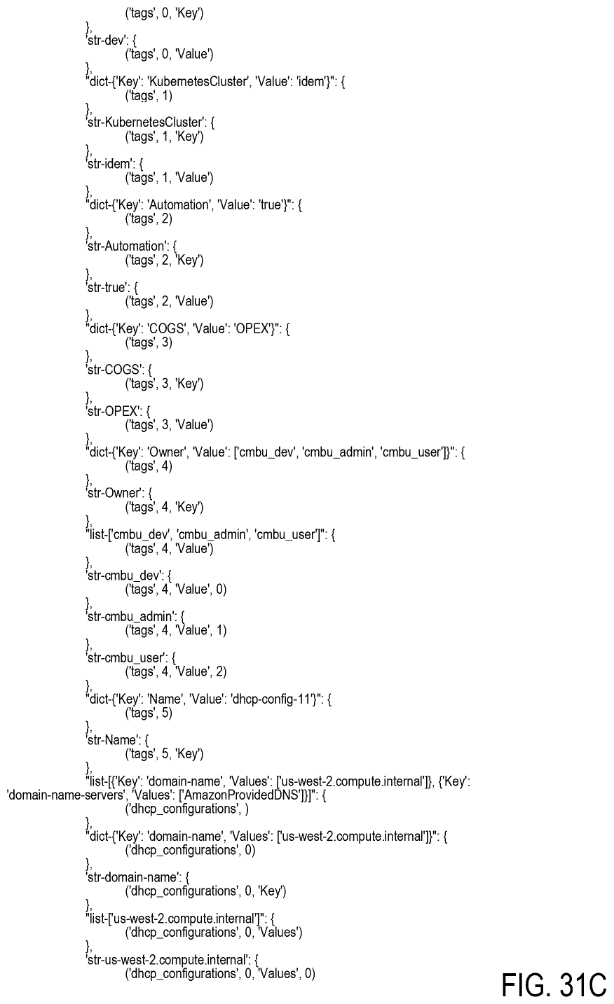

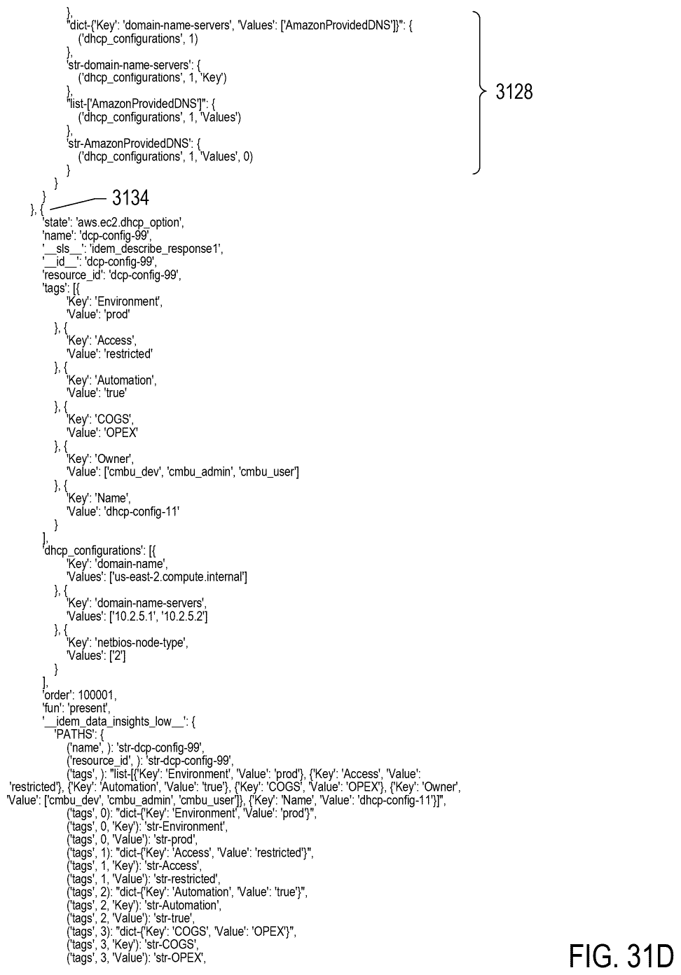

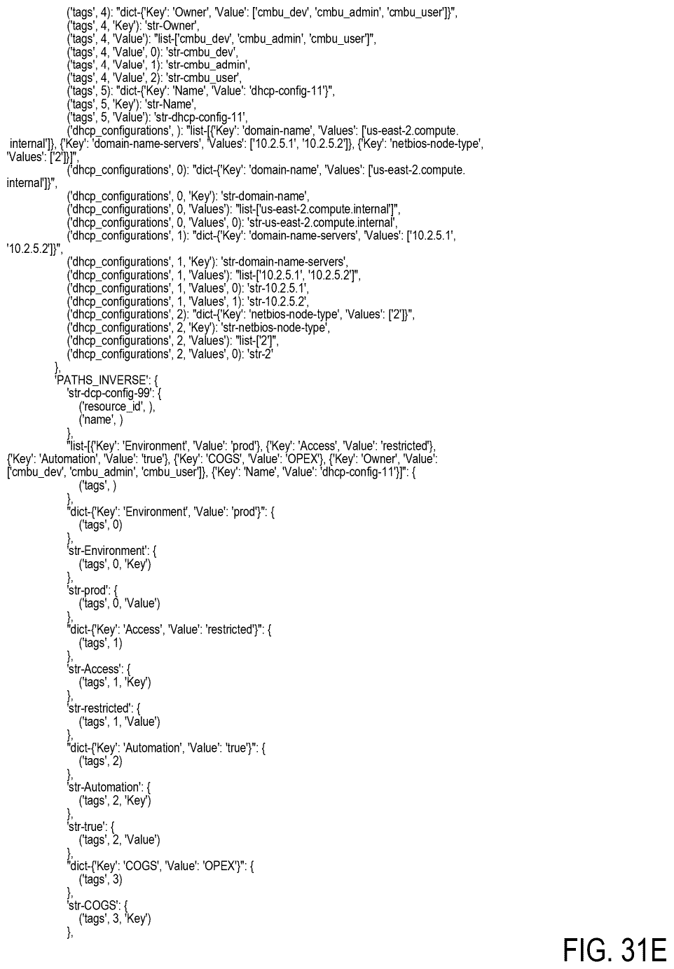

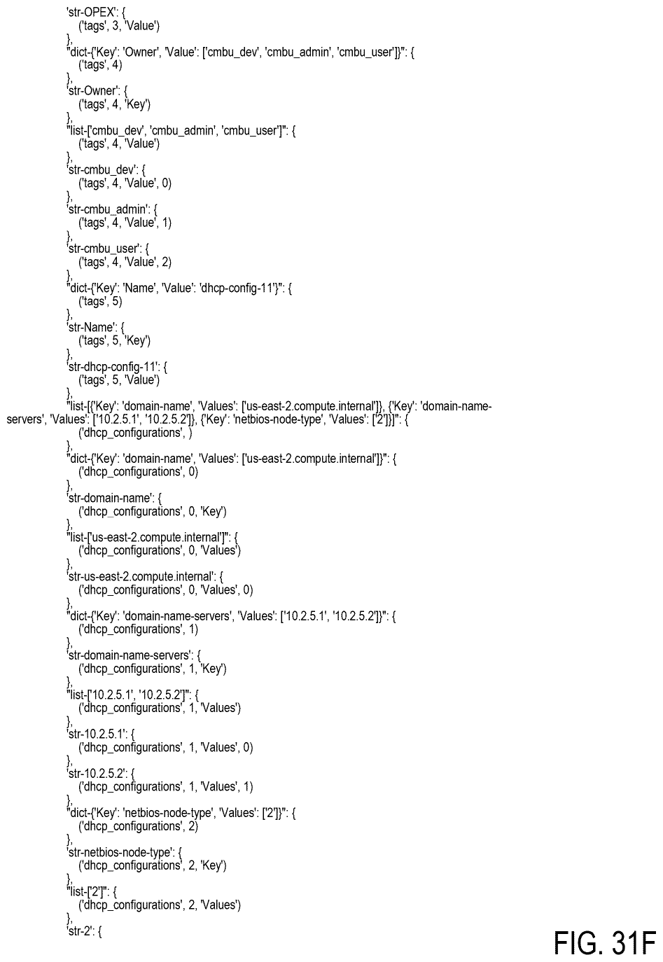

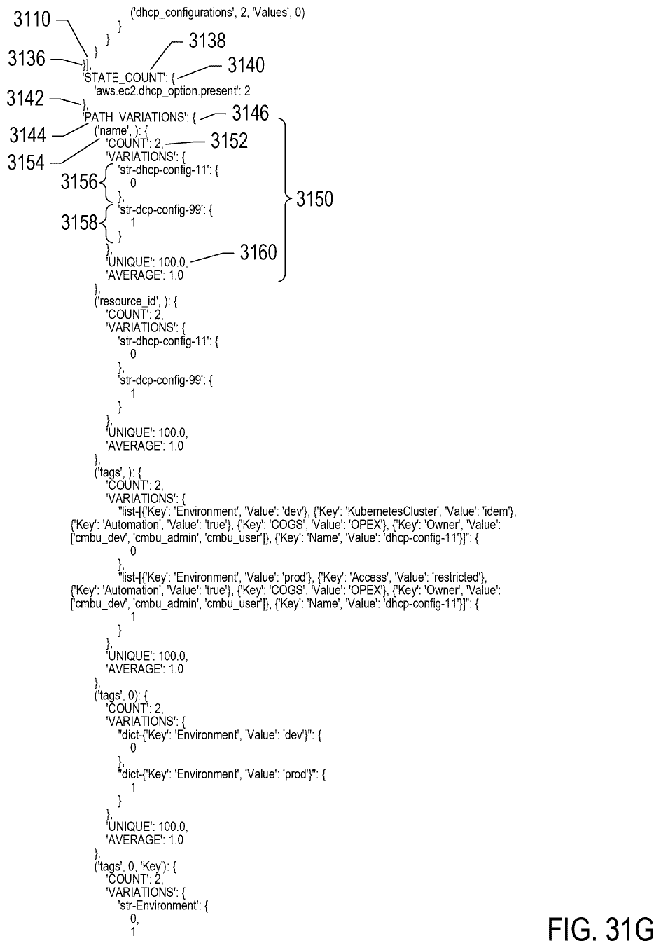

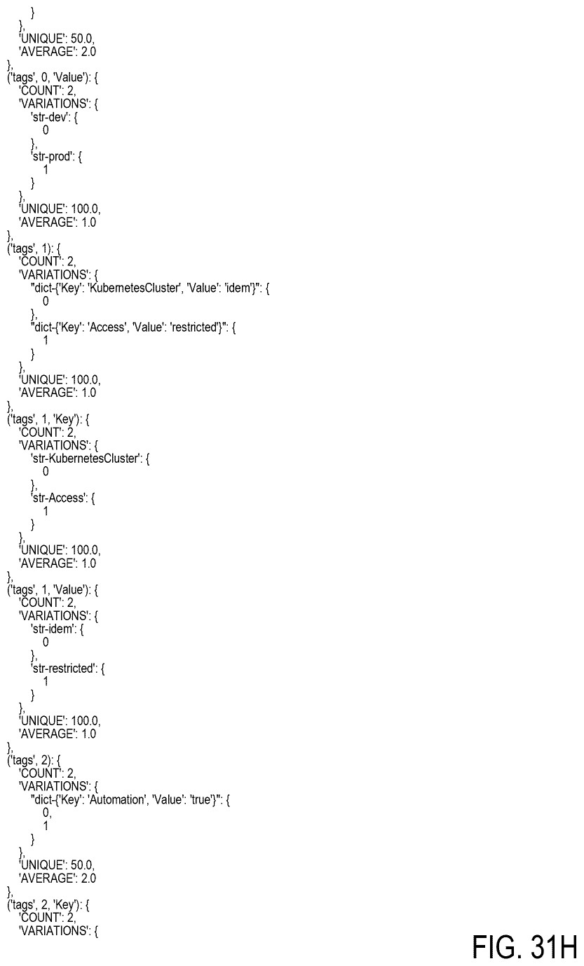

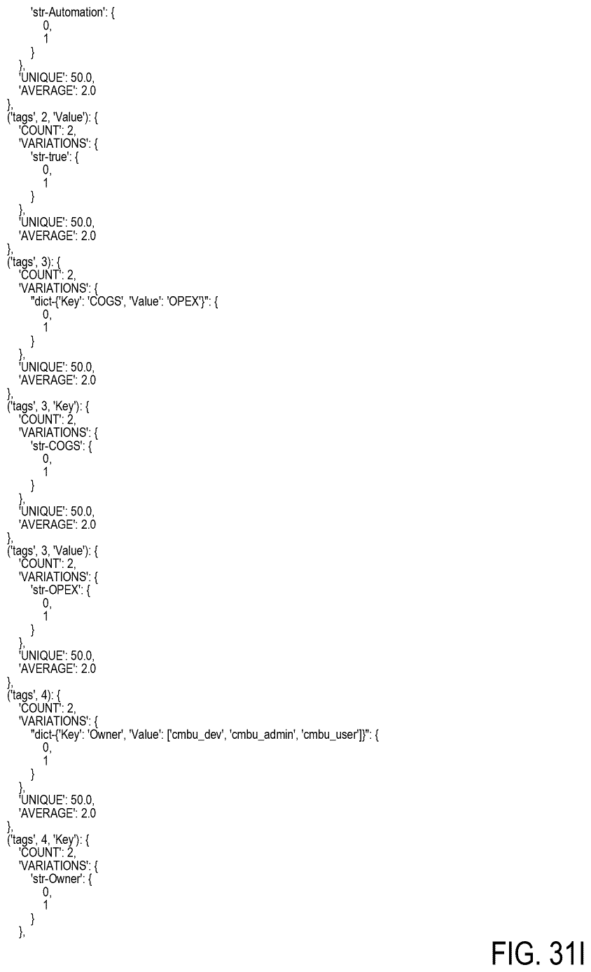

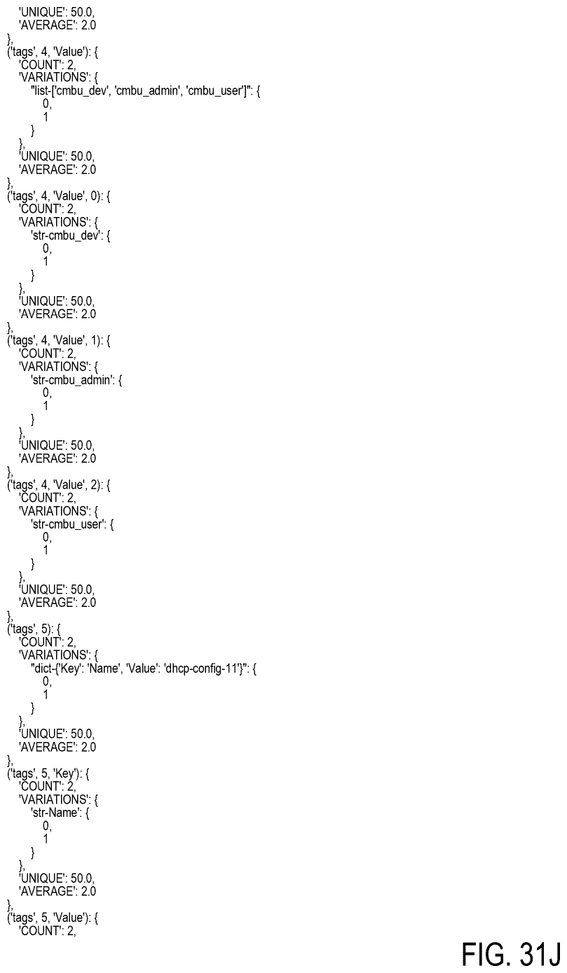

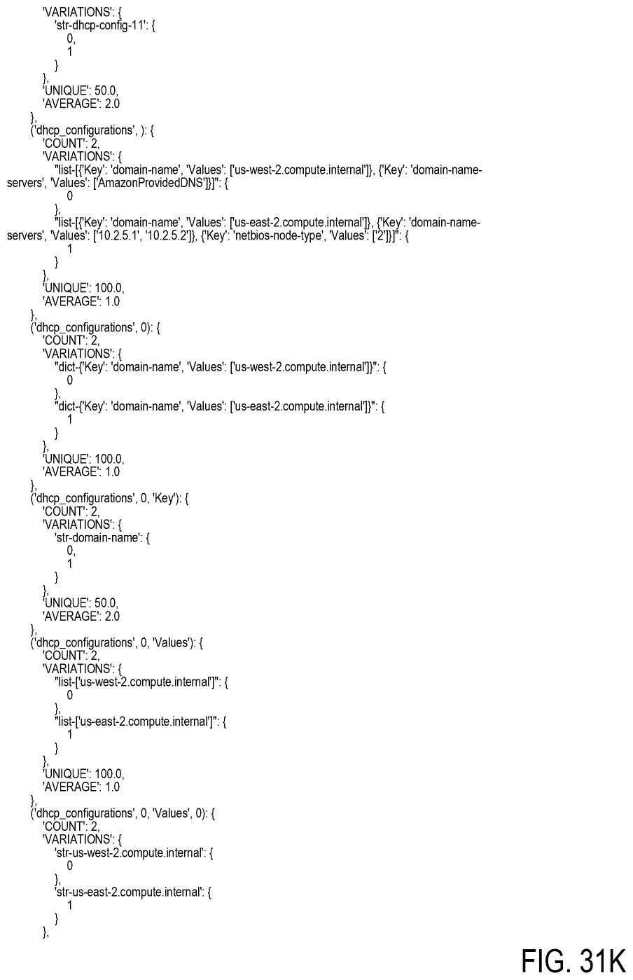

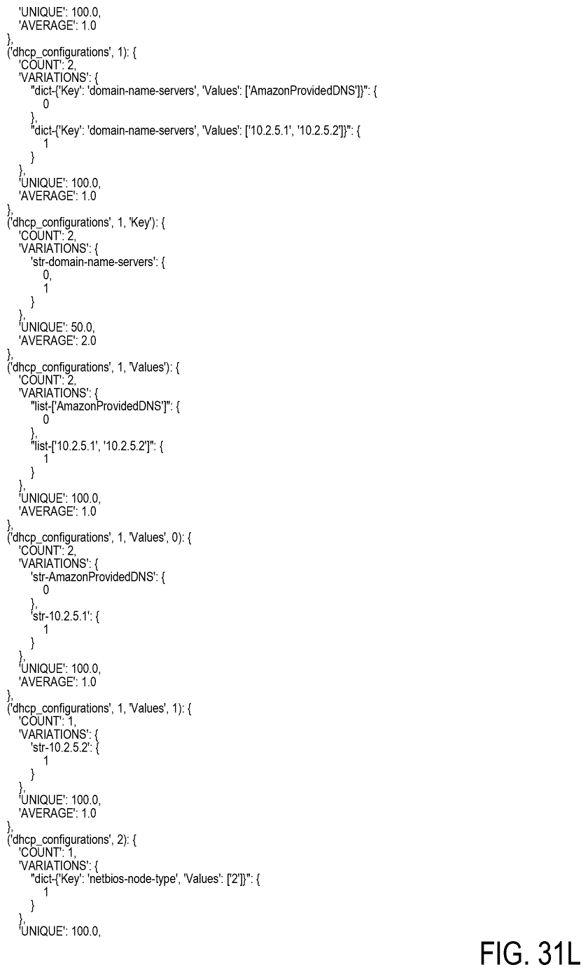

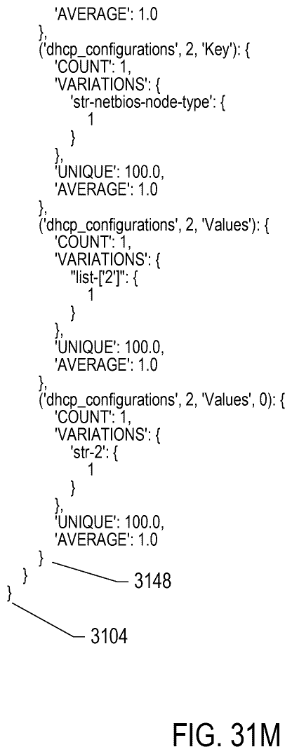

FIGS. 31A-M show the build-insights response contained in the build-insights-response file R produced from the JSON-like representation J output by the routine “compile and validate” for the example SLS data file S shown in FIG. 23. The build-insights response is a data structure that begins with symbol “{” 3102 in FIG. 31A and ends with symbol “}” 3104 in FIG. 31M. The first element of this outer data structure is the above-mentioned key/value pair with key “STATES” 3106 and with a list value that begins with symbol “[” 3108 in FIG. 31A and ends with symbol “]” 3110 in FIG. 31G. Each element in this list includes the resource descriptor for a resource, including the resource-descriptor 3112 in FIG. 31A and 3114 in FIG. 31B, which is the same resource descriptor as resource descriptor 2302 in FIG. 23. As mentioned above, the next portion of the first element of the outer data structure is a key/value pair with key “PATHS” 3116 and a value 3118. The value includes a key/value pair for each element in the resource descriptor other than the first element. The key of each of these elements is a tuple that represents an internal address for the resource-descriptor element, referred to as a “path,” and the value for each of these elements is the value of the resource-descriptor element referenced by the path key. For example, element 3120 includes the key (‘tags’, 0, ‘Key’), which is a path to the key/value pair 2820 in FIG. 28. The element “tags” specifies the tags key 2822 in FIG. 28, the element 0 specifies the first key/value pair in the series of key/value pairs included in the value of the key/value pair that includes “tags” as key, and the element “Key” specifies the key of the first key/value pair in a series of key/value pairs. Together, these elements comprise a path from the top of the resource descriptor to the value “Environment” in key/value pair 2820. The value 3122 of element 3120 specifies the string value “Environment.”

A final portion of the first element of the outer data structure is a key/value pair with key “PATHS_INVERSE” 3124 and a value that includes portion 3126 in FIG. 31B, all of the text in FIG. 31C, and portion 3128 in FIG. 31D. The value includes key/value pairs with keys comprising the values of elements in the resource descriptor and values containing paths to those values. For example, the value “dchp-config-11,” which is the user-friendly resource identifier for the first resource or state, is the key 3128 for a first key/value pair with a value that includes three paths 3130-3132 within the first resource descriptor to value fields 2814-2816 in FIG. 28 containing the value “dchp-config-11” in the JSON-like representation J.

There are only two resources, or states, in the example SLS data file S shown in FIG. 23. Therefore, there are two elements in the list value of the outer data structure in R that includes the key/value pair with key “STATES” 3106 and the list that begins with symbol “[” 3108 in FIG. 31A and ends with symbol “]” 3110 in FIG. 31G. The second element, corresponding to the second resource descriptor 2304 in FIG. 23, begins with symbol “{” 3134 in FIG. 31D and ends with symbol “}” 3136 in FIG. 31G. The outer data structure next includes the key/value pair with key “STATE_COUNT” 3138 and the data structure that begins with symbol “{” 3140 and ends with symbol “}” 3142 in FIG. 31G. This data structure includes a single key/value pair representing the number of dhcp_option resources in SLS data file S. Finally, the outer data structure includes the key/value pair with key “PATH_VARIATIONS” 3144 and, for the value, a data structure that begins with symbol “{” 3146 in FIG. 31 G ends with symbol “}” 3148 in FIG. 31M. The data structure includes a series of key/value pairs, such as key-/value pair 3150, with each key representing a path and with the value comprising a data structure that indicates the number of the paths indicated by the key in the SLS data file S and the different values associated with the paths, along with an indication of the resource descriptor including the values. Thus, there are two occurrences 3152 of the path “name” 3154 in the SLS data file S, one occurrence in the first resource descriptor 3156 and the other occurrence in the second resource descriptor 3158. The uniqueness value for this path 3160 is 100, indicating that each path points to a different value. When the uniqueness value is 1, all paths point to the same value.

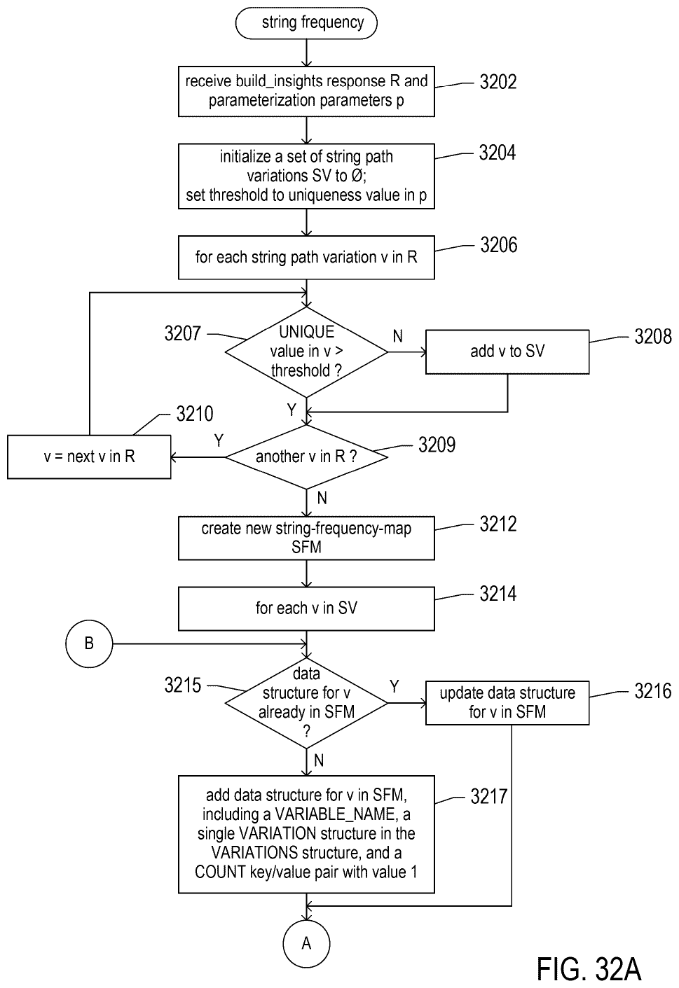

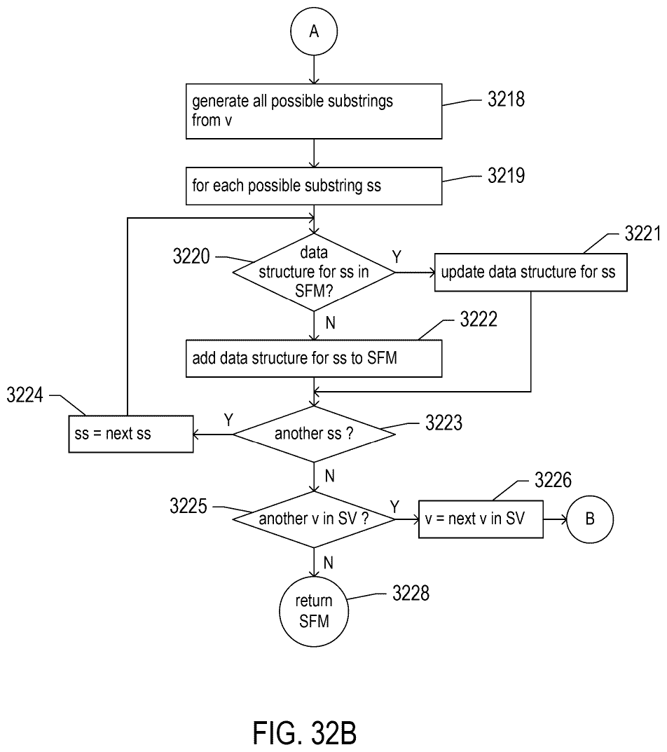

FIGS. 32A-B provide control-flow diagrams that illustrate implementation of the routine “string frequency,” called in step 2508 of FIG. 25. In step 3202, the routine “string frequency” receives the build-insights response R and the parameterization parameters P. In step 3204, the routine “string frequency” initializes a local set variable SV to the empty set. This variable is used to store indications of path variations that point to string values. In addition, a threshold local variable is set to a uniqueness-value threshold in the parameterization parameters P. In the for-loop of steps 3206-3210, the key/value pair for each string path in the elements of the value of the key/value pair with the key “PATH_VARIATIONS” in J is considered. When the uniqueness value in the currently considered key/value pair is less than or equal to the value stored in the local threshold variable, as determined in step 3207, an indication of the currently considered key/value pair is added to the set SV, in step 3208. Following completion of the for-loop of steps 3206-3210, the routine “string frequency” creates a new string-frequency map SFM, in step 3212. In the for-loop of steps 3214-3026, each key/value pair indicated in SV is considered. If the currently considered key/value pair has already been added to SFM, as determined in step 3215, that key/value pair is updated in step 3216. Otherwise, the currently considered key/value pair is added to SFM, in step 3217, by adding a key/value pair with a value comprising a data structure that includes a key/value pair with key “VARIATIONS” and a key/value pair with key “COUNT.” In step 3218, in FIG. 32B, all possible substrings of the string the constitutes that key for the currently considered key/value pair are generated. Then, in the for-loop of steps 3219-3224, a key/value pair for any of the possible substrings generated in step 3218 that have not already been added to SFM is added to SFM. When there is another key/value pair indication in the set SV, as determined in step 3025, a next iteration of the for-loop of steps 3214-3226 is carried out by flow of control back to step 3215 in FIG. 32A. Otherwise, the routine “string frequency” returns SFM in step 3228.

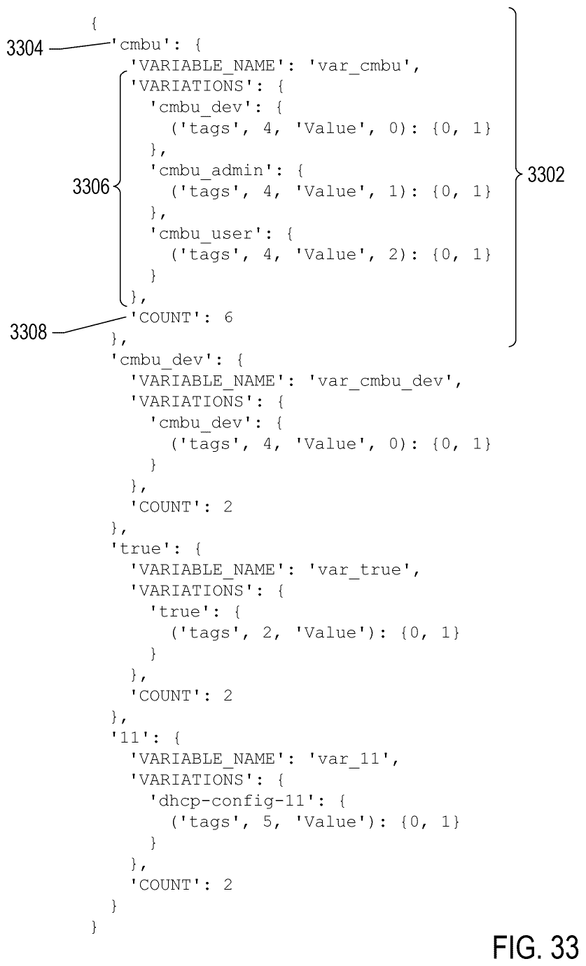

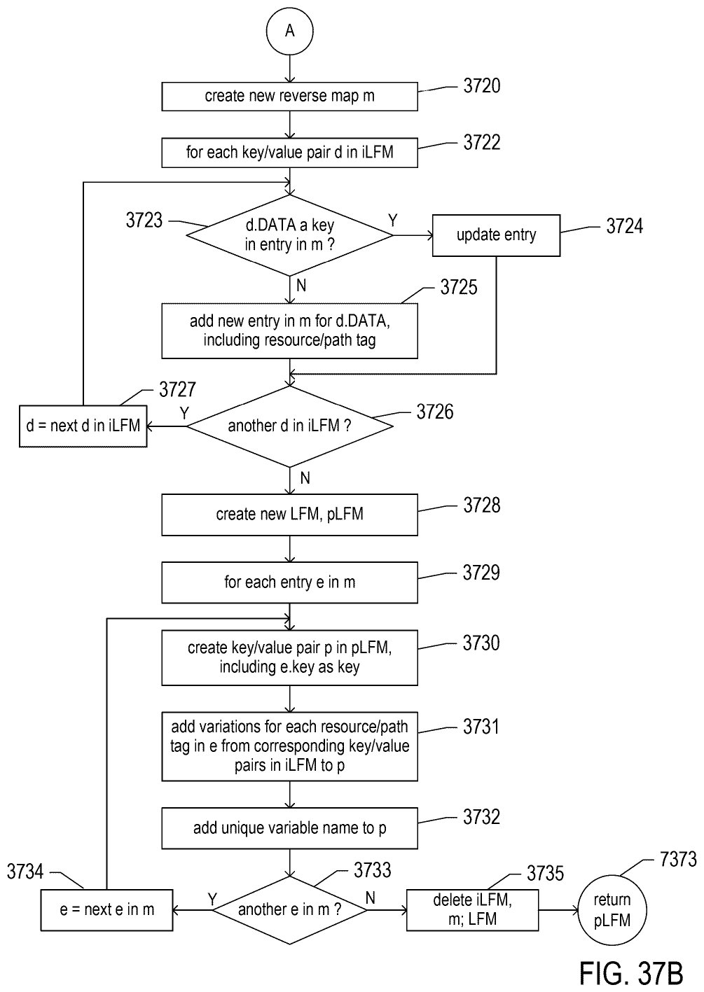

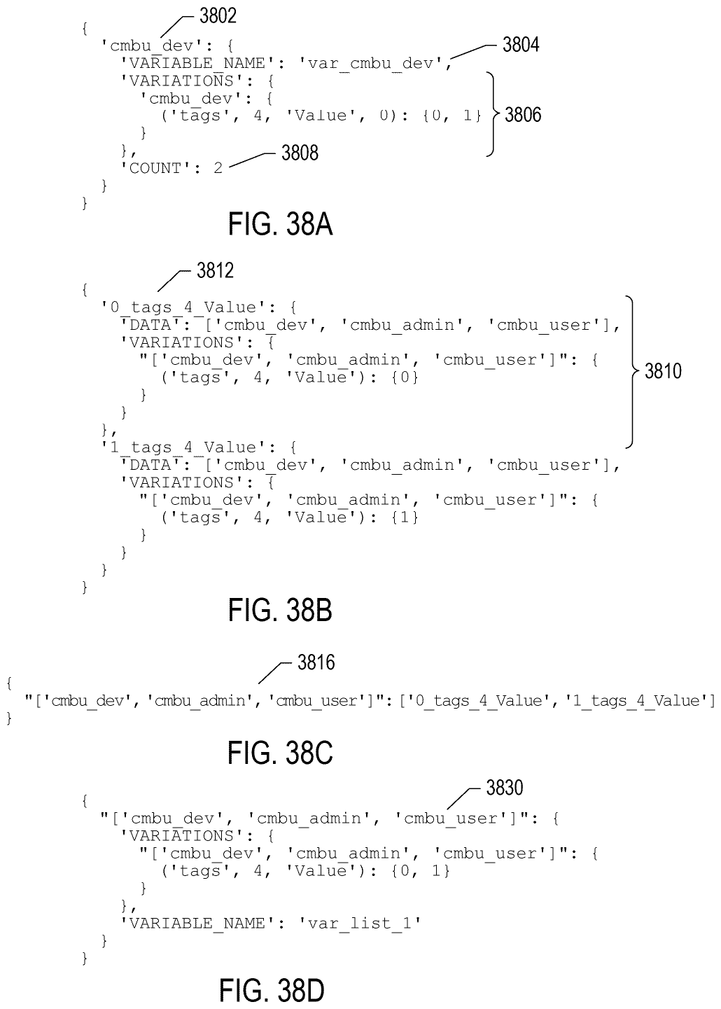

FIG. 33 illustrates a portion of the string-variable frequency map SFM generated by the routine “string frequency” for the build-insights response R generated for the SLS data file S. The key/value pair with key “cmbu” 3302 is the element of the overall data structure representing the SFM for the string variable “cmbu,” which is a substring of the string variables “cmbu_dev,” “cmbu_admin,” and “cmbu_user” that occur as list elements in the list value of the key/value pairs 2314 and 2316 in the SLS data file S shown in FIG. 23. The key/value pair with key “cmbu” 3302 is generated in the inner for-loop of steps 3219-3224 in FIG. 38B. The value for this key/value pair is a data structure that includes three key/value pairs with keys “VARIABLE_NAME” 3304, “VARIATIONS” 3306, and “COUNT” 3308 The value of the key/value pair with key “VARIABLE_NAME” is a proposed variable name, “var_cmbu,” for a parameterization variable with the value “cmbu.” The value of the key/value pair with key “VARIATIONS” includes key/value pairs for each possible string variable that includes “cmbu” that occurs in the SLS data file S, the value of each key/value pair a data structure that includes the path for the possible string variable and an indication of the resource descriptors that include the path. The value of the key/value pair with key “COUNT” indicates the number of occurrences of the string that is the key of the key/value-pair of the overall data structure representing the SFM. Thus, the string-frequency map SFM includes key/value pairs for each possible string variable in the SLS data file S, the value of each such key/value pair indicating a proposed variable name, paths to all occurrences of the string variable, and a count of the occurrences.

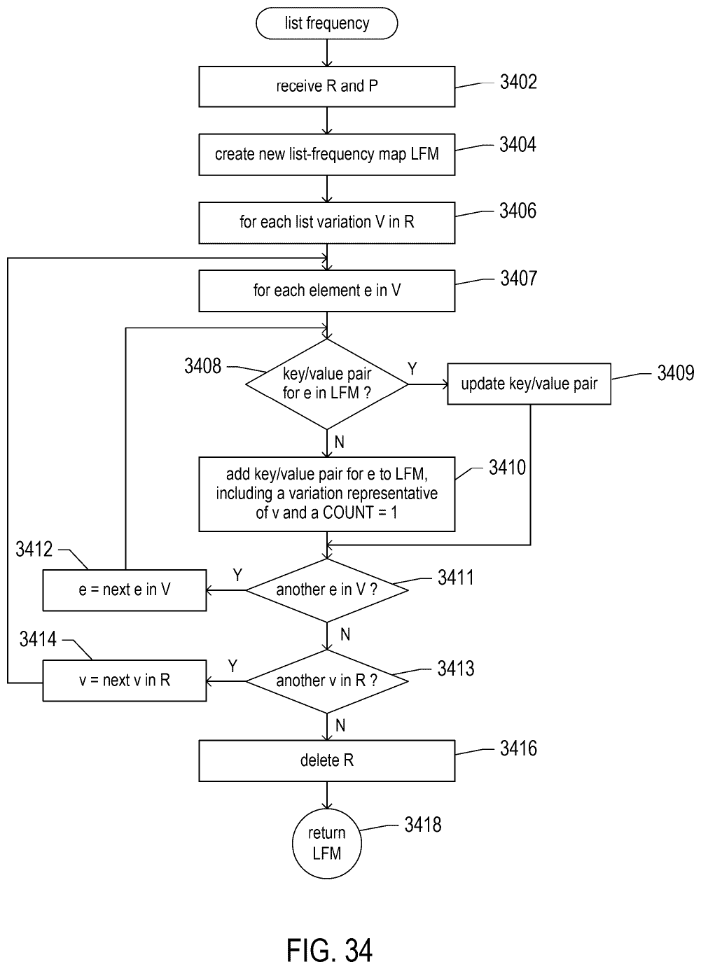

FIG. 34 provides a control-flow diagram for the routine “list frequency,” called in step 2510 of FIG. 25. In step 3402, the routine “list frequency” receives JSON-like representation R and parameterization parameters P. In step 3404, a new list-frequency map LFM is created. In the outer for-loop of steps 3406-3414, the data structure v for each list path in the elements of the value of the key/value pair with key “PATH_VARIATIONS” in J is considered. In the inner for-loop of steps 3407-3412, each list element in the currently considered variation v is considered. When a key/value pair for the element is already included in LFM, as determined in step 3408, the key/value pair is updated in step 3409. Otherwise, in step 3410, a key/value pair for the currently considered element is added to the LFM, the value of which includes a VARIATIONS key/value pair and a COUNT key/value pair. Upon completion of execution of the outer for-loop of steps 3406-3414, the routine “list frequency” deletes R, in step 3416, and returns the LFM in step 3418.

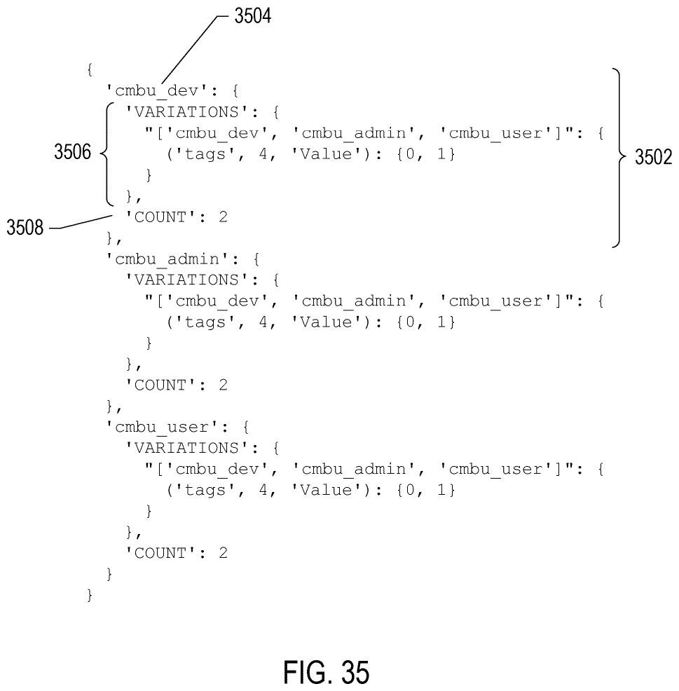

FIG. 35 illustrates a portion of the LFM output by the routine “list frequencies” following processing of the JSON-like representation J. The LFM is a data structure that contains key/value pairs, one for each list element that occurs in the SLS data file S. The key/value pairs 2314 and 2316 in FIG. 23 each include list values. There is a key/value pair in the LFM for each of the elements in these list values, including the key/value pair 3502 for the list element “cmbu_dev.” The key is “cmbu_dev” 3504 and the value is a data structure that includes a VARIATIONS key/value pair 3506 and a COUNT key/value pair 3508. The value of the VARIATIONS key/value pair includes a key/value pair with key equal to the list in which the list element “cmbu_dev” occurs and a path to that element along with an indication of resource descriptors that include the path. The COUNT key/value pair includes a value indicating the number of occurrences of the list element “cmbu_dev.”

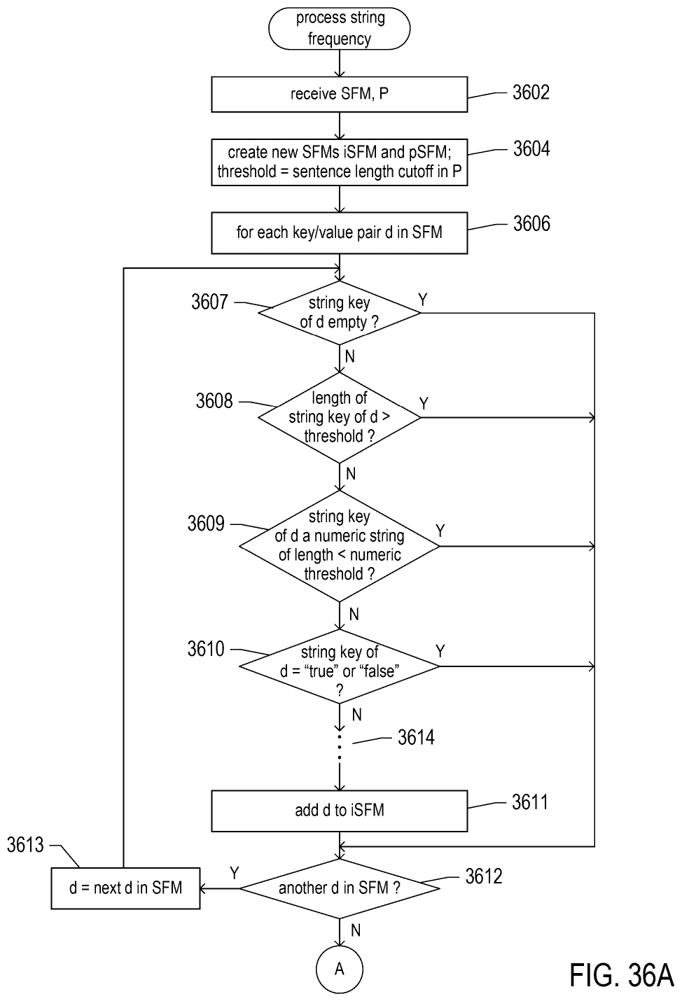

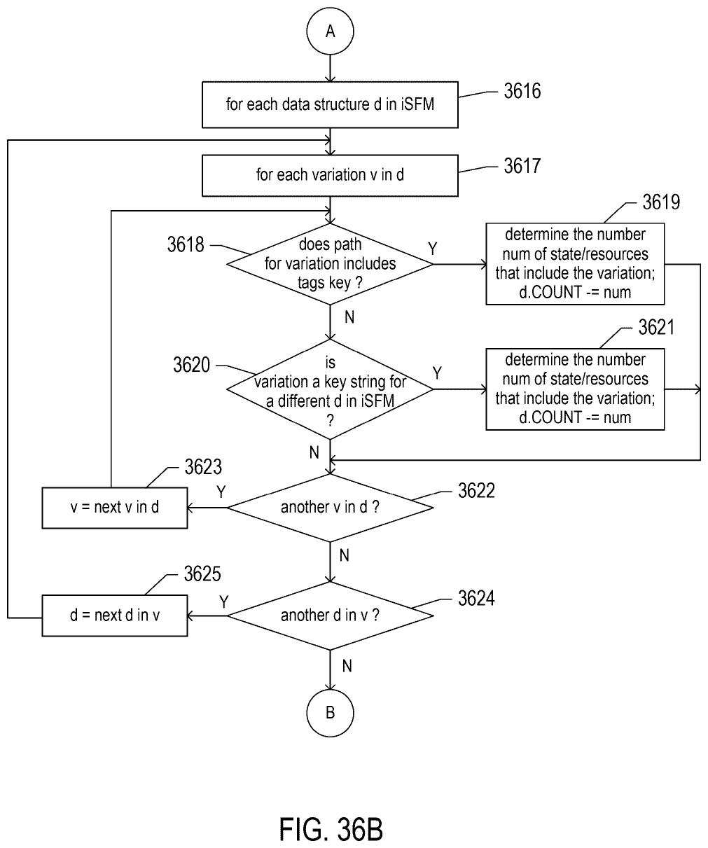

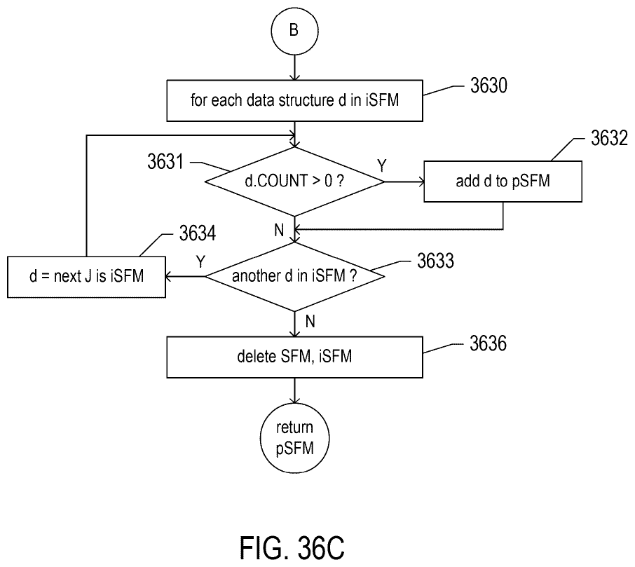

FIGS. 36A-C provide control flow diagrams that illustrate an implementation of the routine “process string frequency,” called in step 2512 of FIG. 25. In step 3602, the routine “process string frequency” receives a string-frequency map SFM produced by the routine “string frequency” and parameterization parameters P. In step 3604, the routine “process string frequency” creates a new SFM, iSFM, and sets a threshold variable to a sentence-length-cutoff value included in the parameterization parameters P. In the for-loop of steps 3606-3613, each key/value pair d in the SFM is considered. A series of steps 3607-3610 filter the key/value pairs to eliminate potential string variables, including string variables for which the string is the empty string, for which the length of the string is greater than the threshold value, for which the string is a short numeric value of a length less than a numeric-string-value-length threshold, and for which the string is a representation of one of the Boolean values TRUE or FALSE. Ellipsis 3614 indicates that other filtering criteria may be used in alternative implementations. When the currently considered key/value pair d has not been rejected by one of the filtering criteria, it is added to iSFM, in step 3611. In the for-loop of steps 3616-3625 in FIG. 36B, the key/value pairs in iSFM are each considered. When a variation in the VARIATIONS key/value pair has a key with the value “tags” or when the key occurs in a different key/value pair in iSFM, the value of the COUNT key/value pair in the value of the currently considered key/value pair d is decremented by the number of resources or states that include the variation, in steps 3619 and 3621. This has the effect of discounting occurrences of the string “tags” and discounting substrings of strings. Finally, in the for-loop of steps 3630-3634, each key/value pair in iSFM is again considered. Those key/value pairs in iSFM for which the value of the COUNT key/value pair is greater than 0 are added to pSFM, the processed string-frequency map. In step 3636, the routine “process string frequency” deletes SFM and iSFM and then returns pSFM.

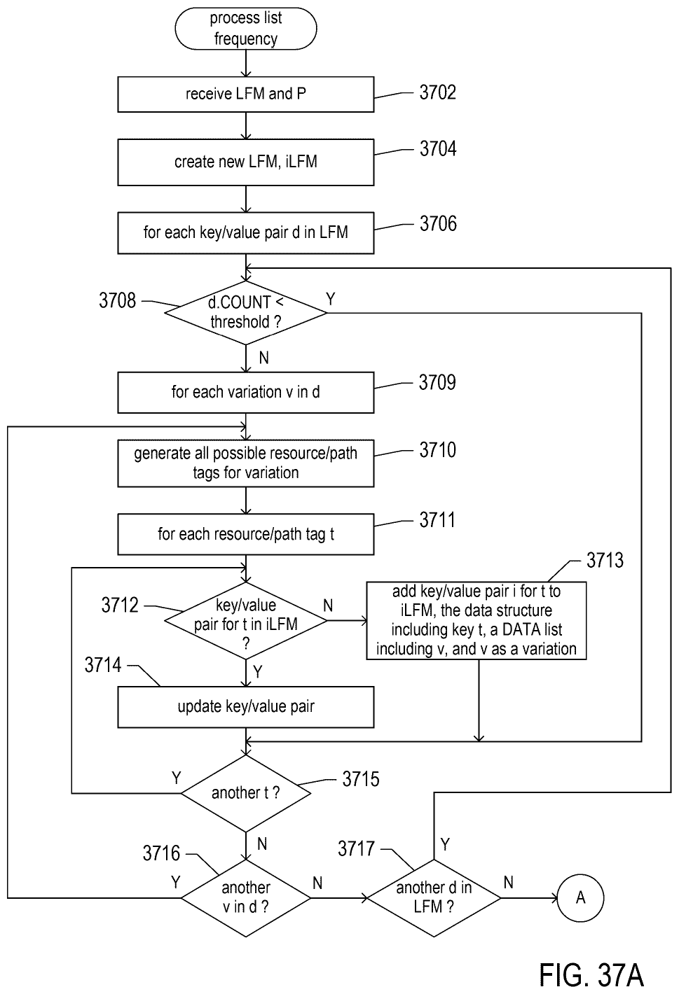

FIGS. 37A-B provide control flow diagrams that illustrate an implementation of the routine “process list frequency” called in step 2514 of FIG. 25. In step 3702, the routine “process list frequency” receives a list-frequency map LFM produced by the routine “list frequency” and parameterization parameters P. In step 3704, the routine “process list frequency” creates a new LFM, iLFM. In the for-loop of steps 3706-3717, each key/value pair d in the LFM is considered. In step 3708, the routine “process list frequency” determines whether the COUNT key/value pair has a count value of less than a threshold value. If so, the currently considered key/value pair d is not processed. Otherwise, in the inner for-loop of steps 3709-3716, each variation v in d is considered. In step 3710, all possible paths for the currently considered variation are generated. In the innermost for-loop of steps 3711-3715, each possible path t generated in step 3710 is considered. When a key/value pair for t is not already in iLFM, as determined in step 3712, a key/value pair for t is added to iLFM, in step 3713. Otherwise, in step 3714, the key/value pair for t is updated. Following the completion of the for-loop of steps 3706-3717, a new reverse map m is created, in step 3720 of FIG. 37B. In the for-loop of steps 3722-3727, when the value of the DATA key/value pair is a key of an entry already in the reverse map m, as determined in step 3723, the entry is updated in step 3724. Otherwise, a new entry is added to m, in step 3725, for the value of the DATA key/value pair. In step 3728, a new LFM, pLFM, is created. In the for-loop of steps 3729-3734, each entry e in the reverse map m is considered. In step 3730, a key/value pair p is created for the currently considered entry e in pLFM, with key equal to e.key. Then, in step 3731, variations for each resource/path tag in e from corresponding key/value pairs in iLFM are added to p. Finally, a unique variable name is added to p in step 3732. In step 3735, iLFM, m, and LFM are deleted. In step 3736, the routine “process list frequency” returns pLFM.

FIGS. 38A-D show examples of the contents of the pSFM and pLFM. FIG. 38A shows a key/value pair in the pSFM. The key “cmbu_dev” 3802 is the value of the potential string variable. The value of the key/value pair includes three key/value pairs: (1) the key/value pair 3804 with key “VARIABLE_NAME” and value “var_cmbu_dev”, the proposed variable name; (2) the key/value pair 3806 with key “VARIATIONS” and value that is a key/value pair with key “cmbu_dev” and a value that includes a path and indications of the resource descriptors in which the path occurs; and (3) the key/value pair 3808 with key “COUNT” and value 2. Thus, each element in pSFM represents a potential string variable that may be included as a variable parameter in the parameters file.

FIG. 38B shows several key/value pairs from the iLFM map generated by the routine “process list frequency.” Each key/value pair, such as key/value pair 3810, includes a resource/path key, such as key 3812 and a value that includes two key/value pairs: (1) the key/value pair with key “DATA” and a value that includes a list that occurs as a value of the key/value pair in a resource descriptor in SLS data file S; and (2) the key/value pair with key “VARIATIONS” and a value that includes the list as a key and a path along with an indication of the resource descriptors in which the path occurs. FIG. 38C illustrates an entry in the reverse map m generated in the routine “process list frequency.” The entry includes a key/value pair 3816 with a key that is a list that occurs as the value of a key/value pair a resource descriptor and a value that includes a list of all the resource/path references to the list in the SLS data file S. Finally, FIG. 38D shows a key/value pair in the final pLFM generated by the routine “process list frequency.” This key/value pair is quite similar to the key/value pair shown in FIG. 38A that is an element of the pSFM. The key is a list 3830 and the value includes a first key/value pair with key “VARIATIONS” and a second key/value pair with key “VARIABLE_NAME.” The pLFM thus contains potential list variables that may be included as variable parameters in the parameters file.

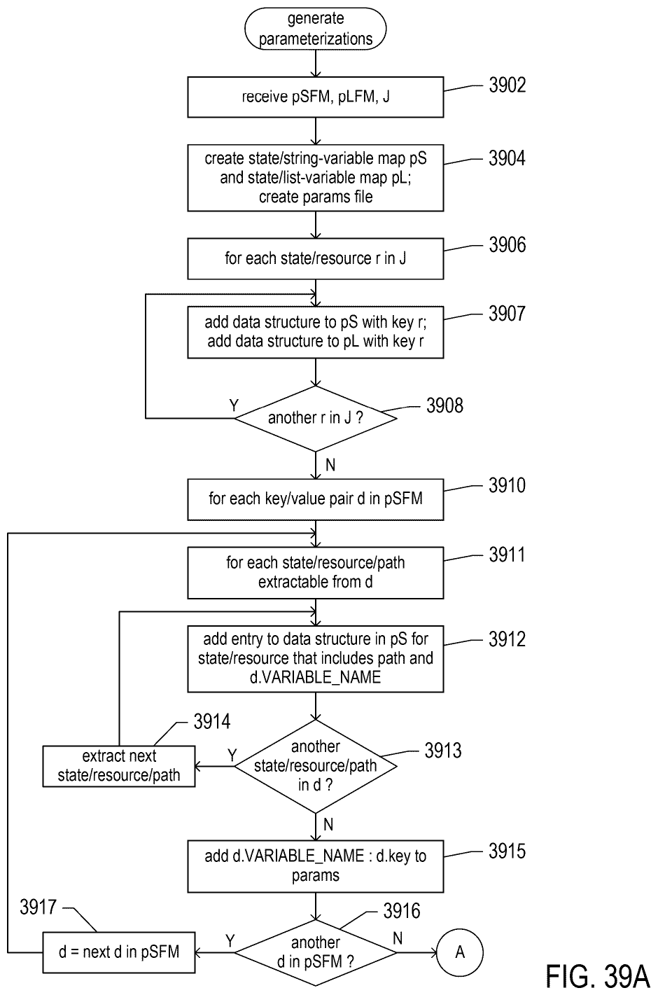

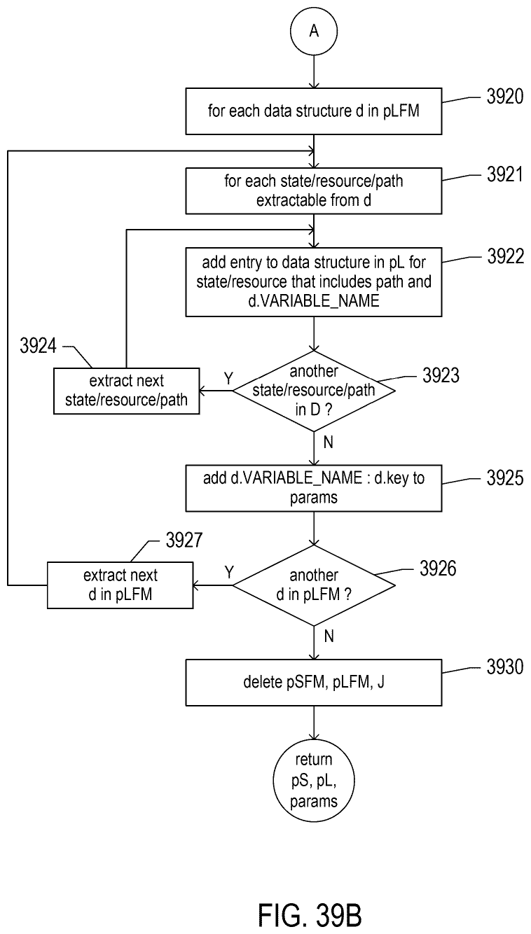

FIGS. 39A-B provide control-flow diagrams for the routine “generate parameterizations,” called in step 2516 of FIG. 24. The routine “generate parameterizations” receives, in step 3902, the processed string-frequency map pSFM generated by the routine “process string frequency” and the processed list-frequency map pLFM generated by the routine “process list frequency” along with the JSON-like representation J. In step 3904, the routine “generate conversations” creates a state/string-variable map pS, a state/list-variable map pL, and a parameters file params. In the for-loop of steps 3906-3908, the routine “generate parameterizations” considers each state or resource r described by a resource descriptor in J. A data structure with a key equal to the currently considered resource r is added to both pS and pL in step 3907. Thus, in the for-loop of steps 3906-3908, both pS and pL are initialized with data structures for each resource or state in the SLS data file S. Next, in the for-loop of steps 3910-3917, the routine “generate parameterizations” considers each key/value pair d in pSFM. In the inner for-loop of steps 3911-3914, the routine “generate parameterizations” considers each resource/path reference extractable from d. In step 3912, an entry is added to the data structure in pS for the state or resource that includes the currently considered resource/path reference along with the variable name and the currently considered key/value pair d. Following completion of the inner for-loop of steps 3911-3914, the routine “generate parameterizations” adds an entry to the file params that includes the variable name in the currently considered key/value pair d and the key of the currently considered key/value pair d that is the variable value. Thus, following completion of the for-loop of steps 3910-3917, the state/string-variable map pS includes an entry for each state or resource that maps each string variable value in the descriptor of a resource to a variable name and, in addition, each string-variable name and value has been added to the params file. The pS file thus constitutes a complete mapping of value fields in the resource descriptors of all of the resources specified in the SLS data file S to the names of string-variable parameters and the params file includes a complete mapping of string-variable names to string-variable values. The for-loop of steps 3920-3927 in FIG. 39B is equivalent to the above-described for-loop of steps 3910-3917 with the exception that the for-loop of steps 3920-3927 produce the pL file that constitutes a complete mapping of value fields in the resource descriptors of all the resources specified in the SLS data file S that include list values to list-variable names and completes the params file to include a complete mapping of list-variable names to list-variable values. In step 3930, the routine “generate parameterizations” deletes pSFM, pLFM, and J.

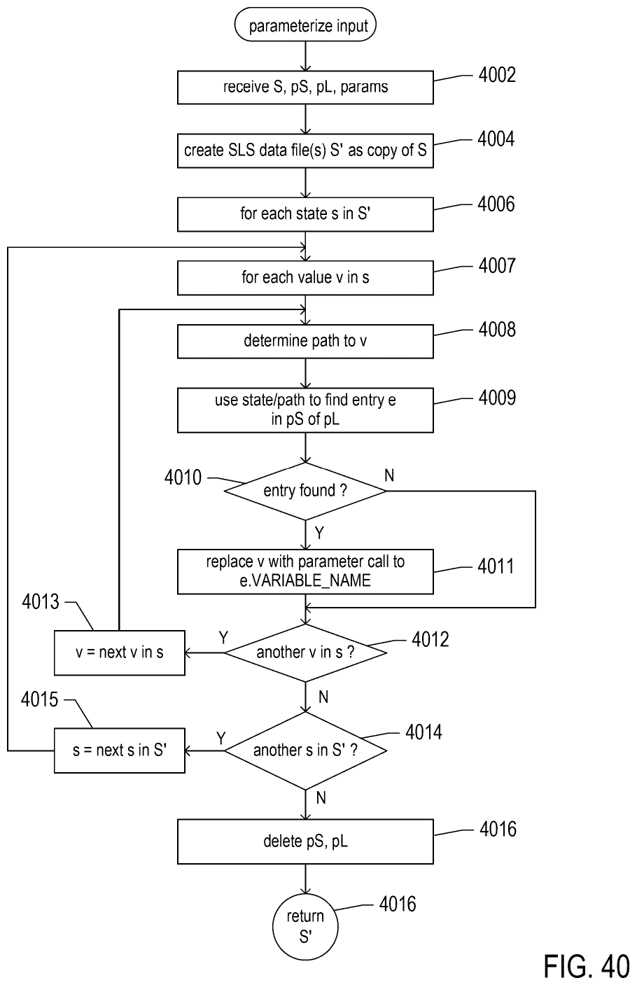

FIG. 40 provides a control-flow diagram that illustrates an implementation of the routine “parameterized input,” called in step 2518 of FIG. 25. In step 4002, the routine “parameterized input” receives the SLS data file S and the pS, pL, and params files. In step 4004, the routine “parameterized input” creates a new SLS data file or files S′ that is a copy of S. Then, in the nested for-loop of steps 4006-4015, the routine “parameterized input” considers each state s in S′. In the inner for-loop of steps 4007-4013, the routine “parameterized input” considers each value field v in currently considered state or resource s. In step 4008, the path to v is determined. In step 4009, the currently considered state s and the path determined in step 4008 are used together to find an entry e in pS or pL. If an entry is found, as determined in step 4010, the value field v is replaced with a parameter call to the variable with variable name e. VARIABLE_NAME, in step 4011. Thus, in the for-loop of steps 4006-4015, pS and pL are used to value fields in S′ with parameter calls that include variable names. In step 4016, pS and pL are deleted and, in step 4018, the routine “parameterized input” returns S′.

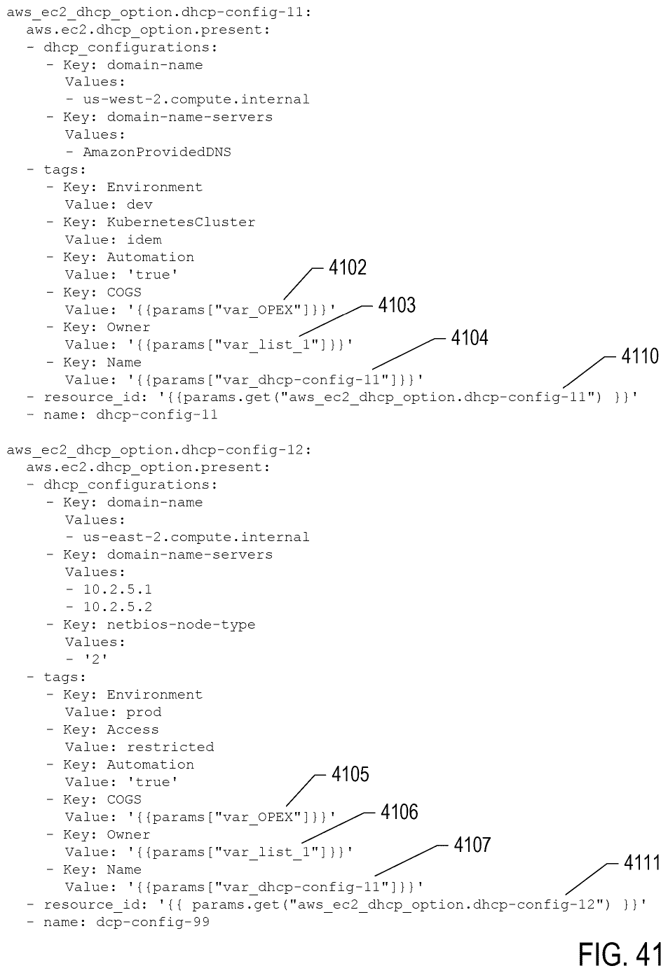

FIG. 41 shows the contents of file S′ output by the routine “generate parameterizations” for the example SLS data file S. The values in value fields 4102-4107 have each been replaced with a first type of parameter call that receives a variable name as an argument and that results in the substitution of the call with the variable value stored in the params file. Note also that a second type of parameter call 4110-4111 has replaced two user-friendly resource identifiers.

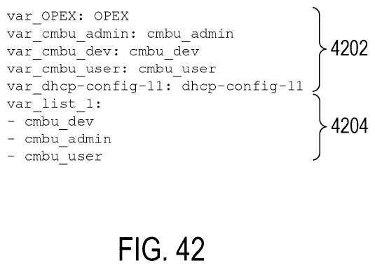

FIG. 42 shows an implementation of the params file. This includes the names and values of string variables 4202 and a name and list elements of a single list variable 4204.

The parameterized cloud-infrastructure template produced by the above-described process can be modified by users in order to add, update, or delete the parameterized variables. The above-described process, with small variations, can be used to process added and updated variables using a pre-populated string-frequency map and list-frequency map. Deleted variables may be detected during a subsequent compilation of the parameterized cloud-infrastructure template, with errors arising from the deleted variables addressed by replacing parameter calls with the corresponding variable values.

The present invention has been described in terms of particular embodiments, it is not intended that the invention be limited to these embodiments. Modifications within the spirit of the invention will be apparent to those skilled in the art. For example, any of many different implementations of the currently disclosed methods and systems can be obtained by varying various design and implementation parameters, including modular organization, control structures, data structures, hardware, operating system, and virtualization layers, automated orchestration systems, virtualization-aggregation systems, and other such design and implementation parameters. While the parameterized cloud-infrastructure templates generated by the currently disclosed methods and systems are sets of SLS data files, the currently disclosed methods and systems may, in other implementations, produce other types of configuration files that together comprise a parameterized cloud-infrastructure template.

1. An automated infrastructure-as-code cloud-infrastructure manager comprising:
one or more computer systems, each containing one or more processors, one or more memories, and one or more data-storage devices; and
processor instructions, stored in one or more of the one or more memories that, when executed by one or more of the one or more processors, control the one or more computer systems to implement the automated infrastructure-as-code cloud-infrastructure manager, the infrastructure-as-code cloud-infrastructure manager comprising:
a management interface configured to receive cloud-infrastructure-management commands and requests, including idempotent state commands that deploy and configure cloud infrastructure;
an execution engine configured to execute the received cloud-infrastructure-management commands and requests; and
parameterizer configured to generates a parameterized cloud-infrastructure template from one or more cloud-infrastructure-specification-and-configuration files.

2. The automated infrastructure-as-code cloud-infrastructure manager of claim 1 wherein the parameterizer generates a parameterized cloud-infrastructure template comprising:
one or more parameterized cloud-infrastructure-specification-and-configuration files; and
a parameters file.

3. The automated infrastructure-as-code cloud-infrastructure manager of claim 2 wherein the parameters file contains a map that maps variable names to values, including string values and list values.

4. The automated infrastructure-as-code cloud-infrastructure manager of claim 2 wherein the one or more parameterized cloud-infrastructure-specification-and-configuration files comprise:
one or more resource descriptors;
one or more of a first type of parameter call that each replaces a value field in one or more of the resource descriptors;
one or more of a second type of parameter call that each replaces a resource-identifier in one or more of the resource descriptors; and
one or more argument bindings that each replaces a resource identifier in one or more of the resource descriptors.

5. The automated infrastructure-as-code cloud-infrastructure manager of claim 1 wherein parameterizer that generates a parameterized cloud-infrastructure template from one or more cloud-infrastructure-specification-and-configuration files by:
validating the one or more cloud-infrastructure-specification-and-configuration files while compiling the one or more cloud-infrastructure-specification-and-configuration files into one or more equivalent cloud-infrastructure-specification-and-configuration files represented in a data-representation language; and
processing the equivalent cloud-infrastructure-specification-and-configuration files represented in the data-representation language to generate the parameterized cloud-infrastructure template.

6. The automated infrastructure-as-code cloud-infrastructure manager of claim 5 wherein processing the equivalent cloud-infrastructure-specification-and-configuration files represented in the data-representation language to generate the parameterized cloud-infrastructure template further comprises:
processing the equivalent cloud-infrastructure-specification-and-configuration files represented in the data-representation language to generate a build-insights response that comprises:
for each resource descriptor in the equivalent cloud-infrastructure-specification-and-configuration files represented in the data-representation language:
a copy of the resource descriptor;
a list of paths to value fields in the resource descriptor; and
for each field value in the resource descriptor:
a list of paths to the field value; and
for each resource type in the equivalent cloud-infrastructure-specification-and-configuration files represented in the data-representation language:
a count of the number of resource descriptors of the resource type in the equivalent cloud-infrastructure-specification-and-configuration files represented in the data-representation language; and
for each path in the resource descriptors in the equivalent cloud-infrastructure-specification-and-configuration files represented in the data-representation language:
a count of the number of occurrence of the path in the equivalent cloud-infrastructure-specification-and-configuration files represented in the data-representation language;
indications of the different values referenced by the path; and
a uniqueness value; and
processing the build-insights response to generate the parameterized cloud-infrastructure template.

7. The automated infrastructure-as-code cloud-infrastructure manager of claim 6 wherein processing the build-insights response to generate the parameterized cloud-infrastructure template further comprises processing the build-insights response to generate the parameterized cloud-infrastructure template by:
filtering the paths in the build-insights response that reference string values to select those paths that reference string values with uniqueness values lower than a threshold value;
for each of the selected paths,
adding, to a string-frequency map, an entry for the string value referenced by the selected path and for substrings of the string value referenced by the selected path, each entry including a proposed string-valued-variable name, paths to occurrences of the string value represented by the entry, and an indication of the number of occurrences of the string value represented by the entry; and
further processing the build-insights response to generate the parameterized cloud-infrastructure template.

8. The automated infrastructure-as-code cloud-infrastructure manager of claim 7 wherein further processing the build-insights response to generate the parameterized cloud-infrastructure template further comprises:
selecting those paths in the build-insights response that reference list values;
for each of the selected paths,
adding, to a list-frequency map, an entry for each element in the list value referenced by the selected path, each entry including paths to occurrences of the element in list values and a count of the occurrences of the list values that include the element; and
further processing the build-insights response, list-frequency map, and string-frequency map to generate the parameterized cloud-infrastructure template.

9. The automated infrastructure-as-code cloud-infrastructure manager of claim 8 wherein further processing the build-insights response, list-frequency map, and string-frequency map to generate the parameterized cloud-infrastructure template comprises:
filtering the entries in the string-frequency map to generate a processed string-frequency map, the filtering employed to remove entries for strings of greater than a threshold length, empty string, numeric strings with less than a threshold length, strings represented Boolean values, strings representing syntax elements, substrings of longer strings, and entries representing strings with no occurrences in the build-insights response;
filtering the entries in the list-frequency map to generate a processed list-frequency map, the filtering employed to remove entries with occurrence counts below a threshold value, the processed list-frequency map including an entry for list values that include paths that reference the list value and a proposed variable name; and
further processing the build-insights response, processed list-frequency map, and processed string-frequency map to generate the parameterized cloud-infrastructure template.

10. The automated infrastructure-as-code cloud-infrastructure manager of claim 9 wherein further processing the build-insights response, processed list-frequency map, and processed string-frequency map to generate the parameterized cloud-infrastructure template comprises:
generating, from the build-insights response, processed list-frequency map, and processed string-frequency map comprising:
a map of paths that reference string variables and list variables within each resource descriptor to variable names; and
a parameters file that maps variable names to variable values; and
using the map of paths that reference string variables and list variables within each resource descriptor to variable names and the parameters file to generate the parameterized cloud-infrastructure template.

11. A method that identifies variables within one or more cloud-infrastructure-specification-and-configuration files and generates a parameterized cloud-infrastructure template, the method comprising:
validating the one or more cloud-infrastructure-specification-and-configuration files while compiling the one or more cloud-infrastructure-specification-and-configuration files into one or more equivalent cloud-infrastructure-specification-and-configuration files represented in a data-representation language; and
processing the equivalent cloud-infrastructure-specification-and-configuration files represented in the data-representation language to generate the parameterized cloud-infrastructure template.

12. The method of claim 11 wherein the parameterized cloud-infrastructure template comprises:
one or more parameterized cloud-infrastructure-specification-and-configuration files; and
a parameters file.

13. The method of claim 12 wherein the parameters file contains a map that maps variable names to values, including string values and list values.

14. The method of claim 12 wherein the one or more parameterized cloud-infrastructure-specification-and-configuration files comprise:
one or more resource descriptors;
one or more of a first type of parameter call that each replaces a value field in one or more of the resource descriptors; and
one or more of a second type of parameter call that each replaces a resource-identifier in one or more of the resource descriptors; and
one or more argument bindings that each replaces a resource identifier in one or more of the resource descriptors.

15. The method of claim 14 wherein processing the equivalent cloud-infrastructure-specification-and-configuration files represented in the data-representation language to generate the parameterized cloud-infrastructure template comprises:
processing the equivalent cloud-infrastructure-specification-and-configuration files represented in the data-representation language to generate a build-insights response that comprises:
for each resource descriptor in the equivalent cloud-infrastructure-specification-and-configuration files represented in the data-representation language
a copy of the resource descriptor,
a list of paths to value fields in the resource descriptor, and
for each field value in the resource descriptor,
a list of paths to the field value, and
for each resource type in the equivalent cloud-infrastructure-specification-and-configuration files represented in the data-representation language,
a count of the number of resource descriptors of the resource type in the equivalent cloud-infrastructure-specification-and-configuration files represented in the data-representation language, and
for each path in the resource descriptors in the equivalent cloud-infrastructure-specification-and-configuration files represented in the data-representation language,
a count of the number of occurrence of the path in the equivalent cloud-infrastructure-specification-and-configuration files represented in the data-representation language,
indications of the different values referenced by the path, and
a uniqueness value; and
processing the build-insights response to generate the parameterized cloud-infrastructure template.

16. The method of claim 15 wherein processing the build-insights response to generate the parameterized cloud-infrastructure template further comprises processing the build-insights response to generate the parameterized cloud-infrastructure template by:
filtering the paths in the build-insights response that reference string values to select those paths that reference string values with uniqueness values lower than a threshold value;
for each of the selected paths,
adding, to a string-frequency map, an entry for the string value referenced by the selected path and for substrings of the string value referenced by the selected path, each entry including a proposed string-valued-variable name, paths to occurrences of the string value represented by the entry, and an indication of the number of occurrences of the string value represented by the entry; and
further processing the build-insights response to generate the parameterized cloud-infrastructure template.

17. The method of claim 16 wherein further processing the build-insights response to generate the parameterized cloud-infrastructure template further comprises:
selecting those paths in the build-insights response that reference list values;
for each of the selected paths,
adding, to a list-frequency map, an entry for each element in the list value referenced by the selected path, each entry including paths to occurrences of the element in list values and a count of the occurrences of the list values that include the element; and
further processing the build-insights response, list-frequency map, and string-frequency map to generate the parameterized cloud-infrastructure template.

18. The method of claim 17 wherein further processing the build-insights response, list-frequency map, and string-frequency map to generate the parameterized cloud-infrastructure template comprises:
filtering the entries in the string-frequency map to generate a processed string-frequency map, the filtering employed to remove entries for strings of greater than a threshold length, empty string, numeric strings with less than a threshold length, strings represented Boolean values, strings representing syntax elements, substrings of longer strings, and entries representing strings with no occurrences in the build-insights response;
filtering the entries in the list-frequency map to generate a processed list-frequency map, the filtering employed to remove entries with occurrence counts below a threshold value, the processed list-frequency map including a entry for list values that include paths that reference the list value and a proposed variable name; and
further processing the build-insights response, processed list-frequency map, and processed string-frequency map to generate the parameterized cloud-infrastructure template.

19. The method of claim 18 wherein further processing the build-insights response, processed list-frequency map, and processed string-frequency map to generate the parameterized cloud-infrastructure template comprises:
generating, from the build-insights response, processed list-frequency map, and processed string-frequency map comprising:
a map of paths that reference string variables and list variables within each resource descriptor to variable names; and
a parameters file that maps variable names to variable values; and
using the map of paths that reference string variables and list variables within each resource descriptor to variable names and the parameters file to generate the parameterized cloud-infrastructure template.

20. A physical data-storage device encoded with processor instructions that, when executed by one or more processors within one or more computer systems, each containing one or more processors, one or more memories, and one or more data-storage devices, control the one or more computer systems to implement an automated infrastructure-as-code cloud-infrastructure manager, the automated infrastructure-as-code cloud-infrastructure manager comprising:
a management interface that receives cloud-infrastructure-management commands and requests, including idempotent state commands that deploy and configure cloud infrastructure;
an execution engine that executes the received cloud-infrastructure-management commands and requests; and
parameterized that generates a parameterized cloud-infrastructure template from one or more cloud-infrastructure-specification-and-configuration files.
